(19) United States
(12) Patent Application Publication
(10) Pub. No.: US 2026/0180070 A1
(43) Pub. Date: Jun. 25, 2026

(54) ENERGY STORAGE UNIT AND METHOD FOR CONTROLLING THE TEMPERATURE OF AN ENERGY STORAGE UNIT

(71) Applicants: ElringKlinger AG, Dettingen (DE); Piëch Design & Engineering AG, Zug (CH)

(72) Inventors: Jonas BODENBENDER, Dettingen (DE); Lukas KOLLER, Dettingen (DE); Marius DORNSEIF, Dettingen (DE); Ralph ILLENBERGER, Schwäbisch Gmünd (DE); Tobias MOERS, Esslingen (DE)

(73) Assignees: ElringKlinger AG, Dettingen (DE); Piëch Design & Engineering AG, Zug (CH)

(21) Appl. No.: 19/541,302

(22) Filed: Feb. 16, 2026

Related U.S. Application Data
(63) Continuation of application No. PCT/EP2024/072893, filed on Aug. 14, 2024.

(30) Foreign Application Priority Data
Aug. 21, 2023 (DE) 10 2023 122 355.0

(51) Int. Cl. H01M 10/6557; H01M 10/613; H01M 10/617; H01M 10/625; H01M 10/643; H01M 50/213; H01M 50/249; H01M 50/271

(52) U.S. Cl. CPC H01M 10/6557; H01M 10/613; H01M 10/617; H01M 10/625; H01M 10/643; H01M 50/213; H01M 50/249; H01M 50/271

(57) ABSTRACT

Energy storage unit, wherein the energy storage unit in particular can be an energy storage module and/or in particular electrical energy for driving a motor vehicle is able to be provided by the energy storage unit, wherein the energy storage unit comprises the following: a plurality of energy storage elements, preferably a plurality of electrochemical energy storage elements, e.g. a plurality of battery cells; and a temperature-control fluid barrier, wherein the temperature-control fluid barrier extends about a temperature-control chamber and in the temperature-control chamber at least a plurality of the energy storage elements are able to be temperature-controlled by means of a temperature-control fluid.

### RELATED APPLICATION

This application is a continuation of international application No. PCT/EP2024/072893 filed on Aug. 14, 2024, and claims the benefit of German application No. 10 2023 122 355.0 filed on Aug. 21, 2023, which are incorporated herein by reference in their entirety and for all purposes.

### FIELD OF DISCLOSURE

The present invention relates to the technical field of energy storage units and associated components. The invention relates in particular to high-performance energy storage units, by way of which electrical energy is able to be provided for driving a motor vehicle.

### BACKGROUND

A wide range of proposals have been made to increase the efficiency and range of motor vehicles which are fully or partially electrically driven.

There are efforts to design the temperature control of electrochemical energy storage units or energy storage modules, in particular their cooling, in such a way that as little energy as possible is consumed for this purpose and at the same time the mass of the motor vehicle is not increased unnecessarily. Thus, a higher proportion of the energy that is able to be stored in the energy storage unit can be made available directly for driving the lightest possible motor vehicle.

There are also efforts to provide electrochemical energy storage units or energy storage modules in as compact designs as possible, so that as much of the space in a motor vehicle as possible is available for a load.

In addition, the motor vehicle's center of gravity should be as low as possible, as this can increase driving safety, especially when suddenly appearing obstacles have to be avoided at high speed.

In this respect, there is still a great need for improvement.

### SUMMARY OF THE INVENTION

The object of the present invention is to provide an efficient energy storage unit and/or a component for the latter in the simplest possible manner.

This object achieved according to the invention by an energy storage unit as claimed in the respective independent claim.

The energy storage unit can in particular be an energy storage module.

In the context of this description and the appended claims, the term “in particular” is used to describe potential elective and/or optional features.

In particular, electrical energy for driving a motor vehicle can be able to be provided by the energy storage unit.

A plurality of energy storage units, for example, a plurality of energy storage units according to the invention, can be interconnected to form energy storage devices or energy storage systems which can provide the entire electrical energy for driving a motor vehicle. An energy storage unit according to the invention can provide in particular part of the electrical energy for driving a motor vehicle.

The energy storage unit comprises a plurality of energy storage elements. These are preferably a plurality of electrochemical energy storage elements, e.g. a plurality of battery cells. For example, the battery cells can be rechargeable lithium-ion battery cells.

Energy storage elements, which can be included by the energy storage unit, can be energy storage elements which are usually installed in customary energy storage devices for driving motor vehicles. These are generally known, which is why they are not to be discussed in more detail.

In energy storage units by way of which electrical energy is able to be provided for driving a motor vehicle, in particular three different battery cell types are installed. These are cylindrical battery cells, prismatic battery cells and pouch cells.

The battery cells can preferably be cylindrical battery cells, prismatic battery cells or pouch cells, particularly preferably cylindrical battery cells or prismatic battery cells, e.g. cylindrical battery cells.

When mention is made of an energy storage element, this is understood to mean in particular a rechargeable energy storage element.

The energy storage unit comprises a temperature-control fluid barrier.

The temperature-control fluid barrier extends about a temperature-control chamber. In the temperature-control chamber, at least a plurality of the energy storage elements can be temperature-controlled by means of a temperature-control fluid.

The plurality of energy storage elements is understood to mean a plurality of the energy storage elements included in the energy storage unit. The plurality of the energy storage elements included in the energy storage unit can be 5% to 100% of the energy storage elements included in the energy storage unit, preferably 40% to 100% of the energy storage elements included in the energy storage unit, particularly preferably 75% to 100% of the energy storage elements included in the energy storage unit.

It can be particularly advantageous when all energy storage elements which are included in the energy storage unit can be temperature-controlled in the temperature-control chamber by means of the temperature-control fluid.

The energy storage unit is not limited in terms of the structure and materials of the temperature-control fluid barrier. The temperature-control fluid barrier can be of a single-piece or multi-piece, preferably of a multi-piece, for example three-piece, construction.

It can be advantageous when the temperature-control fluid barrier has at least one first barrier element and at least one second barrier element.

It can be advantageous when at least one first barrier element and at least one second barrier element form the temperature-control fluid barrier.

It can be advantageous when a first barrier element forms a cover element, e.g. a lid element, of the temperature-control fluid barrier.

It can be advantageous when a second barrier element forms a cover element, e.g. a base element, of the temperature-control fluid barrier.

Preferably, a third barrier element can form a frame wall element of the temperature-control fluid barrier. The frame wall element can be a frame and extend about the temperature-control chamber.

It can be particularly advantageous when the temperature-control fluid barrier has a barrier zone. For example, the barrier zone can be a wall zone. Preferably, the barrier zone can be reinforced by means of a reinforcement element.

The barrier zone reinforced by means of the reinforcement element can preferably be a barrier zone formed by the first barrier element or by the second barrier element.

It can be particularly advantageous when the reinforcement element reinforces the barrier zone in relation to outward bending of the barrier zone.

The reinforcement element can reinforce the barrier zone in relation to outward bulging of the barrier zone, for example.

Bulging of the barrier zone can in particular mean convex bulging of the barrier zone or amplification of a convexity of the barrier zone. Outward bending of the barrier zone or convex bulging of the barrier zone can be understood to mean in particular that the barrier zone at the point where the barrier zone is bent or bulged outward bends in such a way that the temperature-control chamber is enlarged or the temperature-control chamber is inflated.

It can be particularly advantageous when the reinforcement element extends from the barrier zone into the temperature-control chamber.

It can be particularly advantageous when the barrier zone is a first barrier zone and the temperature-control fluid barrier has a second barrier zone. For example, the first barrier zone can be a first wall zone. For example, the second barrier zone can be a second wall zone.

Preferably, the reinforcement element can extend from the first barrier zone to the second barrier zone.

It can be particularly advantageous when the first and the second barrier zone are mutually opposite barrier zones of the temperature-control fluid barrier.

For example, the first barrier zone and the second barrier zone can be mutually opposite barrier zones of the temperature-control fluid barrier. Advantageously, the first wall zone and the second wall zone can be mutually opposite wall zones of the temperature-control fluid barrier.

Preferably, the first wall zone can be a wall zone formed by a first barrier element, e.g. by a lid element. Preferably, the second wall zone can be a wall zone formed by the second barrier element, e.g. by the base element.

It can be particularly advantageous when the reinforcement element extends from a first wall zone formed by the lid element to a second wall zone formed by the base element.

It can be advantageous when the reinforcement element is disposed in such a way that a convexity of the barrier zone, for example of the first barrier zone or the second barrier zone, is associated with a tensile load of the reinforcement element. In particular, a force which is able to counteract the convexity can then act in the reinforcement element.

Preferably, a plurality of the energy storage elements can be disposed at regular intervals.

In particular, surfaces of a plurality of pairs of closest energy storage elements can be in contact with one another, or spacings between the two energy storage elements of a plurality of pairs of closest adjacent energy storage elements can be of identical size. It can be particularly advantageous when the spacings of closest adjacent positioning zones of a partition element, such as a shaped element, determine the spacings of the closest adjacent energy storage elements. A partition element described herein, such as a shaped element, can surround closest adjacent energy storage elements.

In particular, the position of a plurality of energy storage elements can in each case define two parallel planes between which a plurality of the energy storage elements are in each case disposed.

In particular, the position of closest adjacent energy storage elements can be approximated by a prism. It is preferable when the edges extending along the shell face of the prism coincide with straight lines running centrally through the energy storage elements. For example, the position of three closest adjacent energy storage elements can be approximated by a triangular prism. It is preferable when the three edges extending along the shell face of the triangular prism coincide with straight lines running centrally through the three closest adjacent energy storage elements.

Of course, the parallel planes mentioned, the prism mentioned and the triangular prism mentioned are only aids which are used solely for the purpose of defining the regular arrangement of the plurality of energy storage elements.

It can be advantageous when the reinforcement element in the regular arrangement of the plurality of the energy storage elements assumes a position of one of the energy storage elements. In particular, the reinforcement element in the regular arrangement can then replace one of the energy storage elements.

It can be advantageous when the reinforcement element extends in the regular arrangement of the plurality of the energy storage elements between a plurality of energy storage elements. It can be preferable when the reinforcement element extends through the prism. For example, it can extend at least from the base area to the top surface of the prism. For example, it can extend beyond the base area into the prism, through the prism, and over the top surface out of the prism.

It can be particularly preferable when a reinforcement element longitudinal axis of the reinforcement element extends parallel to the edges extending along the shell face of the prism in the prism.

Preferably, the reinforcement element can comprise a counter-reinforcement element. For example, the counter-reinforcement element can be a support reinforcement element.

It can be particularly preferable when the reinforcement element simultaneously acts as a counter-reinforcement element or as a support reinforcement element.

The counter-reinforcement element or support reinforcement element can reinforce the barrier zone in relation to inward bending of the barrier zone. The counter-reinforcement element or the support reinforcement element can reinforce the barrier zone in relation to concave bulging of the barrier zone, for example.

A concavity can in particular be a movement counter to the convexity described herein.

It can be advantageous when the counter-reinforcement element extends from the first barrier zone to the second barrier zone. For example, it can extend from the first wall zone to the second wall zone.

It can be advantageous when an end of the reinforcement element extends into a depression of the barrier zone. For example, a first end of the reinforcement element can extend into a first depression of the first barrier zone.

It can be preferable when a second end of the reinforcement element extends into a second depression of the second barrier zone. The statements “first” and “second” merely indicate that this is a depression of the respectively designated “first” barrier zone or “second” barrier zone. The reference to a “first” depression does not mean that the “first” barrier zone must necessarily have a further depression. The reference to a “second” depression does not mean that the second barrier zone must necessarily have a further depression.

Preferably, the reinforcement element can be fixed to the first barrier zone and to the second barrier zone, preferably fixed in a materially integral manner, particularly preferably welded or adhesively bonded, for example welded.

It can be particularly advantageous when the first end of the reinforcement element is fixed in a materially integral manner, preferably welded or adhesively bonded, for example welded; and/or the second end of the reinforcement element is fixed in a materially integral manner, preferably welded or adhesively bonded, for example welded.

For example, the first end of the reinforcement element in the first recess can be fixed in a materially integral manner, preferably welded or adhesively bonded, for example welded; and/or the second end of the reinforcement element in the second recess can be fixed in a materially integral manner, preferably welded or adhesively bonded, for example welded.

It can be advantageous when the reinforcement element comprises a fixing element by way of which the counter-reinforcement element is able to be fixed to the barrier zone. The counter-reinforcement element can be able to be fixed by way of the fixing element, for example in the depression of the barrier zone.

The reinforcement element can comprise a fixing element.

The fixing element can preferably have a thread. For example, the fixing element can be a screw, a bolt or a nut.

It can be advantageous when the reinforcement element has a shoulder zone, a neck zone and a head zone.

It can be preferable when the barrier zone extends into a fixing zone which lies between the shoulder zone and the head zone on the neck zone.

It can be particularly advantageous when the fixing element forms the head zone and the counter-reinforcement element forms the shoulder zone. When the fixing element is a screw, a head of the screw can form the head zone. When the fixing element is a nut, the nut can form the head zone.

It can be advantageous when the reinforcement element has interlocking threads.

It can be particularly advantageous when the counter-reinforcement element and the fixing element have interlocking threads.

It can be particularly advantageous when the reinforcement element is attached to the barrier zone.

The reinforcement element can be attached to the barrier zone, for example, in a force-fitting, form-fitting and/or materially integral manner.

It is preferable when the end of the reinforcement element or of the counter-reinforcement element extends into the depression of the barrier zone and is thereon attached to the barrier zone.

For example, the first end of the reinforcement element or of the counter-reinforcement element can extend into the first depression of the first barrier zone and be thereon attached to the first barrier zone.

Of course, the energy storage unit can comprise a plurality of reinforcement elements. The barrier zone can be reinforced by means of a plurality of reinforcement elements.

For example, the reinforcement element can be a first reinforcement element and the energy storage unit can comprise at least one further reinforcement element, e.g. a plurality of further reinforcement elements. It can be advantageous when the first reinforcement element and at least two, preferably at least four, particularly preferably at least six, e.g. at least eight, of the further reinforcement elements extend from the first barrier zone to the second barrier zone.

It can be advantageous when the temperature-control chamber extends about a plurality of the reinforcement elements that extend from the first barrier zone to the second barrier zone. For example, a first temperature-control zone described herein can extend about one portion, and a second temperature-control zone described herein can extend about another portion, of each of the reinforcement elements about which the temperature-control chamber extends.

It can be advantageous when a total cross-sectional area of all reinforcement elements about which the temperature-control chamber extends and which extend from the first barrier zone to the second barrier zone is at least 0.025%, preferably at least 0.04%, particularly preferably at least 0.06%, e.g. at least 0.1%, of a total cross-sectional area of all energy storage elements that are able to be temperature-controlled in the temperature-control chamber by means of the temperature-control fluid.

It can be advantageous when a total cross-sectional area of all reinforcement elements about which the temperature-control chamber extends and which extend from the first barrier zone to the second barrier zone is not more than 5.0%, preferably not more than 4.0%, particularly preferably not more than 3.0%, e.g. not more than 2.5%, of a total cross-sectional area of all energy storage elements that are able to be temperature-controlled in the temperature-control chamber by means of the temperature-control fluid.

It can be particularly advantageous when a total cross-sectional area of all reinforcement elements about which the temperature-control chamber extends and which extend from the first barrier zone to the second barrier zone is 0.025% to 5.0%, preferably 0.04% to 4.0%, particularly preferably 0.06% to 3.0%, e.g. 0.1% to 2.5%, of a total cross-sectional area of all energy storage elements that are able to be temperature-controlled in the temperature-control chamber by means of the temperature-control fluid.

Preferably, in the comparison of the total cross-sectional areas, those total cross-sectional areas of reinforcement elements and energy storage elements are taken into account that are derived in a section of the energy storage unit in a central plane. The central plane can preferably extend parallel to a first direction, for example to the first direction described herein, and to a second direction, for example to the second direction described herein, centrally through the energy storage unit. In particular, the central plane can extend orthogonally to a third direction, for example the third direction described herein, centrally through the energy storage unit.

Centrally extending through the energy storage unit can be understood to mean in particular that one half of the energy storage unit is on one side of the central plane and the other half of the energy storage unit is on the other side of the central plane, wherein the volume of one half corresponds to the volume of the other half.

The total cross-sectional area of the energy storage elements also includes the cross-sectional areas that can be attributable to any jackets or housings, e.g. battery cell jackets or housings.

In the total cross-sectional area of the reinforcement elements, the material cross-sections of the reinforcement elements are included, whereby any cavities of reinforcement elements, e.g. of cylindrical or hollow cylindrical reinforcement elements, are not included.

It can be advantageous when a ratio of the number of reinforcement elements about which the temperature-control chamber extends and which extend from the first barrier zone to the second barrier zone to the number of energy storage elements that are able temperature-controlled in the temperature-control chamber by means of the temperature-control fluid, is at least 0.005, preferably at least 0.0075, e.g. at least 0.01.

It can be advantageous when a ratio of the number of reinforcement elements about which the temperature-control chamber extends and which extend from the first barrier zone to the second barrier zone, to the number of energy storage elements that are able to be temperature-controlled in the temperature-control chamber by means of the temperature-control fluid is not more than 0.6, preferably not more than 0.5, e.g. not more than 0.4.

It can be advantageous when a ratio of the number of reinforcement elements about which the temperature-control chamber extends and which extend from the first barrier zone to the second barrier zone, to the number of energy storage elements that are able to be temperature-controlled in the temperature-control chamber by means of the temperature-control fluid is 0.005 to 0.6, preferably 0.0075 to 0.5, for example 0.01 to 0.4.

It can be advantageous when at least one barrier zone is reinforced by an external reinforcement element.

The external reinforcement element can preferably run on a shell face of the barrier zone.

Preferably, the external reinforcement element can be a reinforcement rib.

It can be particularly advantageous when the depression into which an end of the reinforcement element extends is reinforced by the external reinforcement element. For example, an elevation corresponding to the depression can be present on the shell face of the barrier zone and the external reinforcement element can transition into the elevation.

It can be particularly advantageous when an inlet extends through the temperature-control fluid barrier. The inlet can be an opening.

It is preferable when the temperature-control fluid or at least part of the temperature-control fluid is able to be supplied to the temperature-control chamber through the inlet.

It can be particularly advantageous when an outlet extends through the temperature-control fluid barrier. The outlet can be an opening.

It is preferable when the temperature-control fluid or at least part of the temperature-control fluid is able to be discharged from the temperature-control chamber through the outlet. The temperature-control fluid or at least the part of the temperature-control fluid can be able to be discharged from the temperature-control chamber through the outlet, for example.

It can be advantageous when a first extent of the energy storage unit in a first direction is larger than a second extent of the energy storage unit in a second direction, and the first extent of the energy storage unit in the first direction is larger than a third extent of the energy storage unit in a third direction.

Each of the three directions can in particular be aligned orthogonally to the other two directions. In particular, the first direction can be aligned orthogonally to the second direction and the third direction, the second direction can be aligned orthogonally to the first and the third direction, and the third direction can be aligned orthogonally to the first and the second direction.

The first direction can be a direction of longitudinal extent, in which a length of the energy storage unit can be measured. The second direction can be a direction of width extent, in which a width of the energy storage unit can be measured. The third direction can be a direction of height extent, in which a height of the energy storage unit can be measured.

It is preferable when the second extent of the energy storage unit in the second direction is larger than the third extent of the energy storage unit in the third direction.

It can be advantageous when the first extent of the energy storage unit in the first direction is at least 150%, in particular at least 180%, preferably at least 220%, of the second extent of the energy storage unit in the second direction.

It can be advantageous when the first extent of the energy storage unit in the first direction is not more than 800%, in particular not more than 625%, preferably not more than 500%, of the second extent of the energy storage unit in the second direction.

It can be advantageous when the first extent of the energy storage unit in the first direction is 150% to 800%, in particular 180% to 625%, preferably 220% to 500%, of the second extent of the energy storage unit in the second direction.

It can be advantageous when the second extent of the energy storage unit in the second direction is at least 160%, in particular at least 180%, preferably at least 225%, of the third extent of the energy storage unit in the third direction.

It can be advantageous when the second extent of the energy storage unit in the second direction is not more than 1000%, in particular not more than 850%, preferably not more than 700%, of the third extent of the energy storage unit in the third direction.

It can be advantageous when the second extent of the energy storage unit in the second direction is 160% to 1000%, in particular 180% to 850%, preferably 225% to 700%, of the third extent of the energy storage unit in the third direction.

It can be particularly advantageous when the first extent of the energy storage unit in the first direction is at least 150%, in particular 150% to 800%, for example 180% to 625%, of the second extent of the energy storage unit in the second direction, and the second extent of the energy storage unit in the second direction is at least 160%, in particular 160% to 1000%, for example 180% to 850%, of the third extent of the energy storage unit in the third direction.

It can be particularly advantageous when
the first extent of the energy storage unit in the first direction is at least 150%, in particular at least 180%, preferably at least 220%, of the second extent of the energy storage unit in the second direction;
   and
the second extent of the energy storage unit in the second direction is at least 160%, in particular at least 180%, preferably at least 225%, of the third extent of the energy storage unit in the third direction;
   and
the first extent of the energy storage unit in the first direction is not more than 3000%, in particular not more than 2700%, preferably not more than 2500%, of the third extent of the energy storage unit in the third direction.

This can mean in particular that a length of the energy storage unit is larger than a width of the energy storage unit, and a width of the energy storage unit is larger than a height of the energy storage unit.

It can be advantageous when the temperature-control fluid barrier has a frontal barrier zone, wherein the inlet and outlet extend through the frontal barrier zone.

It can be advantageous when the frontal barrier zone is neither the first barrier zone described herein nor the second barrier zone described herein.

It is preferred when the inlet and outlet extend through the frontal barrier zone in such a way that a supply flow direction of the temperature-control fluid, which is able to be supplied through the inlet to the temperature-control chamber, is aligned in the opposite direction to a discharge flow direction of the temperature-control fluid which is able be discharged through the outlet from the temperature-control chamber.

It is preferable when the frontal barrier zone is aligned in such a way that the frontal barrier zone can be defined by two frontal planes which are aligned so as to be mutually parallel and mutually spaced apart, wherein the two frontal planes are aligned orthogonally to the first direction and the frontal barrier zone extends between these two frontal planes.

Of course, the two frontal planes mentioned are only aids which are used in particular to define the frontal barrier zone and its shape. Specifically, the frontal planes are not physical objects.

It can be particularly advantageous when the inlet and the outlet are mutually offset in the second or third direction. For example, the inlet and outlet can be mutually offset in the third direction.

It is preferred when the inlet and outlet in the frontal barrier zone are mutually offset in the second or third direction. For example, the inlet and outlet in the frontal barrier zone can be mutually offset in the third direction.

It can be particularly advantageous when the energy storage unit comprises a temperature-control fluid distribution channel.

Preferably, the energy storage unit can comprise a temperature-control fluid distribution channel and the inlet can be fluidically connected to the temperature-control fluid distribution channel.

It is preferable when the temperature-control fluid distribution channel is aligned in such a way that a first portion of the temperature-control fluid distribution channel that lies closer to the inlet in the temperature-control fluid flow direction is offset from the inlet in the first direction to a lesser extent than a second portion of the temperature-control fluid distribution channel that lies farther away from the inlet in the temperature-control fluid flow direction.

It is preferable when the temperature-control fluid distribution channel is aligned in such a way that the first portion of the temperature-control fluid channel that lies closer to the inlet in the temperature-control fluid flow direction is offset from the inlet in the third direction to the same extent as the second portion of the temperature-control fluid distribution channel that lies farther away from the inlet in the temperature-control fluid flow direction.

It can be particularly advantageous when the energy storage unit comprises a temperature-control fluid collection channel.

Preferably, the energy storage unit can comprise a temperature-control fluid collection channel and the outlet can be fluidically connected to the temperature-control fluid collection channel.

It is preferable when the temperature-control fluid collection channel is aligned in such a way that a first portion of the temperature-control fluid collection channel that lies closer to the outlet in the temperature-control fluid flow direction is offset from the outlet in the first direction to a lesser extent than a second portion of the temperature-control fluid collection channel that lies farther away from the second opening in the temperature-control fluid flow direction.

It is preferable when the temperature-control fluid collection channel is aligned in such a way that the first portion of the temperature-control fluid collection channel that lies closer to the outlet in the temperature-control fluid flow direction is offset from the outlet in third direction to the same extent as the second portion of the temperature-control fluid collection channel that lies farther away from the outlet in the temperature-control fluid flow direction.

It can be particularly advantageous when the temperature-control fluid distribution channel has a fluid distribution passage through which the temperature-control fluid from the temperature-control fluid distribution channel is able to be transferred to a temperature-control zone.

Preferably, a cross section of a fluid distribution passage, for example of the fluid distribution passage, or a width of a fluid distribution passage, for example of the fluid distribution passage, which can be measured transversely to the temperature-control fluid flow direction, can be smaller in the first portion of the temperature-control fluid distribution channel than in the second portion of the temperature-control fluid distribution channel.

It can be particularly advantageous when the temperature-control fluid collection channel has a fluid collection passage through which the temperature-control fluid from a temperature-control zone can be transferred to the temperature-control fluid collection channel.

Preferably, a cross section of a fluid collecting passage, for example of the fluid collecting passage, or a width of a fluid collecting passage, for example of the fluid collecting passage, which is able to be measured transversely to the temperature-control fluid flow direction, can be smaller in the first portion of the temperature-control fluid collection channel than in the second portion of the temperature-control fluid collection channel.

It can be advantageous when the fluid distribution passage widens at least in one portion of the temperature-control fluid distribution channel as the distance from the inlet increases. The increasing distance from the inlet can in particular be a distance that increases from the inlet and is able to be measured in the first direction.

It can be advantageous when the fluid collection passage widens at least in one portion of the temperature-control fluid collection channel as the distance from the outlet increases. The increasing distance from the outlet can in particular be a distance that increases from the outlet in the first direction.

It can be particularly advantageous when the temperature-control chamber has a first temperature-control zone and a second temperature-control zone.

Preferably, the temperature-control fluid from the temperature-control fluid distribution channel is able to be transferred to the first temperature-control zone through the fluid distribution passage.

Preferably, the temperature-control fluid from the second temperature-control zone is able to be transferred into the temperature-control fluid collection channel.

It can be preferable when the temperature-control fluid from the temperature-control fluid distribution channel is able to be transferred into the first temperature-control zone.

It can be preferable when the temperature-control fluid from the second temperature-control zone is able to be transferred into the temperature-control fluid collection channel.

The two temperature-control zones are preferably planar temperature-control zones. They can preferably extend farther along the first direction and along the second direction than along the third direction.

It can be advantageous when the two temperature-control zones are mutually offset in the third direction.

It can be particularly advantageous when a partition element surrounds a plurality of the energy storage elements. For example, the partition element can be a shaped element.

It can be preferable when the partition element separates the first temperature-control zone from the second temperature-control zone. It can be preferable when the partition element extends between the first temperature-control zone and the second temperature-control zone.

The partition element can be a potting element. The potting element can be made completely or partially of a potting compound or can contain a potting compound.

The partition element can be an intermediate barrier element. The plurality of the energy storage elements can be received in recesses of the intermediate barrier element and fixed to the intermediate barrier element. For example, they can be fixed to the intermediate barrier element with a potting compound.

The shaped element can be a shaped element described in more detail herein.

The density of the shaped element or of a foam material which the shaped element may contain or from which the shaped element may be made can preferably not be more than 0.7 g/cm³, particularly preferably not more than 0.5 g/cm³, most preferably not more than 0.3 g/cm³, for example not more than 0.15 g/cm³.

It can be advantageous when the density of the shaped element or of a foam material which the shaped element may contain or from which the shaped element can be made is at least 0.0005 g/cm³, particularly preferably at least 0.0015 g/cm³, most preferably at least 0.01 g/cm³, for example at least 0.015 g/cm³.

It can be advantageous when the at least one temperature-control fluid passage is a temperature-control fluid passage which is integrated into the partition element or shaped element and disposed on a periphery of the shaped element or of the partition element. It can be advantageous when at least one further temperature-control fluid passage is a temperature-control fluid passage which is integrated into the partition element or shaped element and disposed on an opposite periphery of the shaped element or of the partition element.

It can be advantageous when the at least one temperature-control fluid passage is integrated into a material of the barrier zone on an internal surface of a barrier zone of the temperature-control fluid barrier. It can be advantageous when at least one further temperature-control fluid passage is integrated into a material of the opposite barrier zone on an opposite internal surface of an opposite barrier zone of the temperature-control fluid barrier.

It can be particularly advantageous when a plurality of the energy storage elements are cylindrical. It can be preferable when a plurality of the energy storage elements extend from the first temperature-control zone to the second temperature-control zone, for example from the first temperature-control zone through the partition element into the second temperature-control zone.

It can be particularly advantageous when the energy storage unit has at least one temperature-control fluid passage. Preferably, the at least one temperature-control fluid passage can connect the first temperature-control zone fluidically to the second temperature-control zone.

The at least one temperature-control fluid passage can preferably be located on a periphery of the temperature-control chamber, in particular on a periphery of the temperature-control chamber delimiting the extent of the temperature-control chamber in or counter to the second direction, for example the direction of width extent.

Preferably, at least one temperature-control fluid passage is located on a periphery of the temperature-control chamber, wherein the periphery delimits the extent of the temperature-control chamber in the second direction, e.g. the direction of width extent. Preferably, at least one temperature-control fluid passage is also located on an opposite periphery of the temperature-control chamber, wherein the opposite periphery delimits the extent of the temperature-control chamber counter to the second direction, e.g. the direction of width extent.

It is preferable when the energy storage unit has a plurality of temperature-control fluid passages, wherein the temperature-control fluid passages connect the first temperature-control zone fluidically with the second temperature-control zone.

It is preferable when the inlet is disposed along the second direction between two temperature-control fluid passages, wherein the temperature-control fluid passages between which the inlet is disposed can be offset in the first direction relative to the inlet.

It is particularly preferable when the inlet and also the outlet are disposed along the second direction between two temperature-control fluid passages, wherein the temperature-control fluid passages between which the inlet and also the outlet are disposed can be offset in the first direction relative to the inlet and also relative to the outlet.

It can be particularly advantageous when the energy storage unit comprises a temperature-control fluid guide element, wherein the temperature-control fluid guide element determines the course of the temperature-control fluid distribution channel or the course of the temperature-control fluid collection channel.

For example, the energy storage unit can comprise a first temperature-control fluid guide element which determines the course of the temperature-control fluid distribution channel, and a second temperature-control fluid guide element which determines the course of the temperature-control fluid collection channel.

It can be advantageous when the energy storage unit comprises a barrier element, e.g. a cover element, wherein the barrier element forms a barrier zone delimiting the temperature-control chamber and forms a channel barrier zone delimiting the temperature-control fluid distribution channel or the temperature-control fluid collection channel.

It can be particularly advantageous when the fluid distribution passage is a fluid distribution passage formed on the temperature-control fluid guide element that determines the course of the temperature-control fluid distribution channel.

It can be particularly advantageous when the fluid collection passage is a fluid collection passage formed on the temperature-control fluid guide element that determines the course of the temperature-control fluid collection channel.

It can be advantageous when the temperature-control fluid guide element is groove-shaped. The cross section of the temperature-control fluid guide element can be C-shaped or U-shaped, for example.

It can be advantageous when the energy storage unit comprises a temperature-control fluid guide zone. The temperature-control fluid guide zone can be, for example, a temperature-control fluid distribution zone or a temperature-control fluid collection zone.

Preferably, the energy storage unit can comprise a temperature-control fluid distribution zone and/or a temperature-control fluid collection zone.

For example, the energy storage unit can comprise a temperature-control fluid distribution zone and a temperature-control fluid collection zone.

The temperature-control fluid guide zone comprises a first guide zone portion and a second guide zone portion.

For example, the first guide zone portion can be a first distribution zone portion or a first collection zone portion.

For example, the second guide zone portion can be a second distribution zone portion or a second collection zone portion.

The first distribution zone portion can in particular be a first portion of the temperature-control fluid distribution zone.

The first collection zone portion can in particular be a first portion of the temperature-control fluid collection zone.

The second distribution zone portion can in particular be a second portion of the temperature-control fluid distribution zone.

The second collection zone portion can in particular be a second portion of the temperature-control fluid collection zone.

The two guide zone portions follow one another directly or indirectly in a temperature-control fluid flow direction in which the temperature-control fluid is able to be guided in the temperature-control fluid guide zone.

Alternatively, or in addition to the possibility that the two guide zone portions follow one another directly or indirectly in a temperature-control fluid flow direction in which the temperature-control fluid is able to be guided in the temperature-control fluid guide zone, the two guide zone portions can be mutually contiguous or mutually offset in a first direction, which can be, for example, the direction of longitudinal extent of the energy storage unit.

It can be particularly advantageous when the two guide zone portions are mutually contiguous or mutually offset in the first direction, which can be, for example, the direction of longitudinal extent of the energy storage unit.

It is preferred when a first guide zone portion extent of the first guide zone portion in the first direction is identical in size to a second guide zone portion extent of the second guide zone portion in the first direction.

In particular, lengths of the two guide zone portions that are measurable in the first direction can be of identical size.

It can be advantageous when the temperature-control fluid guide zone extends through a temperature-control fluid guide channel. The temperature-control fluid guide channel can be, for example, the temperature-control fluid distribution channel described herein or the temperature-control fluid collection channel described herein.

It can be advantageous when the temperature-control fluid distribution zone extends through the temperature-control fluid distribution channel.

It can be advantageous when the temperature-control fluid collection zone extends through the temperature-control fluid collection channel.

For example, the temperature-control fluid guide channel can comprise a first temperature-control fluid guide channel portion, e.g. a first temperature-control fluid distribution channel portion or a first temperature-control fluid collection channel portion.

For example, the temperature-control fluid guide channel can comprise a second temperature-control fluid guide channel portion, e.g. a second temperature-control fluid distribution channel portion or a second temperature-control fluid collection channel portion.

It can be advantageous when the first guide zone portion extends through the first temperature-control fluid guide channel portion.

It can be advantageous when the second guide zone portion extends through the second temperature-control fluid guide channel portion.

It can be advantageous when the temperature-control chamber has a temperature-control zone, e.g. a first temperature-control zone and a second temperature-control zone, wherein the temperature-control fluid guide zone is fluidically connected to the temperature-control zone via a passage or via a plurality of passages, wherein the passage or the passages are formed in such a way that a second flow resistance for the transfer of temperature-control fluid between the temperature-control zone and the second guide zone portion is lower than a first flow resistance for the transfer of temperature-control fluid between the temperature-control zone and the first guide zone portion.

Which of the flow resistances is lower can be tested by allowing a temperature-control fluid, which is supplied to the temperature-control fluid guide zone at a certain pressure, to flow only through the passage or the passages of the first guide zone portion over a defined period of time, and by measuring the volume of the temperature-control fluid that is obtained through the passage or the passages in this period of time. The test is then repeated for the second guide zone portion. The flow resistance for the transfer of temperature-control fluid between the temperature-control zone and the second guide zone portion is lower than the flow resistance for the transfer of temperature-control fluid between the temperature-control zone and the first guide zone portion when more temperature-control fluid is obtained via the passage or the passages from the second guide zone portion. The test can preferably be carried out on a temperature-control fluid guide element remote from the temperature-control chamber.

A passage described in the context of the guide zone portions can be, for example, a fluid collection passage or fluid distribution passage described herein.

Various possibilities have been found to form the passage or the passages in such a way that a second flow resistance for the transfer of temperature-control fluid between the temperature-control zone and the second guide zone portion is lower than a first flow resistance for the transfer of temperature-control fluid between the temperature-control zone and the first guide zone portion.

Thus, the passage can be V-shaped or wedge-shaped, for example, wherein a narrower portion of the passage extends through or into the first guide zone portion, and a wider portion of the passage extends through or into the second guide zone portion.

Webs can subdivide the V-shaped or wedge-shaped basic shape of the passage.

For example, a plurality of successive V-shaped, wedge-shaped or trapezoidal passages can follow one another or adjoin one another, wherein in particular ends of at least two V-shaped, wedge-shaped or trapezoidal passages can face one another.

It is possible that a narrower portion of a passage extends through or into the first guide zone portion and a wider portion of the passage extends through or into the second guide zone portion.

The passage can be a wave-shaped or any type of slot. A plurality of passages can be wave-shaped or any type of slots.

A plurality of passages can be round passages which are bores, for example. They can be distributed over the length of the temperature-control fluid guide zone in a temperature-control fluid flow direction or counter to a temperature-control fluid flow direction in which temperature-control fluid is able to be guided through the temperature-control fluid guide zone. For example, they can be disposed centrally on the temperature-control fluid guide zone, in particular centrally in terms of a second direction, which is, for example, the direction of width extent.

A spacing of passages can be smaller at the second guide zone portion than at the first guide zone portion.

Alternatively, the temperature-control chamber can have a temperature-control zone, e.g. a first temperature-control zone and a second temperature-control zone, wherein the temperature-control fluid guide zone is fluidically connected to the temperature-control zone via a passage or via a plurality of passages, wherein the passage or the passages are designed in such a way that a second flow resistance for the transfer of temperature-control fluid between the temperature-control zone and the second guide zone portion is greater than a first flow resistance for the transfer of temperature-control fluid between the temperature-control zone and the first guide zone portion. For example, the passage can be V-shaped or wedge-shaped, wherein a narrower portion of the passage extends through or into the second guide zone portion, and a wider portion of the passage extends through or into the first guide zone portion. Webs can subdivide the V-shaped or wedge-shaped basic shape of the passage. For example, a plurality of successive V-shaped, wedge-shaped or trapezoidal passages can follow one another or adjoin one another, wherein in particular ends of at least two V-shaped, wedge-shaped or trapezoidal passages can face one another. It is possible that a narrower portion of a passage extends through or into the second guide zone portion and a wider portion of the passage extends through or into the first guide zone portion. A distance of passages can be smaller at the first guide zone portion than at the second guide zone portion.

At least part of the passages can be disposed to be eccentric, e.g. be mutually offset in the second direction.

Passages can have a wide variety of shapes.

At least part of the passages can be round, sickle-shaped, oval and/or slot-shaped.

In the temperature-control chamber, in particular in at least one temperature-control zone, e.g. in the first and/or in the second temperature-control zone, a guide fin can be disposed.

In the temperature-control chamber, in particular in at least one temperature-control zone, e.g. in the first and/or in the second temperature-control zone, a plurality of guide fins can be disposed.

The guide fin or guide fins can contribute to the temperature-control fluid being distributed or guided uniformly in the temperature-control chamber, preferably in a temperature-control zone or in a plurality of temperature-control zones, e.g. in the first temperature-control zone and/or the second temperature-control zone.

For example, a guide fin can be disposed in such a way that it allows temperature-control fluid to be directed to a front end of the temperature-control chamber, which is facing away from the inlet, facilitating a Z-flow of the temperature-control fluid there.

At least two of a plurality of passages may vary in length, position and/or shape.

It can be advantageous when the temperature-control chamber has a temperature-control zone, for example a first temperature-control zone and a second temperature-control zone, wherein the temperature-control fluid guide zone is fluidically connected to the temperature-control zone via a passage or via a plurality of passages, wherein a dimension of a passage in the first guide zone portion is smaller than a dimension, preferably the corresponding dimension, of the same passage or another passage in the second guide zone portion, wherein the dimension can in particular be a diameter, for example a smallest diameter.

The smallest diameter is understood to be in particular the spacing between peripheries or walls of a passage extending through a central guide path of a temperature-control fluid which is able to be guided through the passage, said spacing being smaller than all other spacings between peripheries or walls of the same passage.

It can be advantageous when the temperature-control chamber has a temperature-control zone, for example a first temperature-control zone and a second temperature-control zone, wherein the temperature-control fluid guide zone is fluidically connected to the temperature-control zone via a passage or via a plurality of passages, wherein a first cross section of a passage in the first guide zone portion is smaller than a second cross section of the same passage or of another passage in the second guide zone portion.

The first cross section can in particular have a first cross-sectional area. The cross-sectional area can be in particular a smallest cross-sectional area of the passage in the first guide zone portion.

The second cross section can in particular have a second cross-sectional area. The cross-sectional area can in particular be a smallest cross-sectional area of the same passage or another passage in the second guide zone portion.

A cross-sectional area of a passage can extend in particular orthogonally to a flow direction in which temperature-control fluid can flow through the passage, i.e. transversely through the passage.

It can be advantageous when the temperature-control chamber has a temperature-control zone, for example a first temperature-control zone and a second temperature-control zone, wherein the temperature-control fluid guide zone is fluidically connected to the temperature-control zone via a passage or via a plurality of passages, wherein a number of passages in the first guide zone portion is less than a number of passages in the second guide zone portion.

It can be advantageous when the temperature-control fluid guide zone has a taper zone, wherein the temperature-control fluid guide zone in the taper zone tapers in the temperature-control fluid flow direction in which the temperature-control fluid is able to be guided in the temperature-control fluid guide zone. Alternatively, the temperature-control fluid guide zone in the taper zone can taper counter to the temperature-control fluid flow direction.

It can be advantageous when the temperature-control fluid guide zone in the taper zone tapers in a second direction which can be, for example, the direction of width extent of the energy storage unit.

It can be advantageous when the energy storage unit comprises a temperature-control fluid guide element, wherein the temperature-control fluid guide element determines the course of the temperature-control fluid guide zone.

It can be advantageous when the energy storage unit comprises a barrier element, for example a cover element, wherein the barrier element forms a barrier zone delimiting the temperature-control chamber and forms a channel barrier zone delimiting the temperature-control fluid guide zone, for example the temperature-control fluid guide channel.

It can be advantageous when the temperature-control fluid guide element is fixed to the barrier element and the temperature-control fluid guide element fixed to the barrier element determines the course of the temperature-control fluid guide zone.

It can be advantageous when the temperature-control fluid guide element and the barrier element are connected to one another in a materially integral manner.

For example, the temperature-control fluid guide element and the barrier element can be welded.

It can be particularly advantageous when the temperature-control fluid guide element contains a plastics material or is made of a plastics material, and the barrier element contains a plastics material or is made of a plastics material, and the two plastics materials are welded.

The two plastics materials can be identical or different and can optionally contain at least one reinforcing material, e.g. fibers, preferably glass fibers, carbon fibers or plastic fibers, independently of one another.

The energy storage unit can preferably comprise the temperature-control fluid distribution zone, the temperature-control fluid collection zone, the first temperature-control zone and the second temperature-control zone. The energy storage unit can preferably also have a temperature-control fluid passage described herein or a plurality of temperature-control fluid passages described herein. Preferably, the temperature-control fluid passage or the plurality of temperature-control fluid passages can connect the first temperature-control zone fluidically to the second temperature-control zone.

It can be particularly advantageous when the length of a shortest temperature-control path, which leads from a passage via the first temperature-control zone, through a temperature-control fluid passage into the second temperature-control zone and via the second temperature-control zone to another passage, is not more than 150%, preferably not more than 130%, particularly preferably not more than 100%, for example at most 80%, of a largest spacing which is able to be measured in a first direction, e.g. the direction of longitudinal extent, between passage ends that are mutually offset to the greatest extent in the first direction, e.g. the direction of longitudinal extent.

The length of the shortest temperature-control path can in this instance be measured in particular from a passage, via which the temperature-control fluid distribution zone is fluidically connected to the first temperature-control zone. The length of the shortest temperature-control path can in this instance be measured in particular towards another passage, via which the temperature-control fluid collection zone is fluidically connected to the second temperature-control zone.

It can be ascertained with little effort from the relative arrangement of passages and temperature-control fluid passages which one of a plurality of temperature-control paths is the shortest temperature-control path and how long the shortest temperature-control path is.

The largest spacing between passage ends, which are mutually offset to the greatest extent in the first direction, e.g. the direction of longitudinal extent, is determined either at the temperature-control fluid distribution zone or at the temperature-control fluid collection zone. If the two largest spacings between the passage ends at the temperature-control fluid distribution zone and at the temperature-control fluid collection zone differ, the larger of the two distances is decisive.

The spacing between the passage ends in the first direction, e.g. the direction of longitudinal extent, is measured, wherein the spacing from the two points of the one or of the plurality of passages that are furthest apart in the first direction is decisive.

It is preferable when the temperature-control chamber is able be supplied through the inlet via the temperature-control fluid distribution zone, through the first distribution zone portion and the second distribution zone portion and through the passage or the plurality of passages with the temperature-control fluid or at least a part of the temperature-control fluid.

It is preferable when the temperature-control fluid or at least a part of the temperature-control fluid is able to be discharged from the temperature-control chamber through the passage or the plurality of passages, through the first collection zone portion and the second collection zone portion via the temperature-control fluid collection zone and through the outlet.

For example, the second guide zone portion can be offset relative to the inlet to a greater extent in or counter to the first direction than the first guide zone portion. This can apply in particular when the temperature-control fluid guide zone or one of the temperature-control fluid guide zones is the temperature-control fluid distribution zone, the first guide zone portion is the first distribution zone portion, and the second guide zone portion is the second distribution zone portion.

For example, the second guide zone portion can be offset relative to the outlet to a greater extent in or counter to the first direction than the first guide zone portion. This can apply in particular when the temperature-control fluid guide zone or one of the temperature-control fluid guide zones is the temperature-control fluid collection zone, the first guide zone portion is the first collection zone portion, and the second guide zone portion is the second collection zone portion.

It can be advantageous when the first temperature-control fluid distribution channel portion is the first portion of the temperature-control fluid distribution channel described herein.

It can be advantageous when the second temperature-control fluid distribution channel portion is the second portion of the temperature-control fluid distribution channel described herein.

It can be advantageous when the first temperature-control fluid collection channel portion is the first portion of the temperature-control fluid collection channel described herein.

It can be advantageous when the second temperature-control fluid collection channel portion is the second portion of the temperature-control fluid collection channel described herein.

It can be advantageous when the temperature-control chamber has a first temperature-control zone and a second temperature-control zone and the energy storage unit has a temperature-control fluid passage or a plurality of temperature-control fluid passages, wherein the one temperature-control fluid passage connects the first temperature-control zone fluidically to the second temperature-control zone or a plurality of the temperature-control fluid passages connect the first temperature-control zone fluidically to the second temperature-control zone.

When the temperature-control chamber has a first temperature-control zone and a second temperature-control zone and the energy storage unit has a temperature-control fluid passage, wherein the one temperature-control fluid passage connects the first temperature-control zone fluidically to the second temperature-control zone, the passage can be, for example, a passage of which the measurable length in a first direction, e.g. the direction of longitudinal extent of the energy storage unit, is at least 70%, preferably at least 80%, of a length of the energy storage unit that is able to be measured in the first direction.

The statement that the one temperature-control fluid passage connects the first temperature-control zone fluidically to the second temperature-control zone or that a plurality of the temperature-control fluid passages connect the first temperature-control zone fluidically to the second temperature-control zone can mean that the one temperature-control fluid passage fluidically connects the first temperature-control zone fluid-directly to the second temperature-control zone or a plurality of the temperature-control fluid passages fluidically connect the first temperature-control zone directly to the second temperature-control zone.

The statement that the one temperature-control fluid passage connects the first temperature-control zone fluidically to the second temperature-control zone or that a plurality of the temperature-control fluid passages connect the first temperature-control zone fluidically to the second temperature-control zone can mean that the one temperature-control fluid passage fluidically connects the first temperature-control zone indirectly to the second temperature-control zone or a plurality of the temperature-control fluid passages fluidically connect the first temperature-control zone indirectly to the second temperature-control zone. For example, the one temperature-control fluid passage can fluidically connect the first temperature-control zone via a further temperature-control zone or via a plurality of further temperature-control zones to the second temperature-control zone, or a plurality of the temperature-control fluid passages can fluidically connect the first temperature-control zone via a further temperature-control zone or via a plurality of further temperature-control zones to the second temperature-control zone.

An optional additional temperature-control zone can be located between the first temperature-control zone and the second temperature-control zone.

A plurality of optional additional temperature-control zones can be located between the first temperature-control zone and the second temperature-control zone.

It can be advantageous when there is no further temperature-control zone located between the first temperature-control zone and the second temperature-control zone.

It can be advantageous when the one temperature-control fluid passage or a plurality of the temperature-control fluid passages comprise a first penetration portion and a second penetration portion, wherein a first penetration portion extent of the first penetration portion in a first direction, for example the direction of longitudinal extent, is identical in size to a second penetration portion extent of the second penetration portion in the first direction, wherein the two penetration portions are mutually contiguous or mutually offset in the first direction.

Preferably, the second penetration portion can be offset relative to an inlet of the energy storage unit described herein and/or relative to an outlet of the energy storage unit described herein to a greater extent in the first direction than the first penetration portion.

It can be advantageous when the temperature-control fluid passage or the temperature-control fluid passages are designed in such a way that a second penetration flow resistance for the penetration of temperature-control fluid from the first temperature-control zone into the second temperature-control zone in the second penetration portion is lower than a first penetration flow resistance for the penetration of temperature-control fluid from the first temperature-control zone into the second temperature-control zone in the first penetration portion.

The penetration flow resistances in the two penetration portions can be tested and compared as described herein for flow resistances with reference to passages that have been described in the context of guide zone portions.

This can be advantageous, as there can be a lesser pressure gradient via the second penetration portion than via the first penetration portion in the operation of the energy storage unit. The comparatively lower second penetration flow resistance relative to the first penetration flow resistance can contribute to ensuring that nevertheless exactly as much or approximately exactly as much temperature-control fluid can flow into the second temperature-control zone via the second penetration portion. A cause for the lower pressure gradient existing over the second penetration portion can be that the inlet and/or the outlet are farther away from the second penetration portion than from the first penetration portion.

It can be advantageous when the energy storage unit has an inlet described herein and an outlet described herein, for example an inlet through which a temperature-control fluid can be directed into the energy storage unit, and an outlet through which a temperature-control fluid can flow out of the energy storage unit, wherein a second temperature-control fluid guide path leading from the inlet to the outlet centrally through the second penetration portion is longer than a first temperature-control fluid guide path leading from the inlet to the outlet centrally through the first penetration portion.

It can be advantageous when a dimension of a temperature-control fluid passage in the first penetration portion is smaller than a dimension of the same temperature-control fluid passage or of another temperature-control fluid passage in the second penetration portion.

It can be advantageous when a dimension of a temperature-control fluid passage in the first penetration portion is smaller than the corresponding dimension of the same temperature-control fluid passage or of another temperature-control fluid passage in the second penetration portion.

In particular, the dimension can be a diameter. For example, the diameter can be a smallest diameter.

It can be advantageous when a first cross section of a temperature-control fluid passage in the first penetration portion is smaller than a second cross section of the same temperature-control fluid passage or of another temperature-control fluid passage in the second penetration portion.

If reference is made herein to a cross section of a temperature-control fluid passage, this can in particular mean a cross-sectional area of the temperature-control fluid passage, in particular a cross-sectional area at a narrowest point of the temperature-control fluid passage.

It can be advantageous when a first cross-sectional area of a temperature-control fluid passage in the first penetration portion is smaller than a second cross-sectional area of the same temperature-control fluid passage or of another temperature-control fluid passage in the second penetration portion.

It can be advantageous when a first cross-sectional area of a temperature-control fluid passage at a narrowest point of the temperature-control fluid passage in the first penetration portion is smaller than a second cross-sectional area at a narrowest point of the same temperature-control fluid passage or of another temperature-control fluid passage in the second penetration portion.

Alternatively, the temperature-control fluid passage or the temperature-control fluid passages can be designed in such a way that a second penetration flow resistance for the penetration of temperature-control fluid from the first temperature-control zone into the second temperature-control zone in the second penetration portion is greater than a first penetration flow resistance for the penetration of temperature-control fluid from the first temperature-control zone into the second temperature-control zone in the first penetration portion. It can be advantageous when a dimension of a temperature-control fluid passage in the first penetration portion is larger than a dimension of the same temperature-control fluid passage or of another temperature-control fluid passage in the second penetration portion. It can be advantageous when a dimension of a temperature-control fluid passage in the first penetration portion is larger than the corresponding dimension of the same temperature-control fluid passage or of another temperature-control fluid passage in the second penetration portion. It can be advantageous when a first cross section of a temperature-control fluid passage in the first penetration portion is larger than a second cross section of the same temperature-control fluid passage or of another temperature-control fluid passage in the second penetration portion. It can be advantageous when a first cross-sectional area of a temperature-control fluid passage in the first penetration portion is larger than a second cross-sectional area of the same temperature-control fluid passage or of another temperature-control fluid passage in the second penetration portion. It can be advantageous when a first cross-sectional area of a temperature-control fluid passage at a narrowest point of the temperature-control fluid passage in the first penetration portion is larger than a second cross-sectional area at a narrowest point of the same temperature-control fluid passage or of another temperature-control fluid passage in the second penetration portion.

Alternatively, the temperature-control fluid passage or the temperature-control fluid passages can be designed in such a way that a second penetration flow resistance for the penetration of temperature-control fluid from the first temperature-control zone into the second temperature-control zone in the second penetration portion is identical in size to a first penetration flow resistance for the penetration of temperature-control fluid from the first temperature-control zone into the second temperature-control zone in the first penetration portion.

It can be particularly advantageous when the passage or the passages are formed in such a way and the temperature-control fluid passage or the temperature-control fluid passages are formed and adapted to the passage or the passages in such a way that in all regions of a temperature-control zone, e.g. in all regions of the first temperature-control zone, an identical flow of the temperature-control fluid and/or the same flow velocity of the temperature-control fluid and/or a uniform temperature control of all energy storage elements that are able to be temperature-controlled by means of the temperature-control fluid, can be achieved in a main flow direction.

It is conceivable, for example, that elements, e.g. throttles/apertures, are used in temperature-control fluid passages, which, for example, can comprise pipe or line portions with a round cross section, or that cross-sectional adaptations of temperature-control fluid passages are brought about by machining, e.g. by boring.

It can be advantageous when the temperature-control fluid barrier has two longitudinal sides and one temperature-control fluid passage or a plurality of temperature-control fluid passages is/are in each case disposed or formed internally on the temperature-control fluid barrier along the two longitudinal sides of the temperature-control fluid barrier.

It can be particularly advantageous when the temperature-control fluid barrier has two longitudinal sides and a plurality of temperature-control fluid passages are in each case disposed or formed internally on the temperature-control fluid barrier along the two longitudinal sides of the temperature-control fluid barrier.

In particular, those sides of the temperature-control fluid barrier that extend, in particular extend in a planar manner, along the first direction, for example, the direction of longitudinal extent, and the third direction, for example, the direction of height extent, are referred to as longitudinal sides, wherein the longitudinal sides of the temperature-control fluid barrier delimit the temperature-control chamber in particular in the second direction, for example in the direction of width extent, on both sides.

It can be preferable when the temperature-control fluid barrier has two frontal sides and no temperature-control fluid passage which fluidically connects the first temperature-control zone to the second temperature-control zone is disposed along the two frontal sides of the temperature-control fluid barrier.

It can be advantageous when a temperature-control fluid passage extends on an internal surface of a longitudinal side in the third direction, e.g. the direction of height extent, e.g. through a material, of which at least the longitudinal side of the temperature-control fluid barrier consists or is made, or through a material of which a partition element described herein consists or is made, the latter surrounding a plurality of the energy storage elements. For example, the partition element can be the shaped element described herein.

The partition element or the shaped element can be a carrier element on which a plurality of energy storage elements of the energy storage unit are fixed.

A temperature-control fluid passage, a plurality of temperature-control fluid passages or all temperature-control fluid passages can be made by casting from a plastics material, e.g. by injection molding.

It can be advantageous when a number of temperature-control fluid passages in the first penetration portion is less than a number of temperature-control fluid passages in the second penetration portion.

An embodiment according to the invention of a temperature-control fluid passage can contribute to a more uniform distribution of temperature-control fluid in the energy storage unit being achieved or facilitated. This can especially help to optimize a cooling function.

It can be advantageous when in a main flow direction which runs parallel to a second direction, for example a direction of width extent, or counter to the second direction through the first temperature-control zone towards the temperature-control fluid passage, proceeding from a temperature-control fluid distribution zone, at most 20 energy storage elements, preferably at most 18 energy storage elements, particularly preferably at most 16 energy storage elements, most particularly preferably at most 14 energy storage elements, e.g. at most 12 energy storage elements, are able to be impacted by a flow and/or surrounded by a flow and/or temperature-controlled by means of the temperature-control fluid that is able to be guided in the main flow direction. The number of energy storage elements that are able to be impacted by a flow in the main flow direction and/or surrounded by a flow and/or temperature-controlled by means of the temperature-control fluid that is able to be guided in the main flow direction can be at least 2, preferably at least 3, e.g. at least 4.

It can be advantageous when in a main flow direction parallel to a second direction, e.g. a direction of width extent, or counter to the second direction through the first temperature-control zone towards the temperature-control fluid passage, proceeding from a temperature-control fluid distribution zone, at most 20 energy storage elements, preferably at most 18 energy storage elements, particularly preferably at most 16 energy storage elements, most preferably at most 14 energy storage elements, for example at most 12 energy storage elements, can be temperature-controlled by means of the temperature-control fluid that is able to be guided in the main flow direction.

The largest number of energy storage elements which are intersected by a main flow direction plane can be decisive in this context. The main flow direction can extend in the main flow direction plane. The main flow direction plane is intersected orthogonally by the first direction, e.g. the direction of longitudinal extent. The main flow direction plane extends in or counter to the second direction from outside the energy storage unit only to the center of the temperature-control fluid distribution zone. The position of the main flow direction plane is selected along the first direction in particular in such a way that a largest number of energy storage elements are intersected by the main flow direction plane.

It can be preferable when in a main counterflow direction, which runs counter to the main flow direction through the second temperature-control zone towards a temperature-control fluid collection zone, proceeding from the temperature-control fluid passage, at most 20 energy storage elements, preferably at most 18 energy storage elements, particularly preferably at most 16 energy storage elements, most preferably at most 14 energy storage elements, e.g. at most 12 energy storage elements, are able to be impacted by a flow and/or surrounded by a flow and/or temperature-controlled by means of the temperature-control fluid that is able to be guided in the main counterflow direction. The number of energy storage elements that are able to be impacted by a flow and/or surrounded by a flow in the main counterflow direction and/or temperature-controlled by means of the temperature-control fluid that is able to be guided in the main flow direction can be at least 2, preferably at least 3, e.g. at least 4.

It can be preferable when in a main counterflow direction which runs counter to the main flow direction through the second temperature-control zone towards a temperature-control fluid collection zone, proceeding from the temperature-control fluid passage, at most 20 energy storage elements, preferably at most 18 energy storage elements, particularly preferably at most 16 energy storage elements, most preferably at most 14 energy storage elements, e.g. at most 12 energy storage elements, are able to be temperature-controlled by means of the temperature-control fluid that is able to be guided in the main counterflow direction.

In particular, the largest number of energy storage elements which are intersected by a main counterflow direction plane can be decisive in this context. The main counterflow direction can extend in the main counterflow direction plane. The main counterflow direction plane is intersected orthogonally by the first direction, e.g. the direction of longitudinal extent. The main counterflow direction plane extends counter to or in the second direction from outside the energy storage unit only to the center of the temperature-control fluid distribution zone. The position of the main counterflow direction plane is selected along the first direction in particular in such a way that a largest number of energy storage elements are intersected by the main counterflow direction plane.

The main counterflow direction plane can be the main flow direction plane.

It can be advantageous when in the main flow direction in the first temperature-control zone, first ends of the at most 20 energy storage elements, preferably at most 18 energy storage elements, particularly preferably at most 16 energy storage elements, most preferably at most 14 energy storage elements, e.g. at most 12 energy storage elements, are able to be impacted by a flow and/or surrounded by a flow and/or temperature-controlled by means of the temperature-control fluid that is able to be guided in the main flow direction;
and/or
in the main counterflow direction in the second temperature-control zone, second ends of the at most 20 energy storage elements, preferably at most 18 energy storage elements, particularly preferably at most 16 energy storage elements, most preferably at most 14 energy storage elements, e.g. at most 12 energy storage elements, are able to be impacted by a flow and/or surrounded by a flow and/or temperature-controlled by means of the temperature-control fluid that is able to be guided in the main counterflow direction.

It can be preferable when the first ends and the second ends are mutually opposite ends of the same at most 20 energy storage elements, preferably at most 18 energy storage elements, particularly preferably at most 16 energy storage elements, most preferably at most 14 energy storage elements, for example at most 12 energy storage elements.

It can be advantageous when the temperature-control chamber has a temperature-control zone, for example a first temperature-control zone, wherein the energy storage unit comprises a flow interference unit which is disposed in the temperature-control zone or is disposed or formed on a surface facing the temperature-control zone of the energy storage unit.

Any unit that can act as a turbulator can be considered a flow interference unit. The flow interference unit can have a passage zone extending through the contacting element.

While a temperature-control fluid which is able to be guided in the temperature-control zone tends to a laminar flow at certain flow velocities, more turbulence can occur at the flow interference unit at the same flow velocity, which can lead to increased cooling of one or more energy storage elements due to the more intense mixing of the temperature-control fluid.

The passage zone can connect a zone, which is farther away from an energy storage element and which is able to be passed through by a flow of temperature-control fluid, fluidically to a contact temperature-control zone described herein. The more remote zone can be offset from the contact temperature-control zone, particularly in or counter to the third direction, e.g. the direction of height extent, to a greater extent than the contact temperature-control zone.

The zone more remote from the energy storage element can lead in particular in or counter to the second direction, for example the direction of width extent, towards a fluid deflection element which can facilitate a deflection of temperature-control fluid through the passage zone to the contact temperature-control zone described herein.

The temperature-control zone, in which the flow interference unit can be disposed, can in particular be the first temperature-control zone which is also described herein without reference to the flow interference unit.

The surface on which the flow interference unit can be disposed or formed can in particular face the first temperature-control zone, which is also described herein without reference to the flow interference unit.

It can be advantageous when the temperature-control chamber has a temperature-control zone, for example a first temperature-control zone, wherein the energy storage unit comprises a current conductor element which extends from the interior of one of the energy storage elements up to the temperature-control zone or into the temperature-control zone and which is able to be temperature-controlled in the temperature-control zone by means of the temperature-control fluid.

The temperature-control zone in which the current conductor element is able to be temperature-controlled by means of the temperature-control fluid can in particular be the first temperature-control zone, which is also described herein without reference to the current control element.

It can be advantageous when the temperature-control chamber also has a second temperature-control zone, for example a second temperature-control zone described herein also without reference to the flow interference unit or to the current conductor element.

It can be advantageous when the energy storage unit comprises a contacting element through which at least a portion of an electrically conducting connection of at least one of the energy storage elements of the energy storage unit to a contacting zone of the energy storage unit is able to be established or exists, wherein it can be preferable when the electrical energy or part of the electrical energy is able to be retrieved from the energy storage unit and/or supplied to the energy storage unit via the contacting zone and the contacting element.

The contacting zone can comprise a terminal, for example a first terminal, or be formed thereon, wherein the terminal is usable for retrieving electrical energy from the energy storage unit and/or for supplying electrical energy to the energy storage unit.

It can be advantageous when the contacting element extends into the temperature-control zone, out of the temperature-control zone and/or through the temperature-control zone. It can be particularly advantageous when the contacting element extends into the first temperature-control zone, out of the first temperature-control zone and/or through the first temperature-control zone.

It can be advantageous when the contacting element has the flow interference unit, or the flow interference unit is formed on the contacting element.

It can be advantageous when at least a portion of the temperature-control zone, for example the first temperature-control zone, extends on the contacting element up to the current conductor element and/or about the current conductor element.

It can be advantageous when the energy storage unit comprises a connecting zone in which the storage element contact zones of different energy storage elements are connected to one another in an electrically conducting manner, wherein the storage element contact zones can preferably be poles of the energy storage elements, for example positive poles and negative poles.

One of the storage element contact zone can be present, for example, on a surface of the current conductor element.

It can be advantageous when a portion of the contacting element extends at least along a portion of the connecting zone. The portion of the connecting zone can preferably lie between one or a plurality of the energy storage elements and the portion of the contacting element.

It can be advantageous when a connecting device or a plurality of connecting devices is/are disposed in the connecting zone. The storage element contact zones of different energy storage elements can be connected to one another in an electrically conducting manner via the connecting device or via the connecting devices.

It can be advantageous when an insulation material prevents direct electrical contact of the portion of the contacting element with the portion of the connecting zone. It can be preferable when the contacting element comprises the insulation material, e.g. a layer of the insulation material on a surface of the contacting element.

It can be advantageous when at least one of the energy storage elements has a first end facing the first temperature-control zone or protruding into the first temperature-control zone, wherein it can be preferable when two storage element contact zones, for example the positive pole and the negative pole, are disposed on the first end.

It can be advantageous when at least one of the energy storage elements has a second end facing the second temperature-control zone or projecting into the second temperature-control zone, wherein it can be preferable when two storage element contact zones, for example the positive pole and the negative pole, are disposed on the first end.

Alternatively, two storage element contact zones, such as the positive pole and the negative pole, can be disposed on the second end.

It can be advantageous when the contacting element has a reinforcement element recess, wherein the temperature-control fluid barrier has a barrier zone, e.g. a wall zone, wherein the barrier zone is reinforced by means of a reinforcement element, wherein the reinforcement element extends from the barrier zone into the temperature-control chamber through the reinforcement element recess.

For example, the contacting element can be grid-shaped, this resulting in regularly spaced-apart recesses caused by the grid shape, the reinforcement element extending through one of the recesses resulting from the grid shape. This recess then forms a reinforcement element recess.

Corresponding reinforcement element recesses can be present in particular or only at those points where reinforcement elements are provided, for example.

It can be advantageous when the first reinforcement element and at least two, preferably at least four, particularly preferably at least six, e.g. at least eight, of the further reinforcement elements extend from the first barrier zone to the second barrier zone through a reinforcement element recess or a plurality of reinforcement element recesses, preferably through a plurality of reinforcement element recesses.

The contacting element can have, for example, a plurality of recesses which are mutually offset in a first direction, e.g. the direction of longitudinal extent, for example at least three recesses which are mutually offset in the first direction, wherein a plurality of reinforcement elements, for example at least three reinforcement elements, extend through the mutually offset recesses.

It can be particularly advantageous when the energy storage unit comprises a monitoring unit.

In particular, the monitoring unit can be a monitoring circuit. For example, the monitoring circuit can be a cell monitoring circuit.

In particular, by means of the monitoring unit, differences in the charge states of a plurality of the energy storage elements can be able to be completely or partially avoidable, or able to be compensated for.

In the plurality of energy storage elements mentioned in the context of the monitoring unit, this can be the plurality of the energy storage elements which are mentioned in the context of the temperature control by means of the temperature-control fluid in the temperature-control chamber.

When reference herein is made in one context to a plurality of energy storage elements of the energy storage unit and is likewise made in another context to a plurality of energy storage elements of the energy storage unit, the two groups of energy storage elements referred to in each case by the word plurality do not have to be identical. For example, it is conceivable that the plurality of the energy storage elements that are able to be temperature-controlled in the temperature-control chamber by means of the temperature-control fluid refer to a group of energy storage elements which is not, or is partially or completely identical to a plurality of energy storage elements mentioned herein in another context.

For example, it is thus conceivable that the energy storage unit, in addition to the plurality of the energy storage elements that are able be temperature-controlled in the temperature-control chamber by means of the temperature-control fluid, comprises further energy storage elements.

It is conceivable that at least one energy storage element of these further energy storage elements belongs to the plurality of energy storage elements mentioned in the context of the monitoring unit.

It can be advantageous when the monitoring unit is disposed in the temperature-control chamber and/or extends into the temperature-control chamber and/or the temperature-control fluid barrier also extends about the monitoring unit.

Preferably, the monitoring unit can meet at least one of the following three conditions with respect to the temperature-control chamber or the temperature-control fluid barrier:
Condition 1: The monitoring unit is disposed in the temperature-control chamber.
Condition 2: The monitoring unit extends into the temperature-control chamber.
Condition 3: The temperature-control fluid barrier also extends about the monitoring unit.

It can be advantageous when a shielding material which prevents or reduces an inflow of the temperature-control fluid into the monitoring unit is disposed on the monitoring unit or between the monitoring unit and the temperature-control chamber. This, too, can contribute to providing an efficient energy storage unit in the simplest possible way. In particular, air pockets can be avoided in the installation space around the monitoring unit. At the same time, contacting the energy storage elements within the temperature-control fluid barrier can be enabled since electrically conducting connections between the monitoring unit and the energy storage elements within the temperature-control fluid barrier can be established and thus there is no need for establishing complicated plug seals in the region of the temperature-control fluid barrier.

It can be advantageous when the monitoring unit is completely or partially embedded in the shielding material.

Preferably, the shielding material can comprise a plastics material or be made of the plastics material.

Preferably, the shielding material, for example the plastics material, can be porous.

It can be particularly advantageous when the shielding material, e.g. the plastics material, is in the form of foam.

For example, the shielding material can be a plastic foam material.

It can be preferable when the shielding material, for example the plastics material in the form of foam or the plastic foam material, is fluid-tight.

A mean density of the shielding material, for example of the plastics material in the form of foam or the plastic foam material, can preferably not be more than 0.7 g/cm³, particularly preferably not be more than 0.5 g/cm³, most preferably not be more than 0.3 g/cm³, for example be at most 0.15 g/cm³.

It can be advantageous when the mean density of the shielding material, for example of the plastics material in the form of foam or the plastic foam material, is at least 0.0005 g/cm³, particularly preferably at least 0.0015 g/cm³, very particularly preferably at least 0.01 g/cm³, for example at least 0.015 g/cm³.

The plastics material in the form of foam or the plastic foam material can, for example, be a hard foam material. Hard foam materials can be polyurethane foams, for example.

Preferably, the plastics material in the form of foam or the plastic foam material comprises a closed-cell foam material.

The object is achieved according to the invention by a monitoring unit as claimed in the respective independent claim.

By means of the monitoring unit, differences in the charge states of a plurality of energy storage elements of an energy storage unit are able to be completely or partially avoidable, or able to be compensated for.

Preferably, by means of the monitoring unit, differences in the charge states of a plurality of energy storage elements of an energy storage module, for example of an electrochemical energy storage module, are able to be completely or partially avoidable, or able to be compensated for.

The monitoring unit according to the invention can in particular be a monitoring circuit. For example, the monitoring circuit can be a cell monitoring circuit. Cell monitoring circuits are known in the industry as so-called Cell Supervisory Circuits (CSC).

The monitoring unit according to the invention is completely or partially embedded in a shielding material.

The shielding material has been described in the context of the energy storage unit according to the invention. For this reason, the information pertaining to the shielding material provided there will not be repeated.

The object is achieved according to the invention by a method for producing an energy storage unit as claimed in the respective independent claim.

The method can be, for example, a method for producing an energy storage unit according to the invention described herein.

In the method, a monitoring unit, by means of which differences in the charge states of a plurality of energy storage elements of an energy storage unit are entirely or partially avoidable, or are able to be compensated for, is disposed in a monitoring space or a monitoring zone, and the monitoring space or the monitoring zone are filled with expanded foam.

The monitoring space or the monitoring zone can be a space surrounded by a temperature-control fluid barrier or a zone surrounded by a temperature-control fluid barrier. The temperature-control fluid barrier can be a housing of the energy storage unit or a part of a housing of an energy storage unit.

In particular, any foaming agent from which a shielding material described herein, for example, the plastics material in the form of foam described herein or the plastic foam material described herein, can be produced is suitable for filling the monitoring space or the monitoring zone with expanded foam.

It can be particularly advantageous when the monitoring unit is incorporated into the monitoring space or the monitoring zone and the filling with expanded foam takes place in a later method step.

It is conceivable that further method steps take place between the incorporation of the monitoring unit into the monitoring space or the monitoring zone and that the filling with expanded foam takes place in a subsequent method step downstream of the further method steps. The further method steps can comprise, for example, an incorporation of energy storage elements into the energy storage unit or the temperature-control fluid barrier.

It can be advantageous when the monitoring space or the monitoring zone is completely or partially filled with expanded foam, for example with a foaming agent, and the disposal of the monitoring unit in the monitoring space or the monitoring zone, for example in the foaming agent located therein, takes place in a later method step.

Even while the monitoring space or monitoring zone is fully or partially filled with expanded foam and the disposal of the monitoring unit in the monitoring space or the monitoring zone takes place in a later method step, further method steps can take place between the filling with expanded foam and the disposal of the monitoring unit.

The object is achieved according to the invention by a contacting system as claimed in the respective independent claim.

The contacting system is a contacting system for contacting energy storage elements of an energy storage unit.

Preferably, the contacting system can be a contacting system for contacting energy storage elements of an energy storage unit according to the invention described herein.

The contacting system can simultaneously be a system for guiding a temperature-control fluid in a temperature-control zone of an energy storage unit.

The contacting system can be a contacting and temperature-control fluid guide system.

The contacting system comprises an electrically conductive contacting element and a flow interference unit, wherein the contacting element comprises the flow interference unit or the flow interference unit is formed on the contacting element.

The contacting element can be particularly suitable for disposal in a temperature-control zone of the energy storage unit or for disposal on a surface of the energy storage unit, wherein the surface faces a temperature-control zone of the energy storage unit.

It can be advantageous when the contacting system comprises a connecting device.

It can be advantageous when the connecting device has at least two connecting zones which are connected to one another in an electrically conducting manner, e.g. a positive-pole connecting zone and a negative-pole connecting zone.

In particular, a contact from the negative pole of an energy storage element to the positive pole of another energy storage element can be able to be established via the connecting zones connected in an electrically conducting manner.

It can be advantageous when the flow interference unit is a flow interference unit communicating with at least one of the connecting zones, for example, a flow interference unit communicating with the positive pole connecting zone.

It can be advantageous when the connecting device is a first connecting device, wherein the contacting system comprises a second connecting device, wherein also the second connecting device has at least two connecting zones which are connected to one another in an electrically conducting manner, for example a positive-pole connecting zone and a negative-pole connecting zone, wherein a negative-pole connecting zone is formed on a contact portion of the first connecting device and a positive-pole connecting zone is formed on a contact portion of the second connecting device, said two contact portions extending into a contact temperature-control zone or being contiguous to a contact temperature-control zone.

It can be advantageous when the flow interference unit is located in or at the contact temperature-control zone.

It can be particularly advantageous when the contacting element has the flow interference unit at the contact temperature-control zone, or the flow interference unit on the contacting element is formed at the contact temperature-control zone.

The object is achieved according to the invention by a method for controlling the temperature of energy storage elements of an energy storage unit as claimed in the respective independent claim.

The method can be a method for controlling the temperature of electrochemical energy storage elements, e.g. of battery cells, of the energy storage unit.

In the context of the method, the energy storage unit can in particular be an energy storage unit according to the invention described herein.

A temperature-control fluid is supplied to a first central region of a first temperature-control zone of the energy storage unit, wherein the first central region extends in a longitudinal direction of the first temperature-control zone through the first temperature-control zone and divides the first temperature-control zone into a first outflow zone located on one side of the first central region and a second outflow zone located on the other side of the first central region,
wherein the temperature-control fluid supplied to the first temperature-control zone is divided among the first outflow zone and the second outflow zone, where it is in each case guided so as to be in heat exchange contact with part of the energy storage elements of the energy storage unit. This can represent a method step.

It can be advantageous when the temperature-control fluid which in an indirectly or directly preceding method step has been guided so as to be in each case in heat exchange contact with part of the energy storage elements is discharged from the energy storage unit, e.g. through the outlet described herein.

It can be advantageous when at least part of the temperature-control fluid supplied to the first temperature-control zone spreads out in mutually opposite main flow directions in the first outflow zone and in the second outflow zone.

It can be advantageous when the number of energy storage elements in sequence along the main flow directions, proceeding from the first central region, is so small and so much temperature-control fluid is conveyed through the energy storage unit that the temperature of the temperature-control fluid discharged from the energy storage unit, e.g. temperature-control fluid discharged through the outlet, in the case of a charging operation of the energy storage unit in which the energy storage unit is transferred from a charge state of 20% to a charge state of 80% in less than 15 minutes, does not exceed a temperature of the temperature-control fluid flowing into the energy storage unit, e.g. temperature-control fluid flowing in through the inlet, by more than 6 K, preferably by not more than 4 K, e.g. not more than 2.5 K, e.g. by not more than 6 K, preferably not more than 4 K, e.g. not more than 2.5 K.

Advantageously, the number of successive energy storage elements along the main flow directions from the first central region can in each case be at most 20, preferably at most 18, particularly preferably at most 16, most particularly preferably at most 14, e.g. at most 12. Advantageously, the number can be at least 2, preferably at least 3, e.g. at least 4.

It can be advantageous when a first proportion of the temperature-control fluid is guided through a temperature-control fluid passage or through a plurality of temperature-control fluid passages at a first end of the outflow zone that is separated from the first central region, and a second proportion of the temperature-control fluid is guided through another temperature-control fluid passage or through a plurality of temperature-control fluid passages at a second end of the second outflow zone that is separated from the first central region.

It can be advantageous when the temperature-control fluid is discharged from the energy storage unit via a second central region of a second temperature-control zone, e.g. through the outlet described herein, wherein the second central region extends in a longitudinal direction of the second temperature-control zone through the second temperature-control zone and divides the second temperature-control zone into a first inflow zone lying on one side of the second central region and into a second inflow zone lying on the other side of the second central region.

It can be advantageous when the first proportion of the temperature-control fluid is guided out of the one temperature-control fluid passage or out of the plurality of temperature-control fluid passages at a first end of the first inflow zone that is separated from the second central region, and the second proportion of the temperature-control fluid is guided out of the other temperature-control fluid passage or out of the plurality of other temperature-control fluid passages at a second end of the second inflow zone that is separated from the second central region.

Advantageously, the first proportion of the temperature-control fluid can be guided via the first inflow zone into the second central region.

Advantageously, the second proportion of the temperature-control fluid can be guided via the second inflow zone into the second central region.

The two proportions of the temperature-control fluid can be guided in the inflow zones so as to be in each case in heat exchange contact with part of the energy storage elements of the energy storage unit.

It can be advantageous when the inlet is fluidically connected to the first central region via a temperature-control fluid guide channel described herein, which can be, for example, the temperature-control fluid distribution channel, and/or via a temperature-control fluid guide zone described herein, which can be, for example, the temperature-control fluid distribution zone.

For example, the temperature-control fluid guide channel described herein, which can be, for example, the temperature-control fluid distribution channel, and/or the temperature-control fluid guide zone described herein, which can be, for example, the temperature-control fluid distribution zone, can extend along the first central region and/or completely or partially cover the first central region. The first central region can, for example, run between energy storage elements and the temperature-control fluid distribution channel and/or the temperature-control fluid distribution zone.

It can be advantageous when the inlet is fluidically connected to the first outflow zone and to the second outflow zone via a temperature-control fluid guide channel described herein, which can be, for example, the temperature-control fluid distribution channel, and/or via a temperature-control fluid guide zone described herein, which can be, for example, the temperature-control fluid distribution zone.

It can be advantageous when a temperature-control fluid guide channel described herein, which can be, for example, the temperature-control fluid distribution channel, and/or a temperature-control fluid guide zone described herein, which can be, for example, the temperature-control fluid distribution zone, forms the first central region.

It can be advantageous when the second central region is fluidically connected to the outlet via a temperature-control fluid guide channel described herein, which can be, for example, the temperature-control fluid collection channel, and/or via a temperature-control fluid guide zone described herein, which can be, for example, the temperature-control fluid collection zone.

For example, the temperature-control fluid guide channel described herein, which can be, for example, the temperature-control fluid collection channel, and/or the temperature-control fluid guide zone described herein, which can be, for example, the temperature-control fluid collection zone, can extend along the second central region and/or completely or partially cover the second central region. The second central region can, for example, run between energy storage elements and the temperature-control fluid collection channel and/or the temperature-control fluid collection zone.

It can be advantageous when the first inflow zone and the second inflow zone are fluidically connected to the outlet via a temperature-control fluid guide channel described herein, which can be, for example, the temperature-control fluid collection channel, and/or via a temperature-control fluid guide zone described herein, which can be, for example, the temperature-control fluid collection zone.

It can be advantageous when a temperature-control fluid guide channel described herein, which can be, for example, the temperature-control fluid collection channel, and/or a temperature-control fluid guide zone described herein, which can be, for example, the temperature-control fluid collection zone, forms the first central region.

It goes without saying that features described in the context of one subject matter according to the invention can also form features of another subject matter according to the invention described herein. Subject matters according to the invention include in particular the energy storage unit, the monitoring unit, the contacting system, the method for producing an energy storage unit and the method for controlling the temperature of energy storage elements.

Further preferred features and/or advantages of the invention are the subject matter of the description hereunder and of the graphic illustration of exemplary embodiments.

### BRIEF DESCRIPTION OF THE DRAWINGS

FIG. 1: shows a first embodiment of an energy storage unit according to the invention in a perspective illustration;

FIG. 2: shows the perspective illustration from FIG. 1 without the first barrier element;

FIG. 3: shows a section through the energy storage unit shown in FIG. 1 along the line Ill-Ill;

FIG. 4: shows an enlarged detail from FIG. 3;

FIG. 5: shows a section through energy storage elements and a reinforcement element of the first embodiment of an energy storage unit according to the invention;

FIG. 6: shows an enlarged detail of the surface facing upwards in FIG. 2;

FIG. 7: shows a perspective illustration of a second embodiment of an energy storage unit according to the invention;

FIG. 8: shows the energy storage unit from FIG. 7 without the first barrier element;

FIG. 9: shows a section through FIG. 7 along the line IX-IX;

FIG. 10: shows an enlarged detail from FIG. 9;

FIG. 11: shows a top view of the energy storage elements of the second embodiment of the energy storage unit;

FIG. 12: shows a shaped element from the second embodiment of an energy storage unit according to the invention;

FIG. 13: shows a perspective illustration of energy storage elements and reinforcement elements of the second embodiment of an energy storage unit according to the invention;

FIG. 14: shows a perspective sectional illustration of a third embodiment of an energy storage unit according to the invention;

FIG. 15: shows a further sectional illustration of the third embodiment of the energy storage unit according to the invention;

FIG. 16: shows a highly simplified sectional illustration of an energy storage unit according to the invention;

FIG. 17: shows the fourth embodiment of the energy storage unit according to the invention in a perspective illustration;

FIG. 18: shows an exploded illustration of the fourth embodiment of the energy storage unit according to the invention;

FIG. 19: shows a top view of the fourth embodiment of the energy storage unit according to the invention;

FIG. 20: shows the top view from FIG. 19 without a first barrier element;

FIG. 21: shows a lateral view of the third embodiment of the energy storage unit according to the invention;

FIG. 22: shows a section through the energy storage unit illustrated in FIG. 19 along the line XXII-XXII;

FIG. 23: shows a section through a schematically illustrated energy storage unit;

FIG. 24: shows another potential embodiment of a current interference unit of the energy storage unit from FIG. 23;

FIG. 25: shows a further embodiment of a current interference unit of the energy storage unit from FIG. 23;

FIG. 26: shows a perspective illustration of an energy storage unit according to a fifth embodiment;

FIG. 27: shows the perspective illustration from FIG. 26 with an open base region;

FIG. 28: shows the open base region from FIG. 27;

FIG. 29: shows the open base region from FIG. 28 without a monitoring system;

FIG. 30: shows a section through the energy storage unit according to the fifth embodiment along line XXX-XXX in FIG. 26;

FIG. 31: shows an enlarged detail from FIG. 30;

FIG. 32: shows part of the energy storage unit according to the fifth embodiment;

FIG. 33: shows a contacting system;

FIG. 34: shows an enlarged detail of the contacting system from FIG. 33;

FIG. 35: shows the contacting system from FIG. 33 without a carrier element;

FIG. 36: shows a perspective sectional illustration of the contacting system along line XXXVI-XXXVI from FIG. 35;

FIG. 37: shows the illustration from FIG. 36 without connection devices;

FIG. 38: shows a further perspective illustration of the energy storage unit according to the fifth embodiment with an open base region;

FIG. 39: shows a perspective illustration of the energy storage unit according to a fifth embodiment with an open lid region;

FIG. 40: shows a temperature-control fluid guide element for an energy storage unit;

FIG. 41: shows another temperature-control fluid guide element for an energy storage unit;

FIG. 42: shows another temperature-control fluid guide element for an energy storage unit;

FIG. 43: shows a further view of the temperature-control fluid guide element from FIG. 42;

FIG. 44: shows a further temperature-control fluid guide element for an energy storage unit; and

FIG. 45: shows a further temperature-control fluid guide element for an energy storage unit.

Similar or functionally equivalent elements are provided with the same reference signs in all of the figures.

### DETAILED DESCRIPTION OF THE DRAWINGS

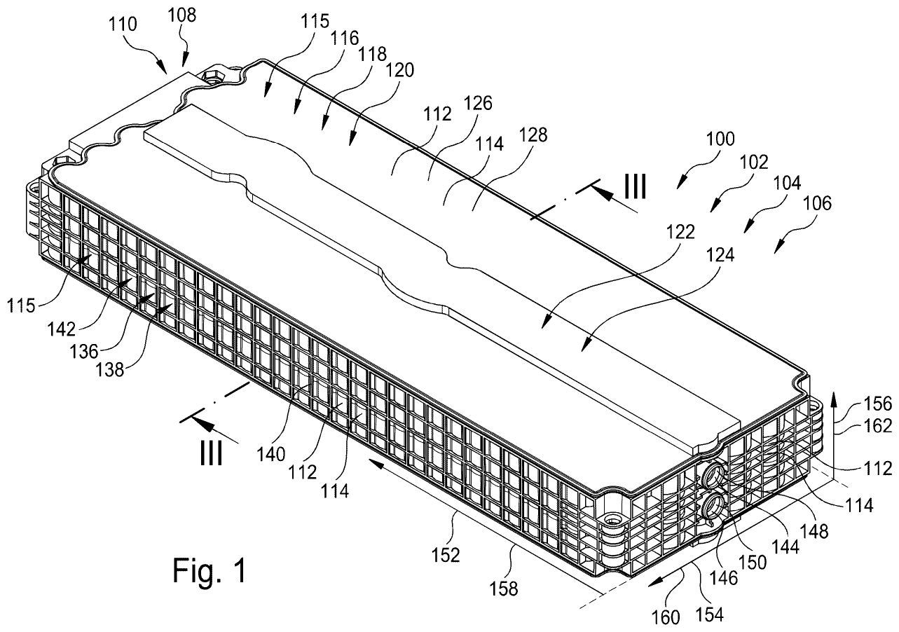

FIGS. 1 to 6 illustrate a first embodiment of an energy storage unit 100. The energy storage unit 100 is an energy storage module 102. With the energy storage unit 100, electrical energy for driving a motor vehicle not shown here is able to be provided.

With the energy storage unit shown in FIGS. 1 to 6, for example, part of the electrical energy for driving a motor vehicle can be able to be provided, wherein a plurality of the illustrated energy storage units 100 can be interconnected so as to form an energy storage device not illustrated. The further energy storage units 100, which can be interconnected so as to form the energy storage device can then provide the remaining electrical energy for driving a motor vehicle.

The energy storage unit 100 is an electrochemical energy storage unit 104. The energy storage module 102 is an electrochemical energy storage module 106.

The energy storage unit 100 comprises a temperature-control fluid barrier 108. The temperature-control fluid barrier is a housing 110.

The temperature-control fluid barrier 108 has a plurality of barrier zones 112. Barrier zones 112 are wall zones 114.

A plurality of barrier elements 115 conjointly form the temperature-control fluid barrier. A first barrier element 116 is a cover element 118. The cover element 118 is a lid element 120.

In the embodiment shown in FIGS. 1 to 6, the first barrier element 116 comprises an overlapping portion 122 which forms a channel barrier zone 124. The first barrier element 116 forms a first barrier zone 126. The first barrier zone 126 is a first wall zone 128.

A second barrier element 130 is likewise a cover element 118. This additional cover element 118 is a base element 132. The second barrier element 130 forms a second barrier zone 134.

A third barrier element 136 is a frame wall element 138. The third barrier element 136 forms a third barrier zone 140. The third barrier element is a frame 142.

The third barrier element 136 has an inlet 150 and an outlet 148.

Through the inlet 150, a temperature-control fluid is able to be directed into the energy storage unit 100.

A temperature-control fluid is able to flow out of the energy storage unit 100 through the outlet 148.

The energy storage unit 100 extends in a first direction 152, in a second direction 154 and in a third direction 156. These three directions are aligned so as to be mutually orthogonal.

The first direction 152 can be considered a direction of longitudinal extent 158 along which a length of the energy storage unit 100 is measurable. The second direction 154 can be considered a direction of width extent 160 of the energy storage unit 100, along which a width of the energy storage unit 100 is measurable. The third direction 156 can be considered a direction of height extent 162 along which a height of the energy storage unit 100 is measurable.

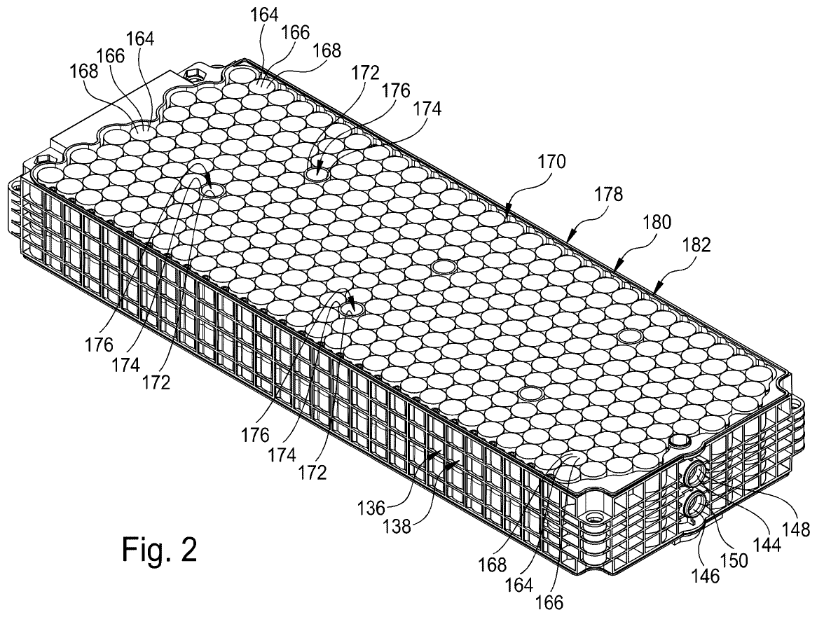

FIG. 2 shows the energy storage unit 100 without the first barrier element 116.

From FIG. 2 it can be seen that the energy storage unit 100 comprises a plurality of energy storage elements 164. The energy storage elements 164 are electrochemical energy storage elements 166. These are battery cells 168, such as rechargeable lithium-ion battery cells.

The temperature-control fluid barrier 108 extends about a temperature-control chamber 170. In the temperature-control chamber 170, the energy storage elements 164 are able to be temperature-controlled by means of the temperature-control fluid.

The energy storage unit comprises a plurality of reinforcement elements 172.

To improve clarity, in FIG. 2 only a minority of the energy storage elements 164 and only some of the reinforcement elements 172 are provided with reference numerals.

In the first embodiment shown in FIGS. 1 to 6, the reinforcement elements 172 are sleeves 174. From FIGS. 2, 3, 5 and 6 it becomes clear that the external diameters of the reinforcement elements 172 correspond to the diameters of the energy storage elements 164. The reinforcement elements 172 have recesses 176.

An upper wall end 178 of the third barrier element 136 faces the first barrier element 116 not illustrated in FIG. 2. A sealing element 180 or a weld seam 182 can be disposed between the upper wall end 178 and the first barrier element 116, for example. The weld seam 182 may preferably be a plastics-material weld seam, since the barrier elements, for example the first barrier element 116 and the third barrier element 136, preferably consist of a plastics material or can be made of a plastics material.

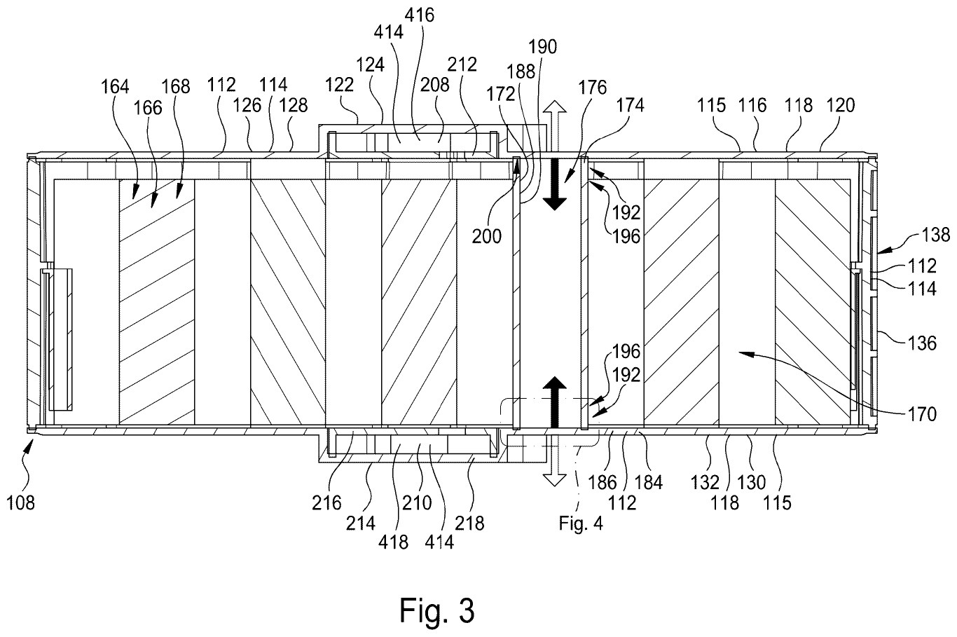

FIG. 3 shows a section through the energy storage unit 100 made along the line Ill-Ill orthogonally to the direction of longitudinal extent 158 (cf. FIG. 1). FIG. 3 illustrates for one of the reinforcement elements 172 how the reinforcement element 172 reinforces the barrier zone 112 in relation to outward bending of the barrier zone 112, e.g. in relation to convex bending of the barrier zone 112. In which directions outward bending of the barrier zone 112 or convex bending of the barrier zone 112 would take place in the absence of the reinforcement element 172 is indicated in FIG. 3 with an upward and a downward pointing arrow, the latter being plotted on the respective barrier zone 112 in the region of the reinforcement element 172.

The reinforcement element 172 extends from the respective barrier zone 112, i.e. from the already described first barrier zone 126, and from the second barrier zone 184 into the temperature-control chamber 170.

As already described in the context of FIG. 1, the first barrier zone 126 is a first wall zone 128. The second barrier zone 184 is a second wall zone 186.

The reinforcement element 172 extends from the first barrier zone 126 to the second barrier zone 184. The first barrier zone 126 and the second barrier zone 184 are mutually opposite barrier zones 112 of the temperature-control fluid barrier 108 formed from the first barrier element 116, the second barrier element 130 and the third barrier element 136.

The reinforcement element 172 comprises a counter-reinforcement element 188. The counter-reinforcement element 188 is a support reinforcement element 190. In the example shown here, the reinforcement element 172 is the counter-reinforcement element 188.

The counter-reinforcement element 188 reinforces the first barrier zone 126 and the second barrier zone 184 respectively in relation to inward bending, e.g. in relation to concave bending of the first barrier zone 126 and the second barrier zone 184. The inward bending of the first barrier zone 126 and the second barrier zone 184 and the concave bending of the first barrier zone 126 and the second barrier zone 184 is indicated with the black solid arrows pointing inwards into the temperature-control chamber 170 in FIG. 3.

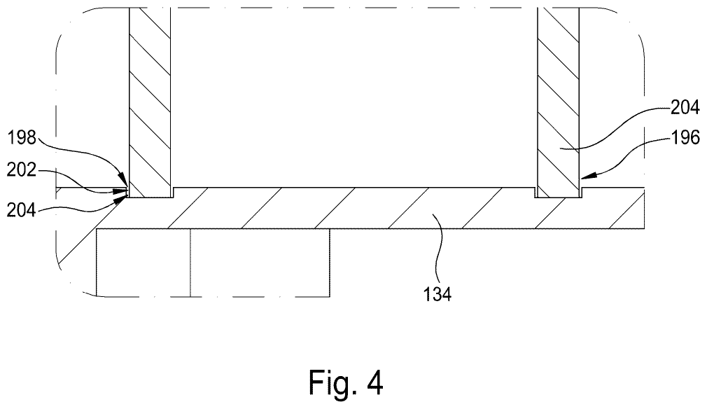

In FIG. 4, a detail from FIG. 3 is showed in an enlargement. The reinforcement element 172 has two ends 192. One of the ends 192 is a first end 194. The other of the two ends 192 is a second end 196. The barrier zones 112, 126 and 184 have depressions 198. The first barrier zone 126 has a first depression 200. The second barrier zone 184 has a second depression 202.

Ends 192 of the reinforcing element 172 are received in the depressions 198. The first end 194 is received in the first depression 200. The second end 196 is received in the second depression 202. FIG. 4 illustrates the second end 196 being received in the second depression 202. The reinforcement element 172 has a hollow cylindrical reinforcement wall 204. The second depression 202 is a second hollow cylindrical depression 206. The second end 196 of the reinforcement element 172 can be attached in the second depression 202 in a materially integral manner, for example. The materially integral attachment can be carried out, for example, by plastics material welding or with the aid of an adhesive. This is not illustrated in FIG. 4.

FIG. 3 also shows that the energy storage unit 100 comprises a temperature-control fluid distribution channel 210 and a temperature-control fluid collection channel 208. The temperature-control fluid distribution channel 210 extends in the direction of longitudinal extent 158 between the overlapping portion 122 and a first temperature-control fluid guide element 212.

The temperature-control fluid collection channel 208 extends counter to the direction of longitudinal extent 158 between a further overlapping portion 214 of the second barrier element 130 and a second temperature-control fluid guide element 216.

The further overlapping portion 214 is a further channel barrier zone 218.

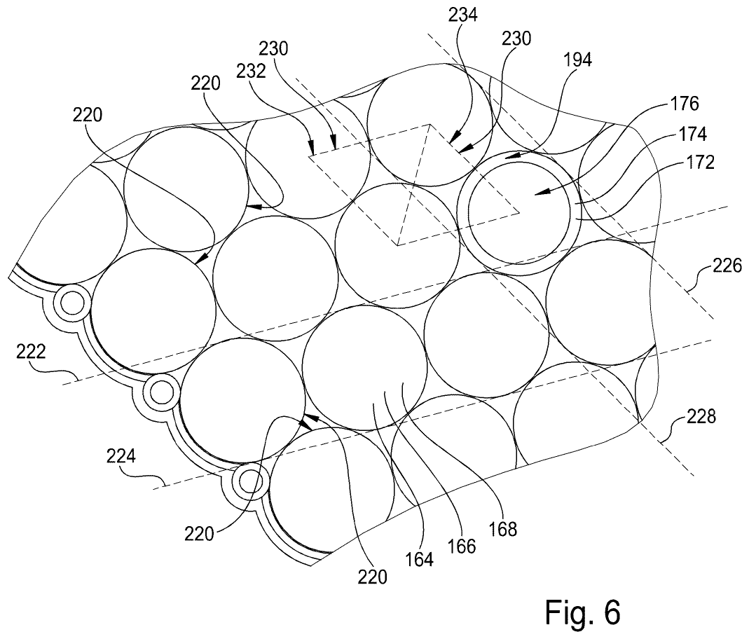

It becomes clear in particular from FIGS. 2, 5 and 6 that the energy storage elements 164 are disposed at regular intervals in the energy storage unit 100. In pairs of closest adjacent energy storage elements 164, the surfaces 220 of the energy storage elements are in mutual contact. This is shown in particular in FIG. 6.

The position of in each case a plurality of energy storage elements defines two parallel planes, disposed between which are in each case a plurality of the energy storage elements 164. From FIG. 6 it becomes clear that a plurality of energy storage elements 164 are in each case disposed between the first plane 222 and the second plane 224 running parallel thereto, and that a plurality of energy storage elements 164 are in each case likewise disposed between the third plane 226 and the fourth plane 228 running parallel thereto. The four planes are indicated in FIG. 6 as straight lines, since the viewing direction of the observer runs along the surfaces of the planes.

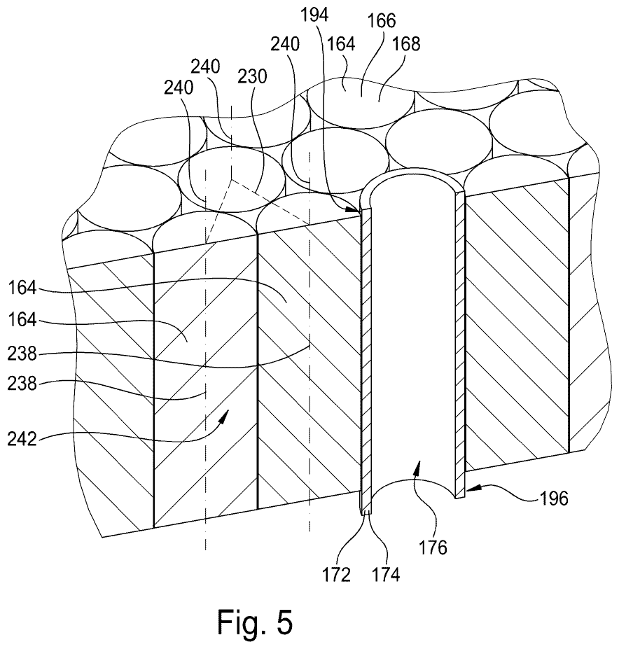

The position of closest adjacent energy storage elements 164 can be approximated by a prism 230. In FIG. 6, a first prism 232 and a second prism 234 are indicated. The edges extending along the shell faces of the two prisms 232, 234 coincide in each case with straight lines running centrally through the energy storage elements 164. FIG. 5 clearly shows how the edges 238 extending along the shell face 242 of a prism 230 coincide with straight lines 240 running centrally through the energy storage elements 164.

In the first embodiment of the energy storage unit 100 shown in FIG. 1 to 6, the reinforcement elements 172 in the regular arrangement of the energy storage elements 164 each occupy a position of one of the energy storage elements 164.

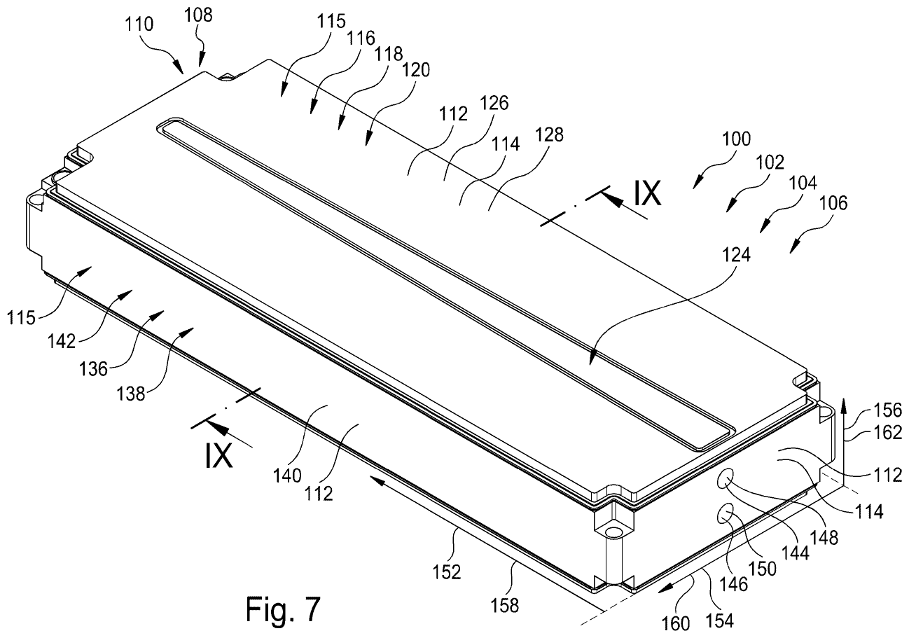

The second embodiment of an energy storage unit 100 visualized in FIGS. 7 to 13 differs in particular, but not only in this respect.

This difference is not obvious from FIG. 7, since there the view of the observer onto the energy storage elements is blocked by the first barrier element 116. However, FIG. 7 clearly shows that the channel barrier zone 124 in the second embodiment shown there is not formed on an overlapping portion.

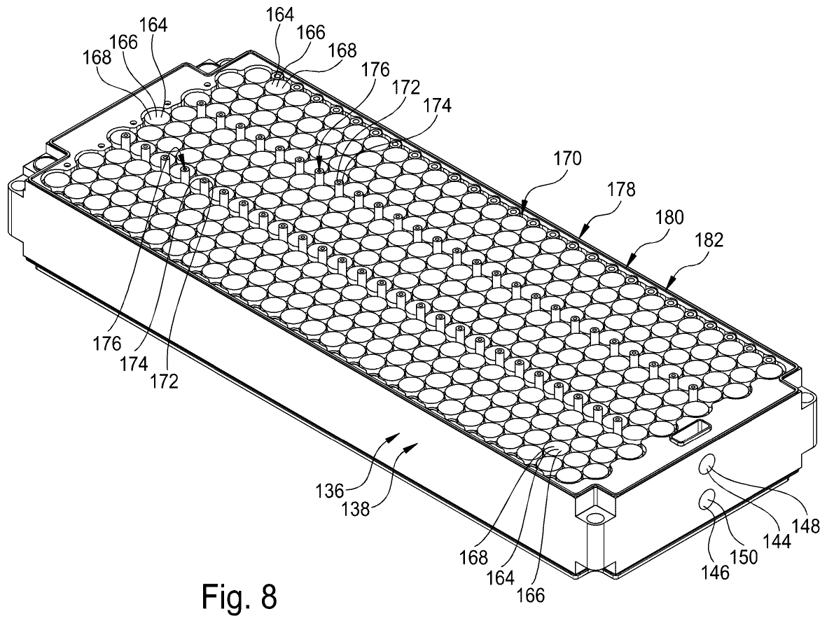

FIG. 8 shows the energy storage unit 100 from FIG. 7 without the first barrier element 116. It can be clearly seen that in the second embodiment shown there, the reinforcement elements 172 in the regular arrangement of the energy storage elements do not each occupy positions of one of the energy storage elements 164.

Instead, the reinforcement elements 172 extend in the regular arrangement of the energy storage elements 164 in each case between three energy storage elements 164.

A further difference between the second embodiment and the first embodiment is that the number of reinforcement elements is substantially larger and the diameters of the reinforcement elements 172 are substantially smaller than in the first embodiment.

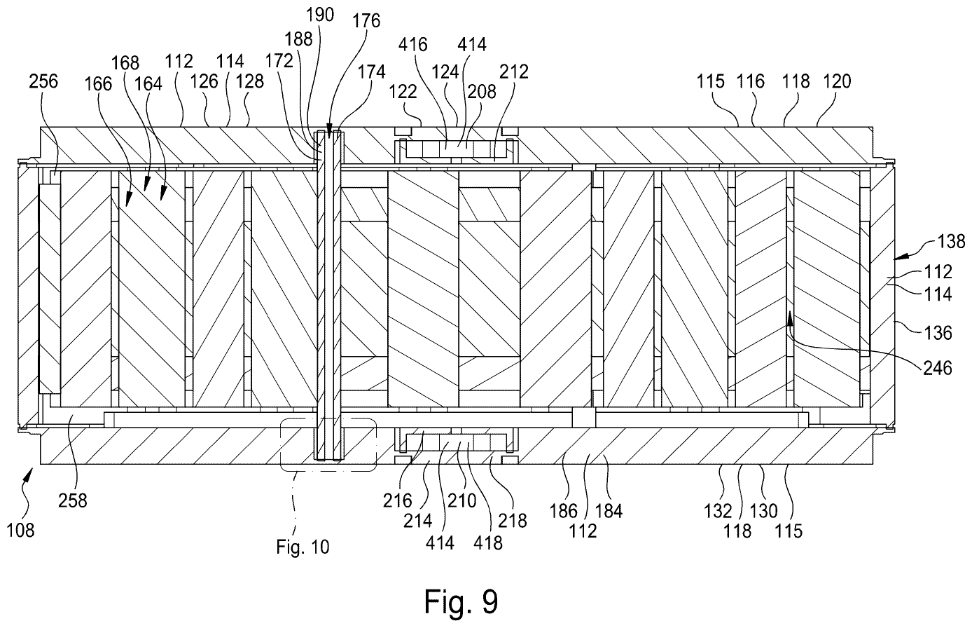

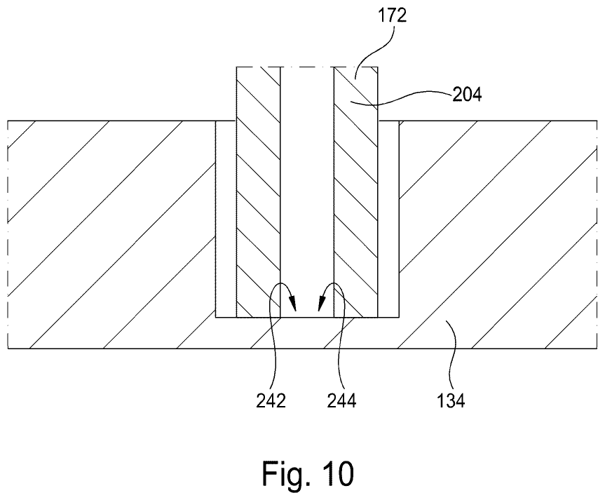

Unlike in the first embodiment, the ends of the reinforcement elements 172 are not received in hollow cylindrical depressions of the barrier zones 112, 126, 184, but in cylindrical depressions 243. This is illustrated by FIG. 10 which shows a detail from FIG. 9 including a second cylindrical depression 244.

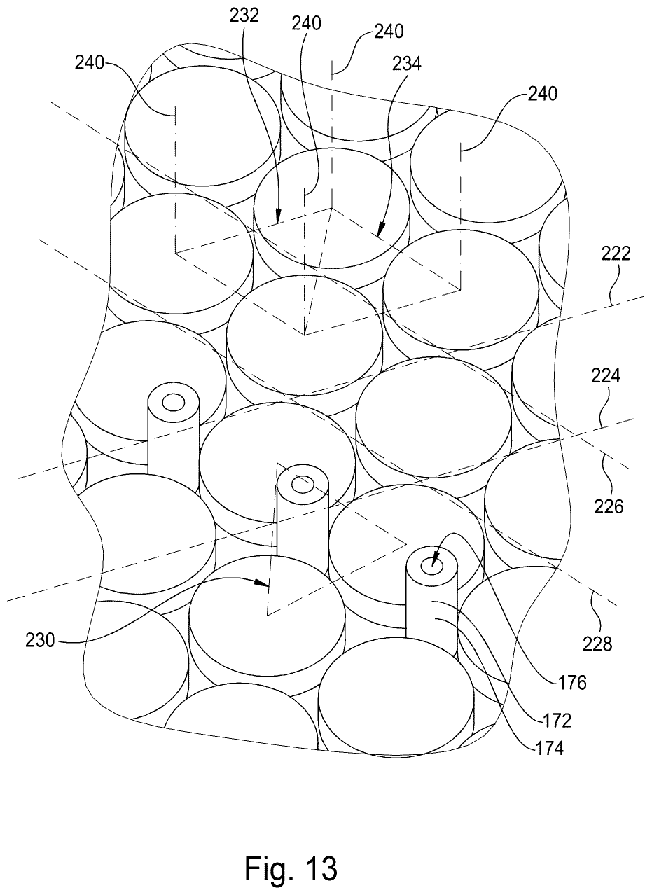

While in the first embodiment of the energy storage unit 100 shown in FIGS. 1 to 6, the surfaces of pairs of nearest adjacent energy storage elements each touch one another, in the second embodiment of the energy storage unit 100 shown in FIGS. 7 to 13 there is in each case a spacing between surfaces of closest adjacent energy storage elements 164. This can be seen particularly well in FIG. 13.

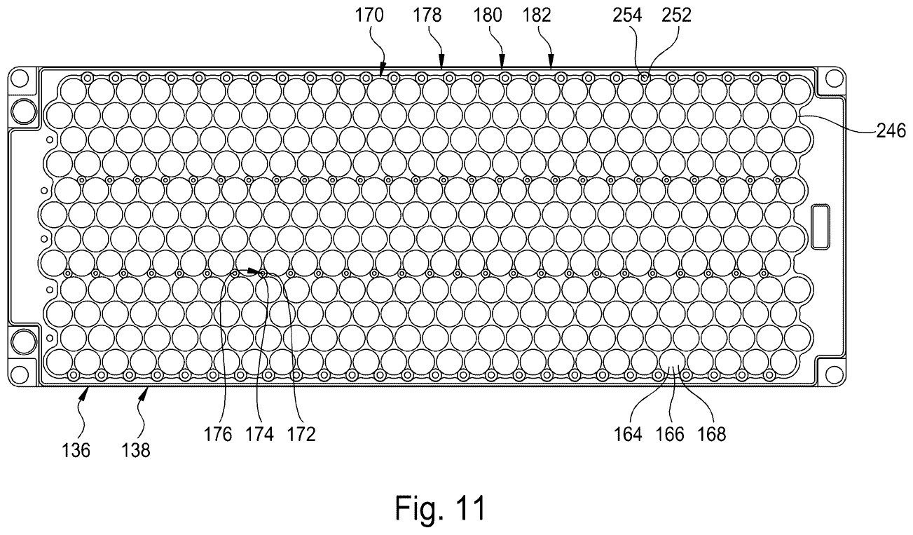

Spacings between the two energy storage elements 164 of a plurality of pairs of closest adjacent energy storage elements 164 in the second embodiment of the energy storage unit 100 illustrated in FIGS. 7 to 13 are of identical size. This can also be seen from FIG. 11.

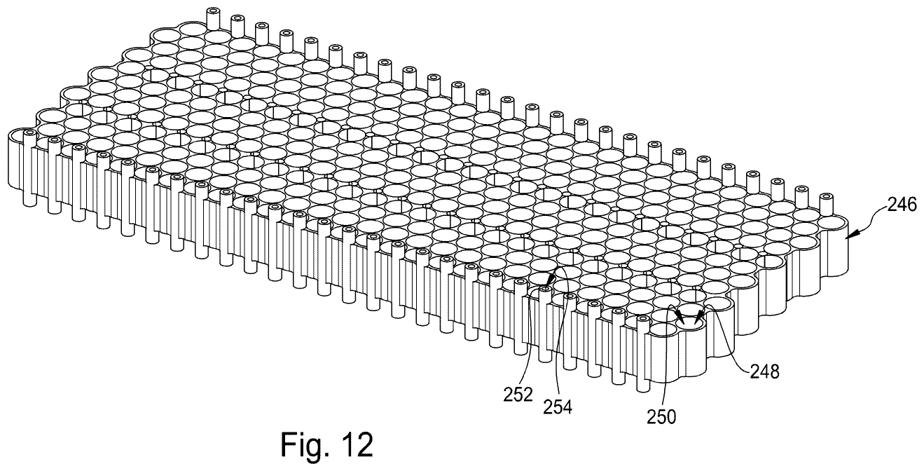

FIG. 12 shows a shaped element 246. The shaped element has a plurality of positioning zones 248. The positioning zones 248 are storage element receptacle zones 250. In the second embodiment of the energy storage unit 100, the energy storage elements 164 are disposed in the positioning zones 248. They are received in storage element receptacle zones 250. The spacings of closest adjacent positioning zones 248 of the shaped element 246 determine the spacings of closest adjacent energy storage elements 164.

The shaped element 246 comprises a plurality of temperature-control fluid guide elements 252. The temperature-control fluid guide elements 252 each have a temperature-control fluid passage 254.

The shaped element 246 defines in the second embodiment of the energy storage unit 100 a first temperature-control zone 258, which is on one side of the shaped element, and a second temperature-control zone 256, which is on the opposite side of the shaped element 246. This can be seen in particular from FIG. 9. A temperature-control fluid can be transferred from the first temperature-control zone 258 to the second temperature-control zone 256 through the temperature-control fluid passages 254.

FIG. 13 shows that a reinforcement element 172 extends through a prism 230 by way of which the position of closest adjacent energy storage elements can be approximated. The reinforcement element 172 extends through the prism 230, in particular also through the cover surface and the base area of the prism.

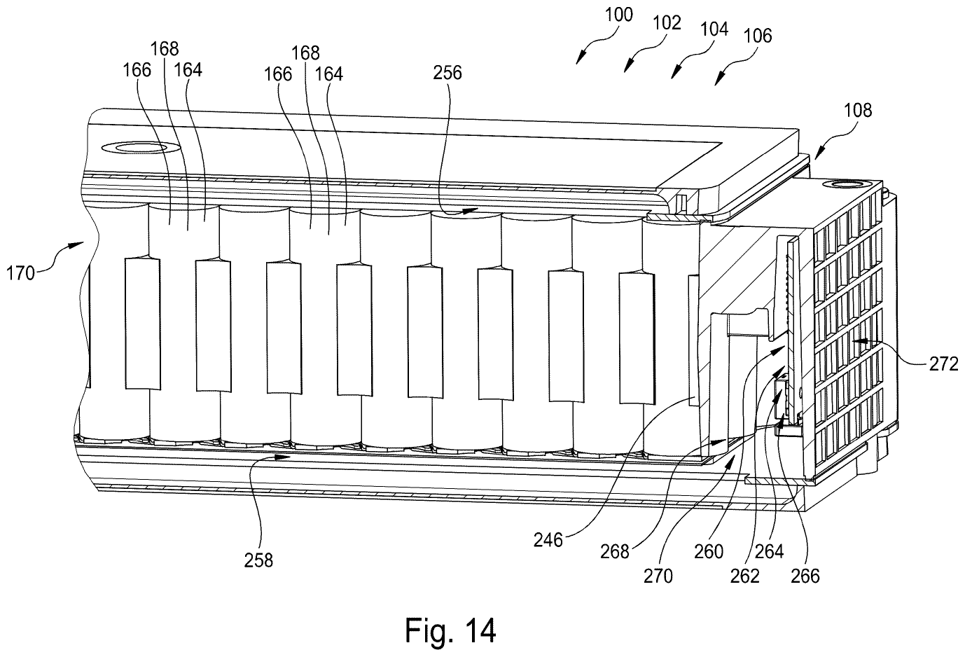

FIGS. 14 to 16 illustrate a third embodiment of an energy storage unit 100. The energy storage unit 100 comprises a temperature-control fluid barrier 108. The temperature-control fluid barrier 108 extends about a temperature-control chamber 170. The energy storage unit comprises a plurality of energy storage elements 164. The energy storage elements 164 are able be temperature-controlled in the temperature-control chamber 170 by means of a temperature-control fluid.

The third embodiment of an energy storage unit 100 shown in FIGS. 14 to 16 comprises a monitoring unit 260. The monitoring unit 260 is a monitoring circuit 262. The monitoring circuit 262 is a cell monitoring circuit 264. The cell monitoring circuit can in particular be a so-called Cell Supervisory Circuit (CSC) 266.

By means of the monitoring unit 260, differences in the charge states of the energy storage elements 164 are able to be completely or partially avoided or able to be compensated for.

In the embodiment shown in FIGS. 14 to 16, the monitoring unit 260 is disposed in a monitoring zone 268. The monitoring zone 268 is located in the monitoring space 270.

The temperature-control fluid barrier 108 simultaneously also forms a monitoring space barrier 272. The temperature-control fluid barrier 108 thus extends also about the monitoring zone 268 and about the monitoring unit 260 located therein.

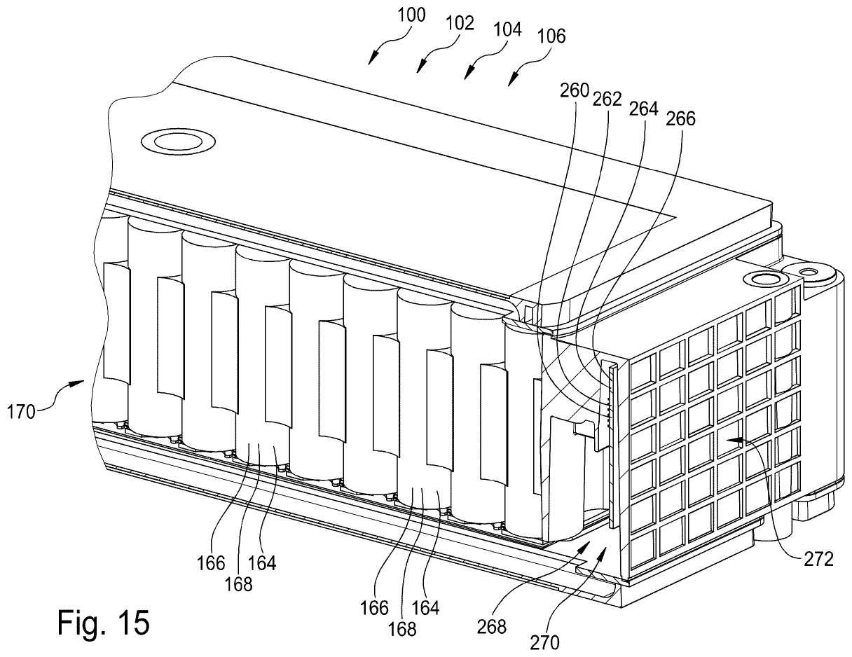

A shielding material 274, which can prevent or reduce an inflow of the temperature-control fluid to the monitoring unit, is not illustrated in FIGS. 14 and 15.

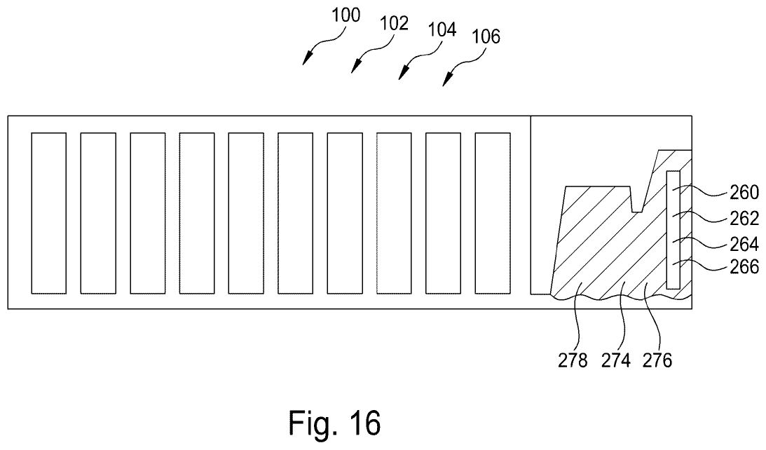

Such a shielding material 274 is shown in FIG. 16, the energy storage unit 100 being illustrated in a highly simplified manner in the latter. The monitoring unit 260 is embedded in the shielding material 274. The shielding material comprises a plastics material 276. The plastics material 276 is porous. This is a shielding material in the form of foam. For example, it can be a plastic foam material 278.

The plastic foam material 278 is fluid-tight. This can ensure that an inflow of the temperature-control fluid to the monitoring unit 260 is prevented or reduced.

For example, the mean density of the plastic foam material can be 0.08 g/cm³.

The third embodiment of an energy storage unit 100 shown in FIGS. 14 to 16 can be produced, for example, in that the monitoring unit 260 is disposed in the monitoring space 270 and the monitoring space 270 is filled with expanded foam.

In the process, the monitoring unit 260 can be incorporated into the monitoring space 270 and the filling with expanded foam can take place in a later method step. Alternatively, the monitoring space 270 can be completely or partially filled with expanded foam. This can be done, for example, with a foaming agent. The disposal of the monitoring unit 260 in the monitoring space 270, for example in the foaming agent located in the latter, can take place in a later method step.

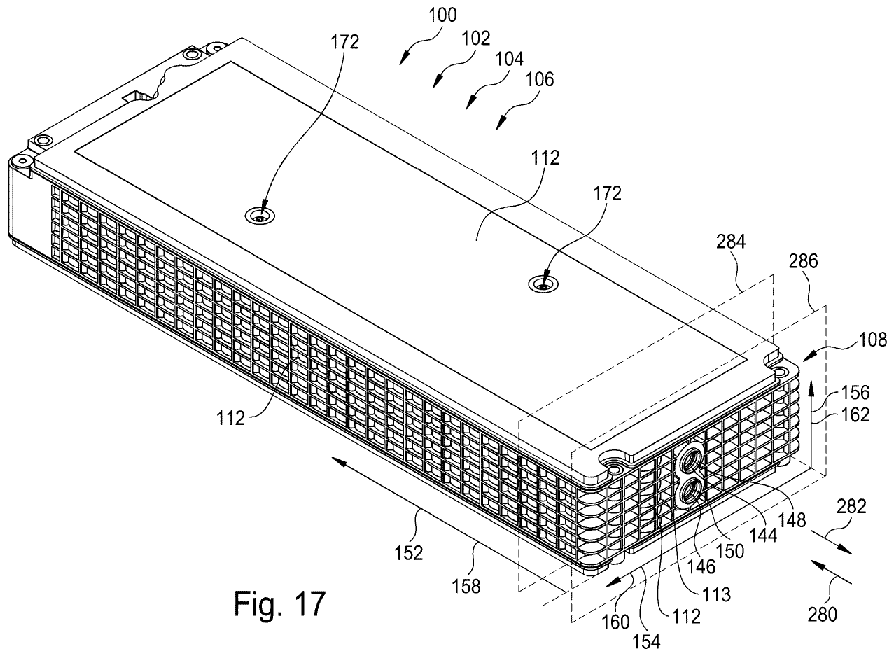

FIGS. 17 to 22 show further details of the energy storage unit 100 from FIGS. 14 to 16.

FIG. 17 shows that the energy storage unit 100 has an inlet 150 and an outlet 148. The two associated openings 144 and 146 extend through the temperature-control fluid barrier 108. The temperature-control fluid is able to be supplied to the temperature-control chamber through the inlet 150. The temperature-control fluid is able to be discharged from the temperature-control chamber through the outlet.

FIG. 17 shows that a first extent of the energy storage unit 100 in a first direction 152 is larger than a second extent of the energy storage unit 100 in a second direction 154.

FIG. 17 also shows that the first extent of the energy storage unit 100 in the first direction 152 is larger than a third extent of the energy storage unit 100 in a third direction 156.

Each of the three directions 152, 154 and 156 is aligned orthogonally to the other two directions. This means that the first direction 152 is aligned orthogonally to the second direction 154 and orthogonally to the third direction 156, the second direction 154 is aligned orthogonally to the first direction 152 and orthogonally to the third direction 156, and that the third direction 156 is aligned orthogonally to the first direction 152 and to the second direction 154.

The first direction 152 is a direction of longitudinal extent 158. An extent of the energy storage unit 100 in the first direction 152 can thus be understood to be a length of the energy storage unit 100.

The second direction 154 is a direction of width extent 160. A second extent of the energy storage unit 100 in the second direction 154 can thus be understood to be a width of the energy storage unit 100.

The third direction 156 is a direction of height extent 162. An extent of the energy storage unit 100 in the third direction 156 can thus be understood to be a height of the energy storage unit 100.

The temperature-control fluid barrier 108 has a plurality of barrier zones 112. These have been described in the context of other embodiments of the energy storage unit 100, which is why repetitions in this respect are dispensed with. One of the barrier zones 112 is a frontal barrier zone 113. The temperature-control fluid barrier 108 thus has a frontal barrier zone 113. The inlet 150 and outlet 148 extend through the frontal barrier zone 113. They extend through the frontal barrier zone 113 in such a way that an inflow direction 280 of the temperature-control fluid which can be supplied through the inlet 150 to the temperature-control chamber is aligned counter to an outlet flow direction 282 of the temperature-control fluid which can be discharged through the outlet 148 from the temperature-control chamber.

The frontal barrier zone 113 is aligned in such a way that the frontal barrier zone 113 can be defined by two frontal planes 284 and 286 which are aligned so as to be mutually parallel and mutually spaced apart. The two frontal planes 284 and 286 are aligned orthogonally to the first direction 152. The frontal barrier zone 113 extends between these two frontal planes 284 and 286.

The two frontal planes 284 and 286 are plotted in FIG. 17.

The inlet 150 and the outlet 148 are mutually offset in the third direction 156. The two associated openings 144 and 146 are mutually offset in the third direction 156 in the frontal barrier zone 113.

FIG. 17 shows that also the third embodiment of the energy storage unit 100 shown there has reinforcement elements 172.

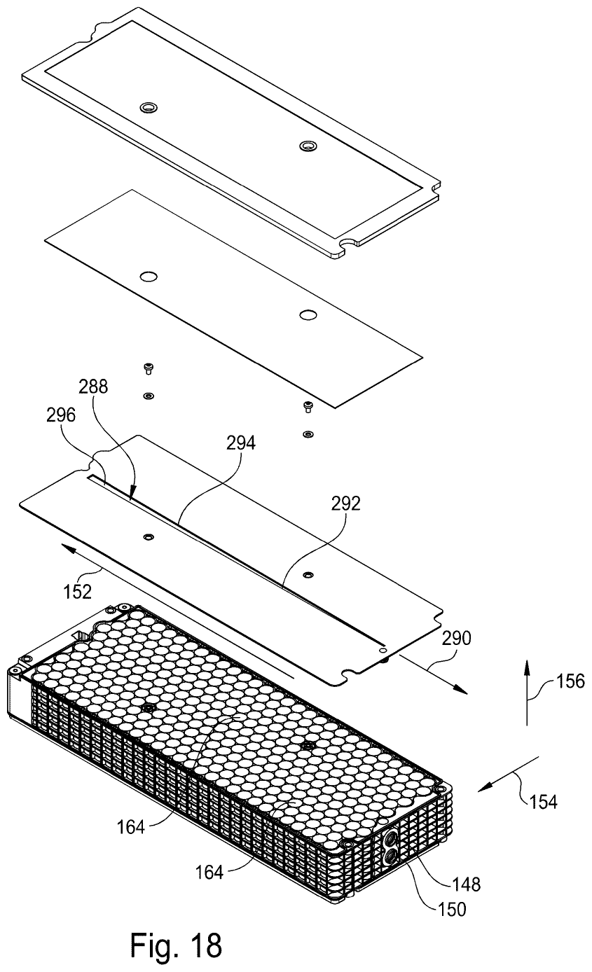

The exploded illustration shown in FIG. 18 shows that the energy storage unit comprises a temperature-control fluid collection channel 288, and the outlet 148 is fluidically connected to the temperature-control fluid collection channel 288.

In the energy storage unit 100, the temperature-control fluid collection channel 288 is aligned in such a way that a first portion 292 of the temperature-control fluid collection channel 288 that lies closer to the outlet 148 in the temperature-control fluid flow direction 290 is offset from the outlet 148 to a lesser extent in the first direction 152 than a second portion 294 of the temperature-control fluid collection channel 288 that lies farther away from the outlet 148 in the temperature-control fluid flow direction 290. At the same time, the temperature-control fluid collection channel 288 is aligned in such a way that the first portion 292 of the temperature-control fluid collection channel 288 that lies closer to the outlet 148 in the temperature-control fluid flow direction 290 is offset from the outlet 148 to the same extent in the third direction 156 as the second portion 294 of the temperature-control fluid collection channel 288 that lies farther away from the outlet 148 in the temperature-control fluid flow direction 290.

The temperature-control fluid collection channel 288 has a fluid collection passage 296 through which the temperature-control fluid from a temperature-control zone can be transferred to the temperature-control fluid collection channel 288.

The fluid collection passage 296 widens as the distance from the second outlet 148 increases. Therefore, a cross section of the fluid collection passage 296 in the first portion 292 of the temperature-control fluid collection channel 288 is smaller than in the second portion 294 of the temperature-control fluid collection channel 288. Also, a width of the fluid collection passage 296 that is able to be measured transversely to the temperature-control fluid flow direction 290 is smaller in the first portion 292 of the temperature-control fluid collection channel 288 than in the second portion 294 of the temperature-control fluid collection channel 288. The width of the fluid collection passage 296 can be determined in each case in the second direction 154.

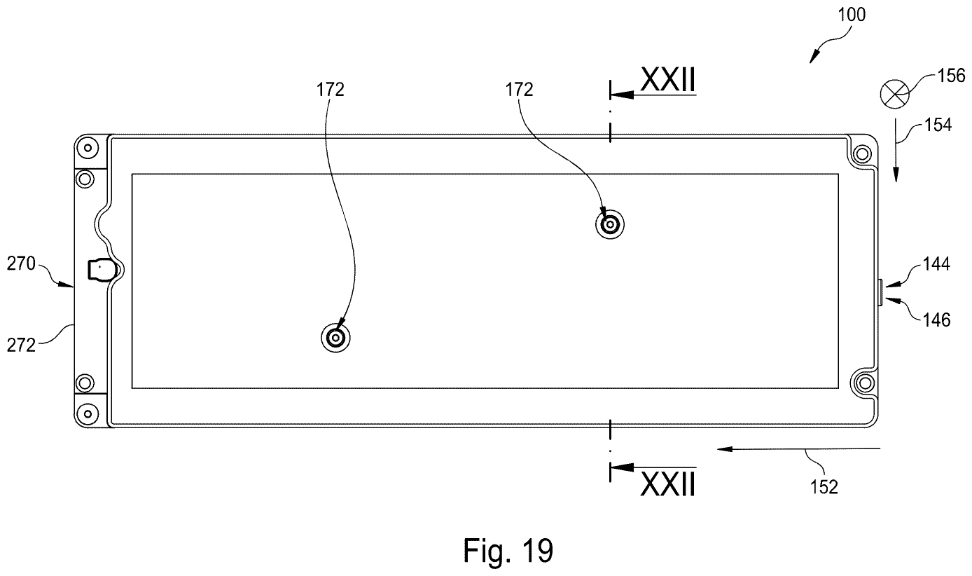

In FIG. 19, the energy storage unit 100 is illustrated from above. The viewing direction of the observer runs counter to the third direction 156. FIG. 19 also shows that the monitoring space 270 and the monitoring space barrier 272 surrounding the monitoring space are formed opposite the outlet 148 and the inlet 150.

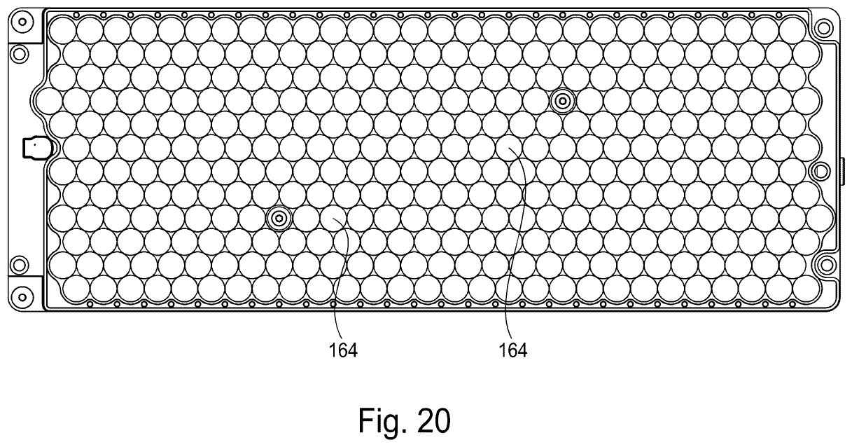

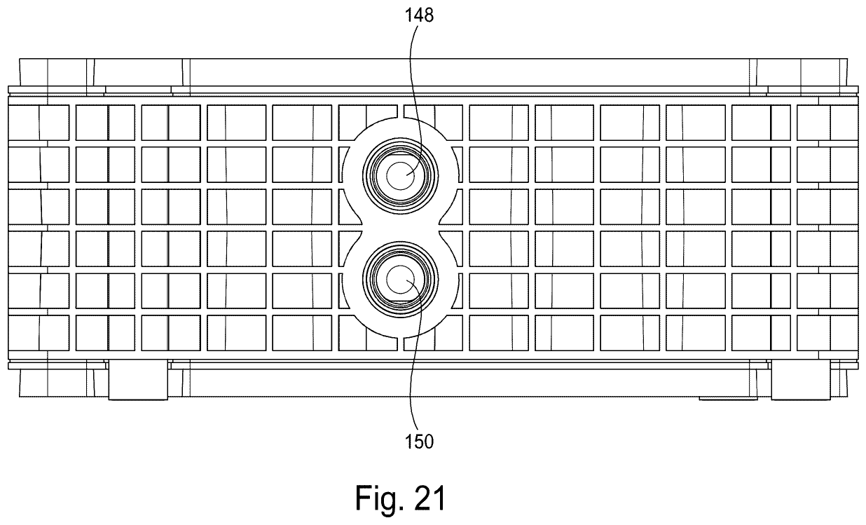

FIG. 20 corresponds to FIG. 19, wherein all elements and components that obscure the energy storage elements 164 in FIG. 19 have been omitted FIG. 21 shows the frontal barrier zone 113 in an enlarged illustration. The viewing direction of the observer runs counter to the outlet flow direction 282 and along the inflow direction 280.

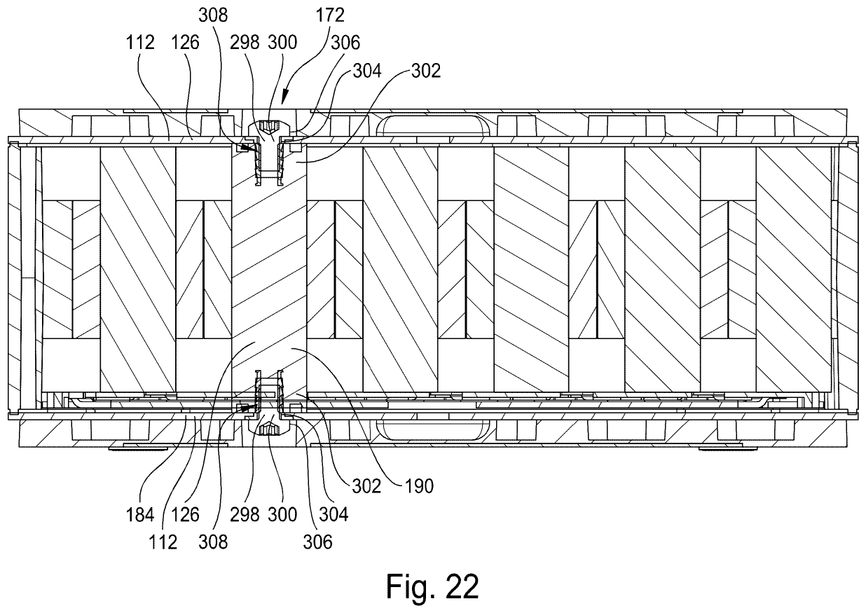

FIG. 22 shows a section along the line XXII-XXII drawn in FIG. 19.

The section shown in FIG. 22 illustrates the structure of the reinforcement elements 172 installed in the energy storage unit 100 according to the third embodiment. The reinforcement element 172 illustrated in a sectional view therein comprises a counter-reinforcement element 188. The counter-reinforcement element 188 is a support reinforcement element 190. The functional mode of the counter-reinforcement element 188 has been explained in the context of FIG. 3. Therefore, repetitions are dispensed with.

The reinforcement element 172 comprises two fixing elements 298. The two fixing elements 298 are screws 300. With the fixing elements, the counter-reinforcement element 188 is able to be fixed to the two barrier zones 112. One of the two barrier zones 112 is a first barrier zone 126. The other of the two barrier zones 112 is a second barrier zone 184. The reinforcement element 172 extends from the first barrier zone 126 to the second barrier zone 184. The reinforcement element 172 shown in FIG. 22 has a shoulder zone 302, a neck zone 304 and a head zone 306. It has at each end of the two ends of the reinforcing member 172 a shoulder zone 302, a neck zone 304 and a head zone 306. Between the respective head zone and the respective shoulder zone, a fixing zone 308 is located on the neck zone. The first barrier zone 126 extends into one of the two fixing zones 308. The second barrier zone 184 extends into the other of the two fixing zones 308.

The two fixing elements 298 each form the head zones 306. The two ends of the counter-reinforcement element 188 form the two shoulder zones 302.

The counter-reinforcement element 188 and the two fixing elements 298 have interlocking threads.

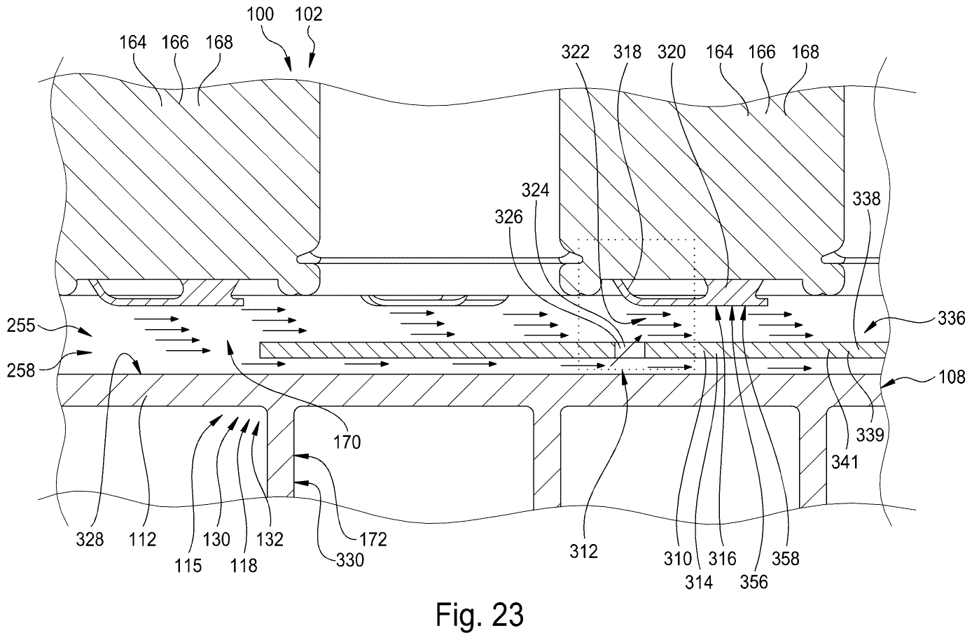

FIG. 23 shows a detail of a section through an energy storage unit 100 according to the invention. The energy storage unit 100 shown in FIG. 23 can be an energy storage unit 100 according to the first, the second, the third or the fourth embodiment described herein with reference to FIGS. 1 to 22.

In particular, the temperature-control zone 255, for example the first temperature-control zone 258, can also in the first, the second, the third or the fourth embodiment be embodied as will be described hereunder with reference to FIGS. 23 to 37.

FIG. 23 shows an energy storage unit 100 which is an energy storage module 102. The energy storage unit 100 comprises a plurality of energy storage elements 164 and a temperature-control fluid barrier 108.

The energy storage elements 164 are electrochemical energy storage elements 166. These are battery cells 168. In particular, these can be rechargeable lithium-ion battery cells.

The temperature-control fluid barrier extends about a temperature-control chamber 170. The energy storage elements 164 shown can be temperature-controlled in the temperature-control chamber 170 by means of a temperature-control fluid.

The temperature-control fluid barrier 108 shown in FIG. 23 has a barrier zone 112. The barrier zone is a wall zone 114. The barrier zone 112 is reinforced by means of a reinforcement element 172. The reinforcement element 172 shown in FIG. 23 is an external reinforcement element 330. The latter can in particular be reinforcement ribs which run on an external surface of the barrier element 115 shown.

The reinforcement element 172 reinforces the barrier zone 112 in relation to outward bending of the barrier zone 112. In particular, the reinforcement element 172 can reinforce the barrier zone 112 against a convex bulging of the barrier zone 112. The external reinforcement elements 330 shown in FIG. 23 do not extend from the barrier zone 112 into the temperature-control chamber 170.

The barrier zone 112 comprises a barrier element 115. The barrier element 115 is a second barrier element 130. The second barrier element 130 is a cover element 118. The cover element 118 is a base element.

The temperature-control chamber 170 has a temperature-control zone 255. The temperature-control zone is a first temperature-control zone 258.

The energy storage unit 100 comprises a flow interference unit 312. The flow interference unit 312 is disposed in the temperature-control zone 255, i.e. in the first temperature-control zone 258.

The energy storage unit 100 comprises for each energy storage element 164 in each case a plurality of current conductor elements 318, 320 which extend from the interior of the respective energy storage element 164 into the temperature-control zone 255 and which are able to be temperature-controlled in the temperature-control zone 255 by means of the temperature-control fluid. The current conductor elements 318, 320, which each extend from the interior of one of the energy storage elements 164, conjointly form a storage element contact zone 316. The storage element contact zone 316 acts as pole 356, wherein the energy storage elements 164 shown at the poles 356 are in each case positive poles 358.

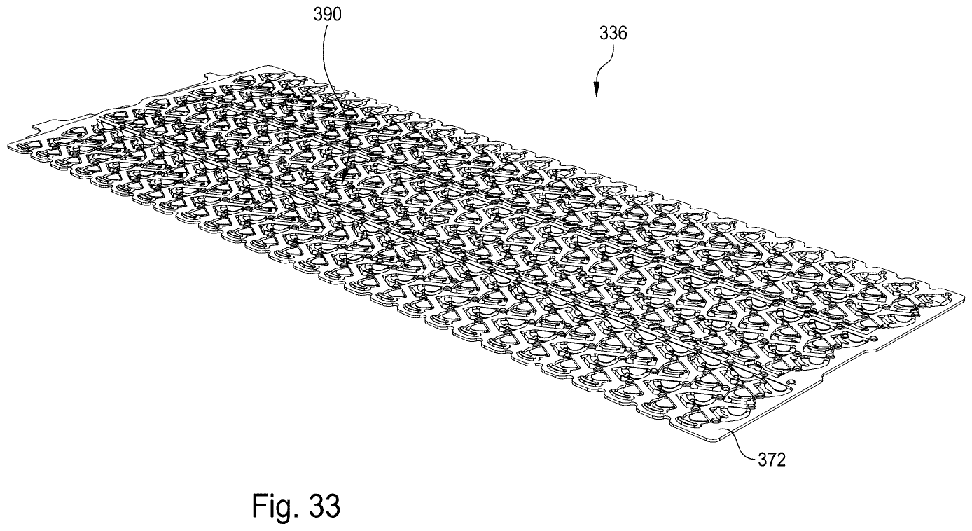

The energy storage unit 100 comprises a contacting element 338. This here can be a contacting element 338 of a contacting system 336 which is described in more detail herein, in particular with reference to FIGS. 33 to 37.

Owing to the contacting element 338, there exists a portion 341 of an electrically conducting connection 339 of at least one of the energy storage elements 164 of the energy storage unit 100 to a contacting zone of the energy storage unit 100. This is not apparent from FIG. 23.

Via said contacting zone 350 and the contacting element 338, the electrical energy or part of the electrical energy can be retrieved from the energy storage unit or supplied to the energy storage unit.

The contacting element 338 extends into the temperature-control zone 255.

FIG. 23 shows that the contacting element 338 comprises the flow interference unit 312.

Moreover, at least a portion of the temperature-control zone 255, i.e. of the first temperature-control zone 258, extends on the contacting element 338 up to the current conductor elements 318, 320 of the right-hand one of the two illustrated energy storage elements 164 and about these current conductor elements.

The contacting element 338 acts simultaneously as a fluid guide unit 310 and as a temperature-control zone subdivision unit 314.

The flow interference unit 312 acts as a turbulator 326. The flow interference unit 312 has a passage zone 324 which extends through the contacting element 338.

While the temperature-control fluid in the temperature-control zone 255 tends to a laminar flow at certain flow velocities, there can be increased turbulence at the flow interference unit 312 at the same flow velocity, which due to the more intense mixing of the temperature-control fluid can ensure increased cooling of the energy storage element 164, the latter being illustrated on the right in FIG. 23.

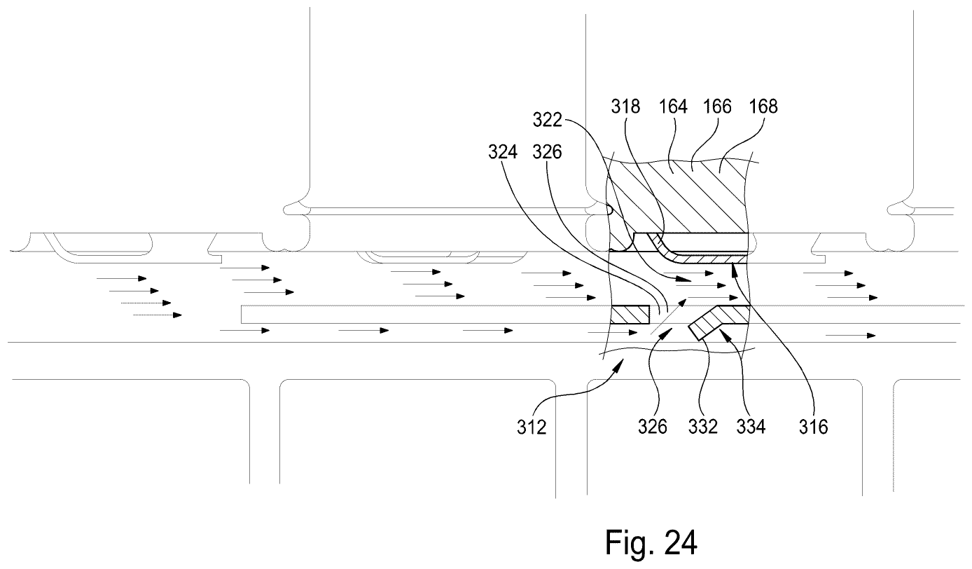

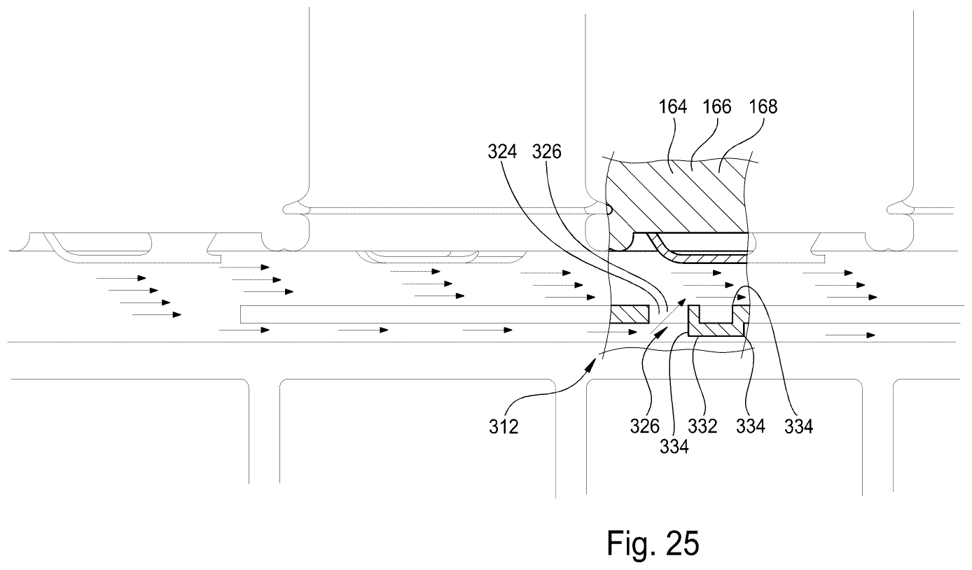

FIGS. 24 and 25 show by way of example possibilities for designing the flow interference unit 312. In each case only a small detail from FIG. 23 is shown, from which the deviations from FIG. 23 can be seen.

FIG. 24 shows that at the flow interference unit 312, the contacting element 338 has a bend 334, so that a curved portion 332 of the contacting element can act as a fluid deflection element 332. The fluid deflection element 332 can, in particular, have the effect that a temperature-control fluid which is able to flow on one side of the contacting element 338 impacts the fluid deflection element 332 and escapes through the passage zone 324, whereby increased turbulence can occur in a contact temperature-control zone 322 and thus more intense cooling of the energy storage element 164 can be achieved.

This can also be achieved by the design option of the flow interference unit 312 shown in FIG. 25. Instead of the bend 334 shown in FIG. 24, three bends 334 are present in the design option shown in FIG. 25. Owing to these bends 334, the contacting element 338 is bent so as to be substantially U-shaped in the sectional view shown.

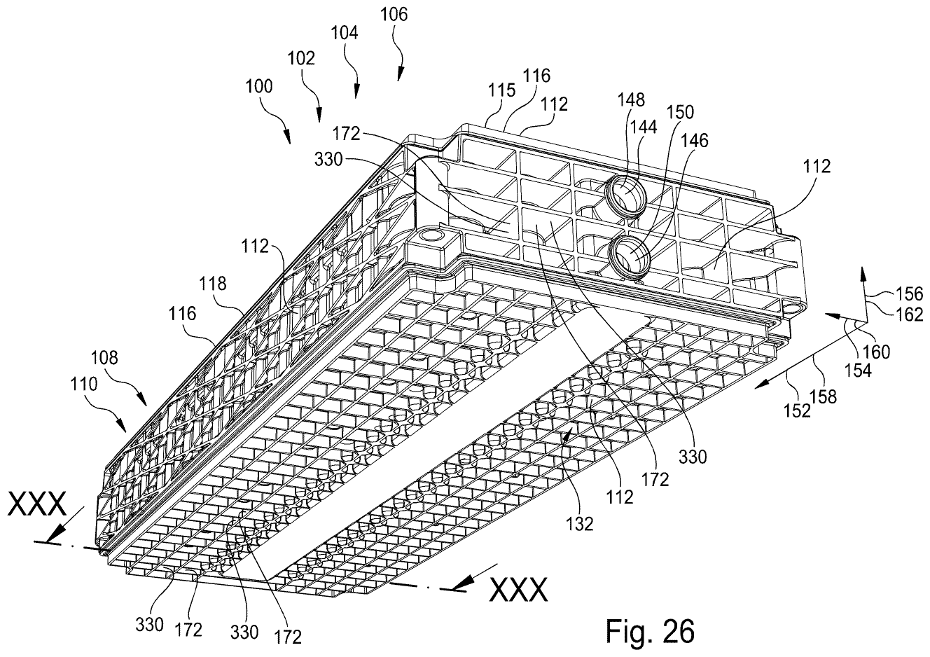

FIGS. 26 to 32 illustrate a fifth embodiment of an energy storage unit 100 according to the invention.

The fifth embodiment of the energy storage unit 100 according to the invention, shown in FIG. 26, is similar in many respects to the energy storage units 100 of the first to fourth embodiments. Therefore, repetitions in the description of the figure are largely dispensed with. The temperature-control fluid barrier 108 shown in FIG. 26 has a barrier zone 112. The barrier zone 112 shown therein is also reinforced by reinforcement elements 172. Part of the reinforcement elements 172 can be seen in FIG. 26. These reinforcement elements 172 are external reinforcement elements 330 which are disposed on the outside of the barrier zone 112. The external reinforcement elements 330 are disposed in a grid-like manner on a plurality of barrier zones 112, wherein part of the external reinforcement elements 330 extend in each case in one direction and another part of the external reinforcement elements 330 in another direction along the respective barrier zone 112 respectively.

As will become obvious from the following figures, the energy storage unit 100 shown in FIG. 26 also has reinforcement elements 172 which extend from a barrier zone 112 into a temperature-control chamber.

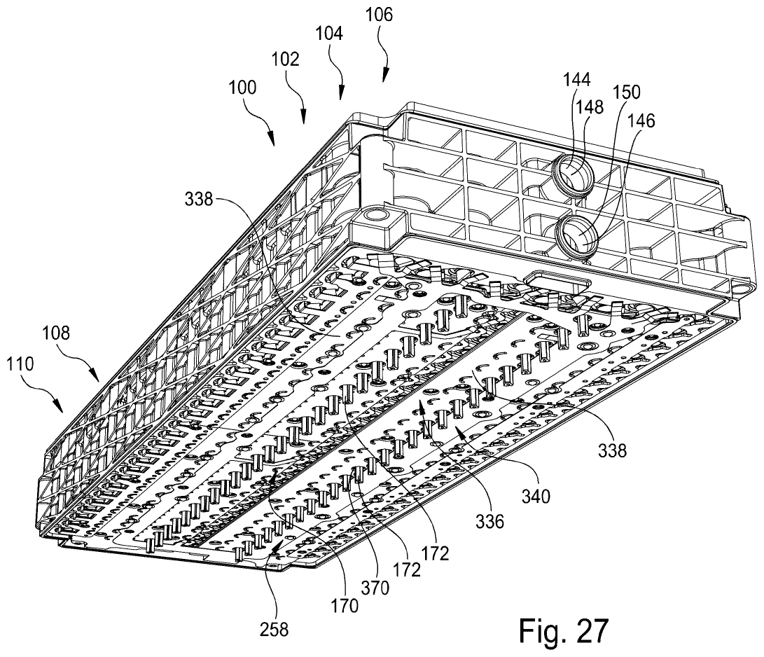

In FIG. 27, the energy storage unit 100 from FIG. 26 is illustrated without the base element 132. This renders components of the contacting system 336 and monitoring system 340 comprised by the energy storage unit 100 visible. The removal of the base element 132 also provides a clear view of reinforcement elements 172.

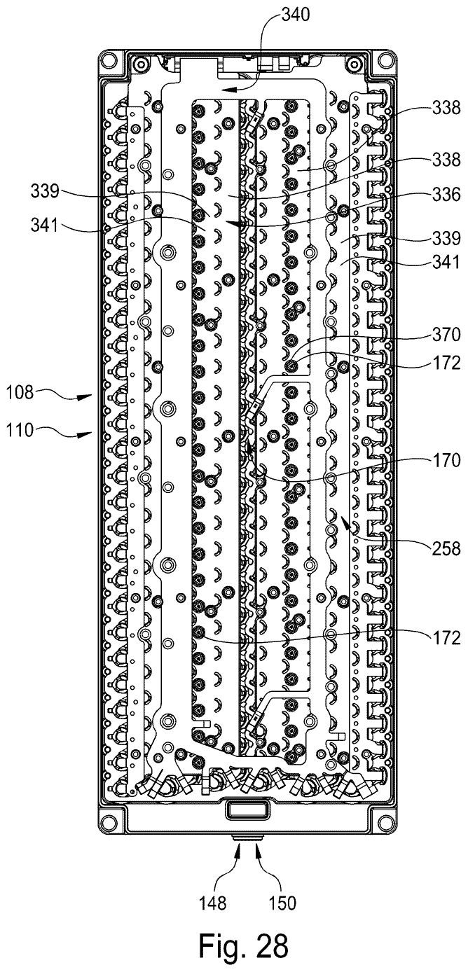

In FIG. 28, the energy storage unit 100 from FIG. 27 is illustrated from below. The energy storage unit 100 shown comprises a monitoring system 340 and a contacting system 336. It comprises contacting elements 338.

Owing to one of the contacting elements, a portion 341 of an electrically conducting connection 339 of energy storage elements 164 of the energy storage unit 100 to a contacting zone 350 of the energy storage unit 100 is established. The energy storage elements 164 and the contacting zone 350 cannot be seen in FIG. 28. The same applies to the second contacting element 338 which is shown in FIG. 28. Owing to the second contacting element 338, a portion 341 of a further electrically conducting connection 339 of energy storage elements 164 of the energy storage unit 100 to the other contacting zone of the energy storage unit 100 is established. The other contacting zone 350 also cannot be seen in FIG. 28.

It is also easy to see from FIG. 28 that the two contacting elements 338 each have reinforcement element recesses 370.

Reinforcement elements 172 extend through the reinforcement element recesses 370 into the temperature-control chamber 170.

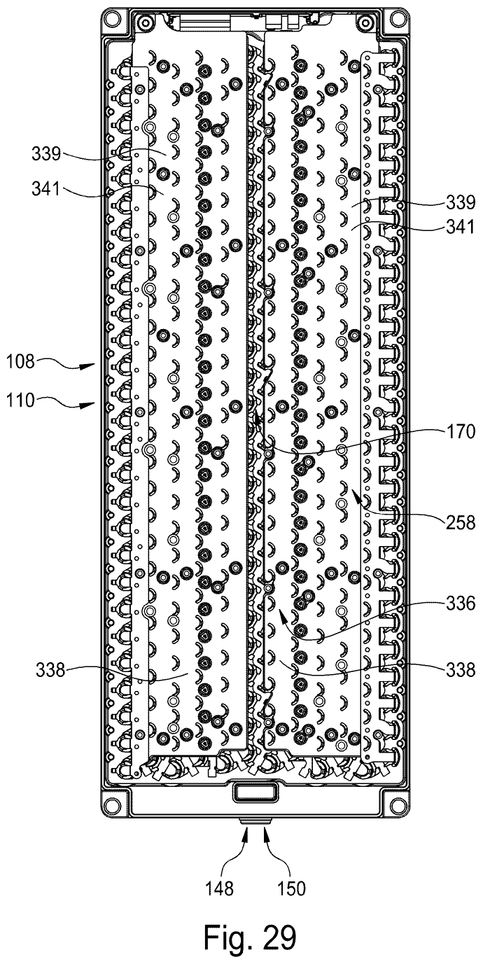

The illustration shown in FIG. 29 corresponds to that shown in FIG. 28, wherein the monitoring system 340 is not illustrated.

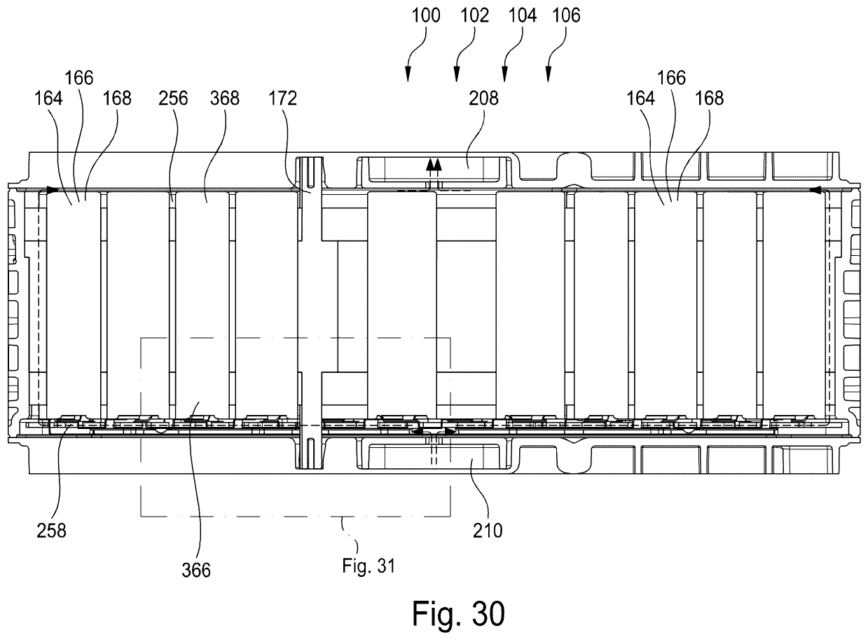

FIG. 30 shows a section through the energy storage unit 100 from FIG. 26 along the line X-X. In FIG. 30, the respective temperature-control fluid flow direction is indicated by dashed arrows.

FIG. 30 also shows a temperature-control fluid collection channel 208 and a temperature-control fluid distribution channel 210. These two channels 208, 210 extend along the viewing direction. The inlet 150 is fluidically connected to the temperature-control fluid distribution channel 210. The outlet 148 is fluidically connected to the temperature-control fluid collection channel 208.

The energy storage elements 164 of the energy storage unit 100 shown in FIG. 30 each have a first end 366 and a second end 368. For reasons of clarity, only one of the energy storage elements 164 is provided with the two reference numerals 366 and 368.

The energy storage elements 164 each have a first end 366 facing the first temperature-control zone 258.

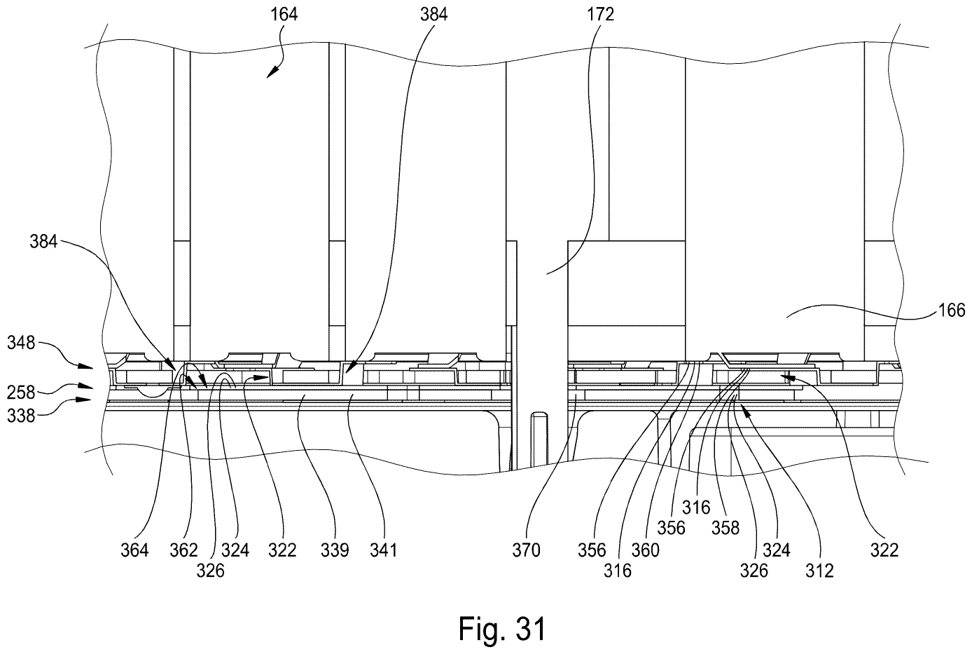

A detail of FIG. 30 is illustrated in an enlargement in FIG. 31. FIG. 31 shows that the energy storage elements 164 each have two storage element contact zones 316. One of the storage element contact zones 316 is a positive pole 358. The other of the storage element contact zones 316 is a negative pole 360. The two storage element contact zones 316 mentioned are disposed on the first end 366 of the respective energy storage element 164.

FIG. 31 shows that the energy storage unit 100 comprises a connection zone 348 in which the storage element contact zones 316 of different energy storage elements 164 are connected to one another in an electrically conducting manner.

In the connecting zone, the storage element contact zones of different energy storage elements are in each case connected to one another via one of a plurality of connecting devices 384.

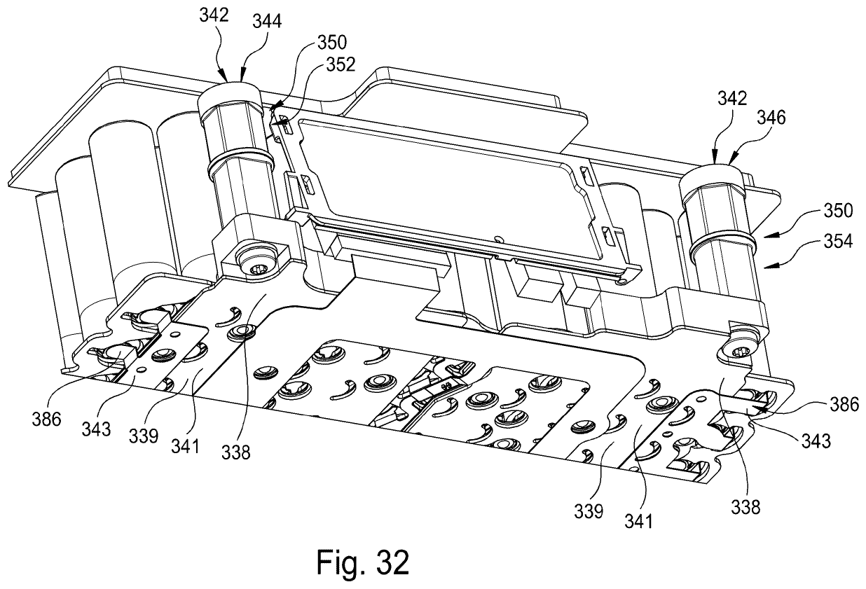

FIG. 32 shows the section from FIG. 30 in a perspective illustration. It becomes evident from the illustration shown there that owing to the two contacting elements 338, in each case at least a portion 341 of an electrically conducting connection 339 of at least one of the energy storage elements 164 of the energy storage unit 100 to in each case one of two contacting zones 350 of the energy storage unit 100 is established. The contacting zone illustrated on the left in FIG. 32 is a first contacting zone 352. The contacting zone illustrated on the right in FIG. 32 is a second contacting zone 354.

A terminal 342 can in each case be present in the region of the contacting zones 350, wherein a first terminal 344 can be present in the region of the first contacting zone 352 and a second terminal 346 can be present in the region of the second contacting zone 354.

FIG. 32 also shows that the two contacting elements are not in each case directly connected to one of the energy storage elements 164 by way of an electrically conducting connection 339. The electrically conducting connection 339 from the contacting elements 338 to the energy storage elements 164 is in each case established via a peripheral connecting device 386.

Owing to in each case one peripheral connecting device 386, a further portion 343 of the respective electrically conducting connection 339 of energy storage elements 164 of the energy storage unit 100 to the respective contacting zone 350 is established.

FIG. 33 shows an example of a contacting system 336 according to the invention. The contacting system shown is installed in the energy storage unit 100 according to the fifth embodiment illustrated in FIGS. 26 to 32. The contacting system 336 shown is a contacting system 336 for contacting energy storage elements 164. The contacting of energy storage elements 164 can take place on the connecting side 390. The contacting system is also suitable for guiding a temperature-control fluid in a temperature-control zone 255, 256, 258 of an energy storage unit 100, for example an energy storage unit 100 according to one of the first to fifth embodiments described herein.

The contacting system 336 comprises a carrier element 372. The carrier element can, for example, serve to hold the energy storage elements 164 in desired positions. The carrier element 372 can moreover serve to hold the connecting devices 384, which are described with reference to the following figures, in desired positions.

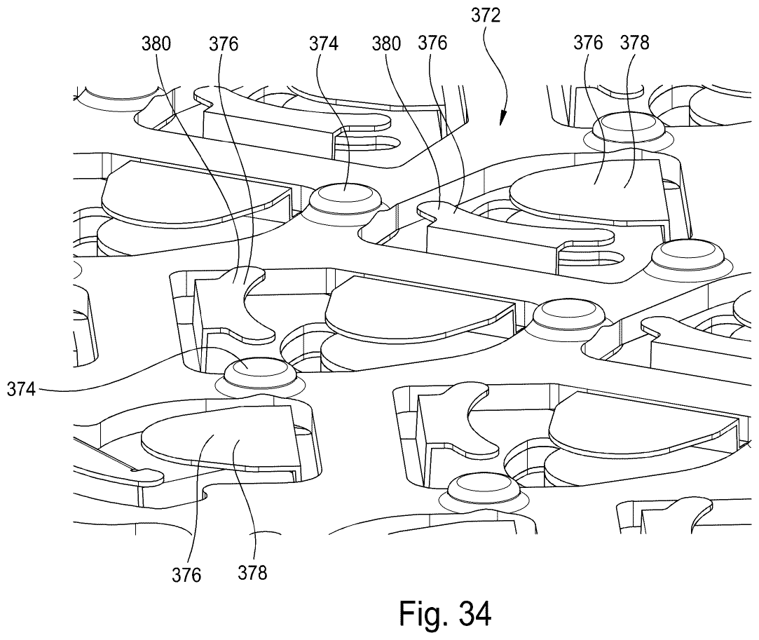

FIG. 34 shows an enlarged detail of FIG. 33. FIG. 34 shows that the carrier element 372 has positioning elements 374. The positioning elements 374 can be used to hold the energy storage elements 164 on the connecting side 390 in the desired positions.

FIG. 34 shows that the contacting system 336 has connecting zones 376. The connecting zones 376 include positive-pole connecting zones 378 and negative-pole connecting zones 380.

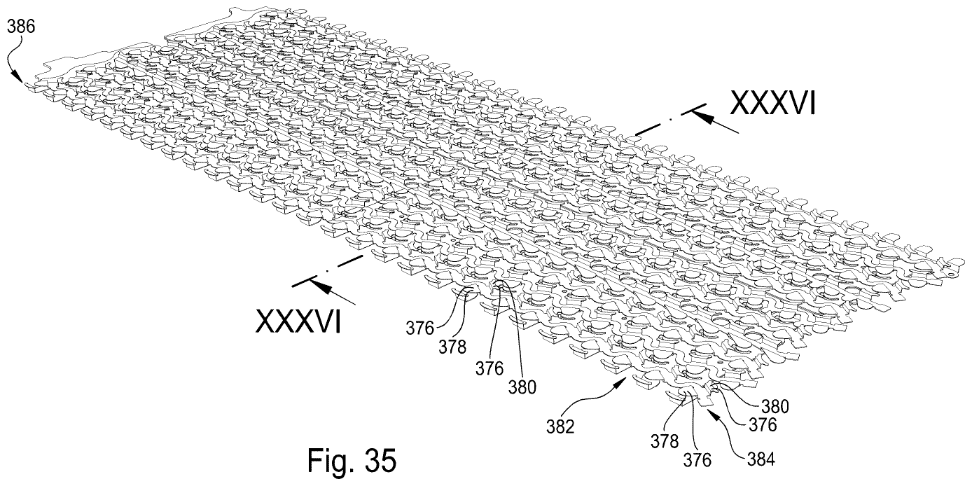

FIG. 35 shows the contacting system 336, which is also illustrated in FIGS. 33 and 34, without the carrier element 372. FIG. 35 shows that the contacting system 336 has a plurality of connecting devices 384 extending substantially parallel to one another. The connecting devices 384 extend also substantially parallel to the peripheral connecting devices 386 which are in each case provided on the two peripheries. The connecting devices 384 are each connecting devices which have at least two connecting zones 376, 378 and 380 that are connected to one another in an electrically conducting manner. They each have at least two positive-pole connecting zones 378 and negative-pole connecting zones 380 which are connected to one another in an electrically conducting manner.

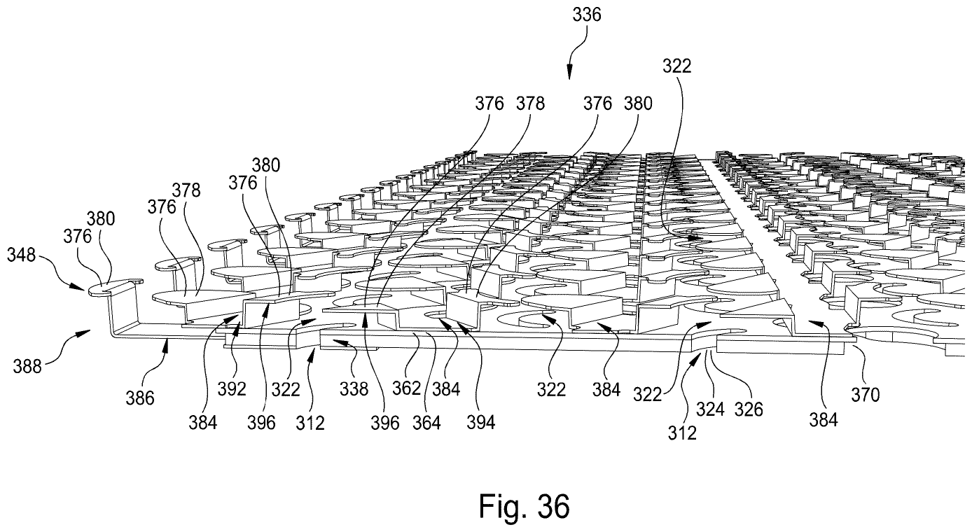

FIG. 36 shows a section through the illustration in FIG. 35 along the line XXXVI-XXXVI. One of the connecting devices 384 forms a first connecting device. A connecting device 384 directly adjacent thereto forms a second connecting device 394.

A negative-pole connecting zone 380 is formed on a contact portion 396 of the first connecting device 392. A positive-pole connecting zone 378 is formed on a contact portion 396 of the second connecting device 394.

These two contact sections 396 are contiguous to a contact temperature-control zone 322.

The contacting element 338 has the flow interference unit 312 at the contact temperature-control zone 322. The flow interference unit 312 acts as a turbulator 326. In the example shown, the latter is designed as a passage zone 324. In the contact temperature-control zone 322, a particularly efficient possibility for cooling an energy storage element 164 via the storage element contact zone 316 and the current conductor elements 318, 320, which extends thereto, can result.

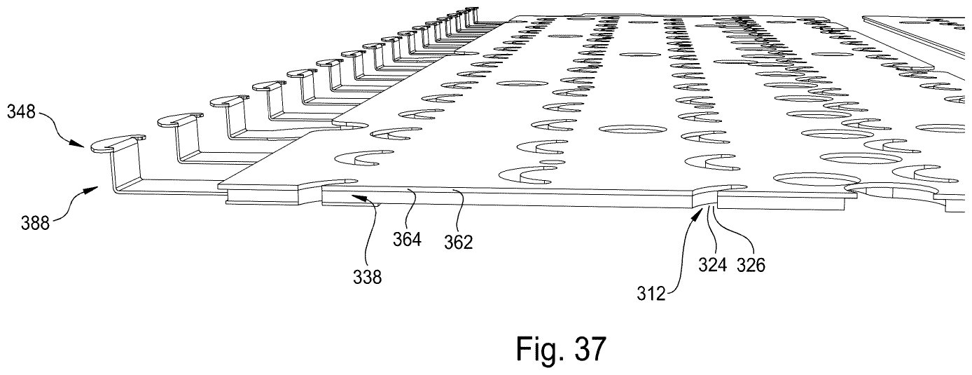

FIG. 37 corresponds to FIG. 36, wherein the connecting devices 384 are not illustrated. From FIGS. 36 and 37 it becomes evident that the insulation material 362 prevents direct electrical contact of the portion of the contacting element 338 that extends along the connection zone 348 with the connection zone 348. The insulation material 362 forms a layer 364 which is disposed between the contacting element 338 and the connecting devices 384.

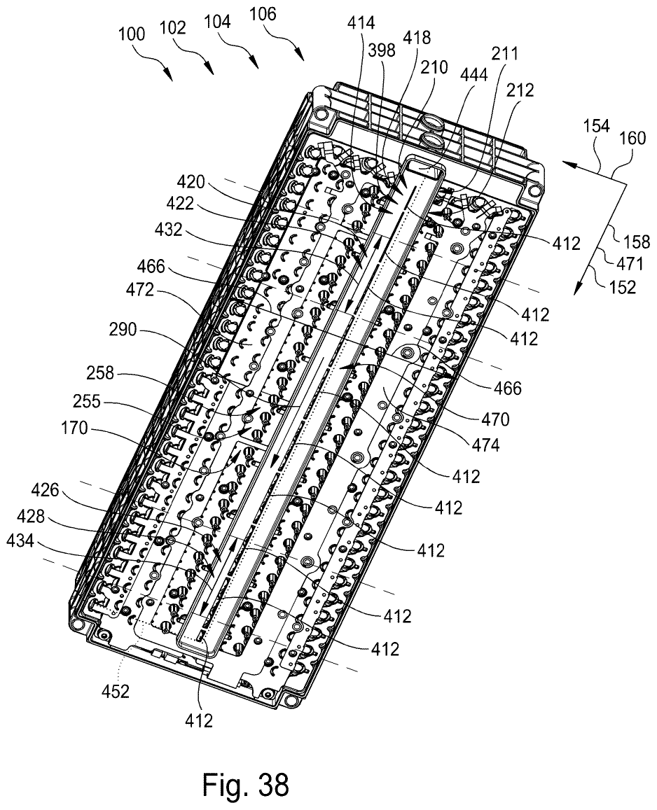

FIG. 38 also shows the energy storage unit 100 according to the fifth embodiment. Deviating from the illustration in FIG. 27, a temperature-control fluid guide element 211 is additionally illustrated. The temperature-control fluid guide element 211 is a first temperature-control fluid guide element 212.

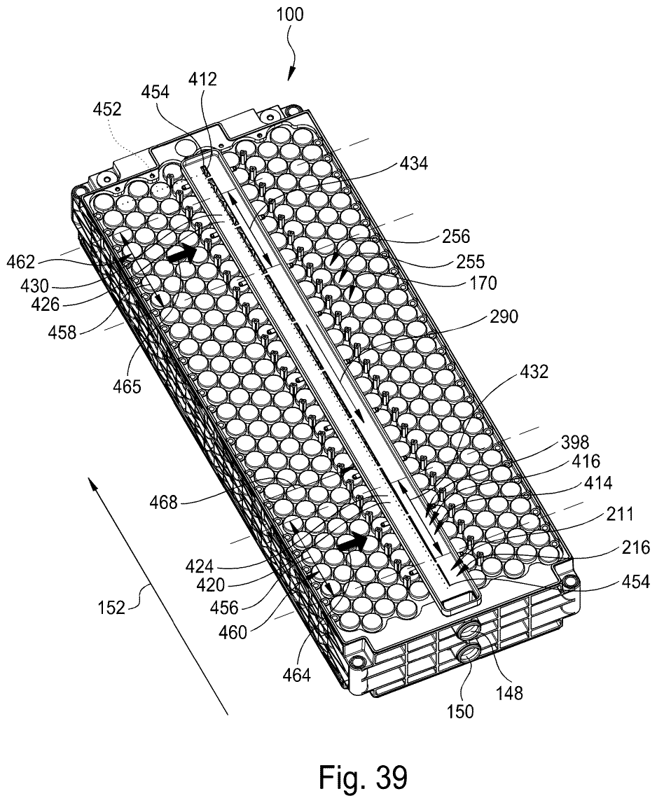

Moreover, the energy storage unit 100 comprises a further temperature-control fluid guide element 211. The further temperature-control fluid guide element 211 is a second temperature-control fluid guide element 216. The second temperature-control fluid guide element 216 is disposed opposite the first temperature-control fluid guide element 212. FIG. 39 shows the energy storage unit 100 according to the fifth embodiment without the lid element 120. The second temperature-control fluid guide element 216 is disposed at the top below the lid element 120. The first temperature-control fluid guide element 212 is disposed at the bottom above the base element 132.

From FIGS. 38 and 39 it is clear that the energy storage unit 100 comprises two temperature-control fluid guide zones 414 according to the fifth embodiment. The one temperature-control fluid guide zone 414 is a temperature-control fluid distribution zone 418. It is illustrated in FIG. 38. The other temperature-control fluid guide zone 414 is a temperature-control fluid collection zone 416. It is illustrated in FIG. 39. The energy storage units 100 according to the first to fourth embodiments each comprise two temperature-control fluid guide zones 414, wherein one of the temperature-control fluid guide zones 414 is a temperature-control fluid collection zone 416 and the other of the temperature-control fluid guide zones 414 is a temperature-control fluid distribution zone 418.

Respective details will be described hereunder in the context of the fifth embodiment with reference to FIGS. 38 to 45.

The two temperature-control fluid guide zones 414 shown in FIGS. 38 and 39 each extend through a temperature-control fluid guide channel 398.

FIG. 38 illustrates that the temperature-control fluid guide zone 414 shown there comprises a first guide zone portion 420 and a second guide zone portion 426. The first guide zone portion 420 shown there is a first distribution zone portion 422. The second guide zone portion 426 shown there is a second distribution zone portion 428.

The temperature-control fluid guide zone 414 shown in FIG. 39 also comprises a first guide zone portion 420 and a second guide zone portion 426. The first guide zone portion 420 shown there is a first collection zone portion 424. The second guide zone portion 426 shown there is a second collection zone portion 430.

The two first guide zone portions 420 shown in FIGS. 38 and 39 lie opposite one another. The two second guide zone portions 426 shown in FIGS. 38 and 39 also lie opposite one another.

The two guide zone portions 420 and 426 shown in FIG. 38 as well as the two guide zone portions 420 and 426 shown in FIG. 39 follow one another indirectly in the temperature-control fluid flow direction 290 in which the temperature-control fluid in the respective temperature-control fluid guide zone is guided.

The guide zone portions 420 and 426 shown in FIG. 38 as well as the guide zone portions 420 and 426 shown in FIG. 39 are mutually offset in a first direction 152 which is a direction of longitudinal extent 158 of the energy storage unit 100.

The guide zone portions 420 and 426 are in no way delimited by the regions of the temperature-control fluid guide zones 414 that are contiguous to the guide zone portions 420 and 426.

However, the guide zone portions 420 and 426 are chosen in such a way that a first guide zone portion extent 432 of the first guide zone portion 420 in the first direction 152 is identical in size to a second guide zone portion extent 434 of the second guide zone portion 426 in the first direction 152.

The temperature-control fluid distribution zone 418 shown in FIG. 38 extends through a temperature-control fluid distribution channel 210.

The temperature-control fluid collection zone 416 shown in FIG. 39 extends through a temperature-control fluid collection channel.

The temperature-control chamber 170 of the energy storage unit 100 has two temperature-control zones 255. The temperature-control zone 255 shown in FIG. 38 is a first temperature-control zone 258. The temperature-control zone 255 shown in FIG. 39 is a second temperature-control zone 256.

The temperature-control fluid guide zone 414 shown in FIG. 38 is fluidically connected to the first temperature-control zone 258 via a plurality of passages 412.

The temperature-control fluid guide zone 414 shown in FIG. 39 is fluidically connected to the second temperature-control zone 256 via a plurality of passages 412. In both temperature-control fluid guide zones 414, the passages are designed in such a way that a second flow resistance for the transfer of temperature-control fluid between the temperature-control zone 255 and the second guide zone portion 426 is lower than a first flow resistance for the transfer of the temperature-control fluid between the temperature-control zone 255 and the first guide zone portion 420.

There are many different ways to adjust the flow resistances of the passages.

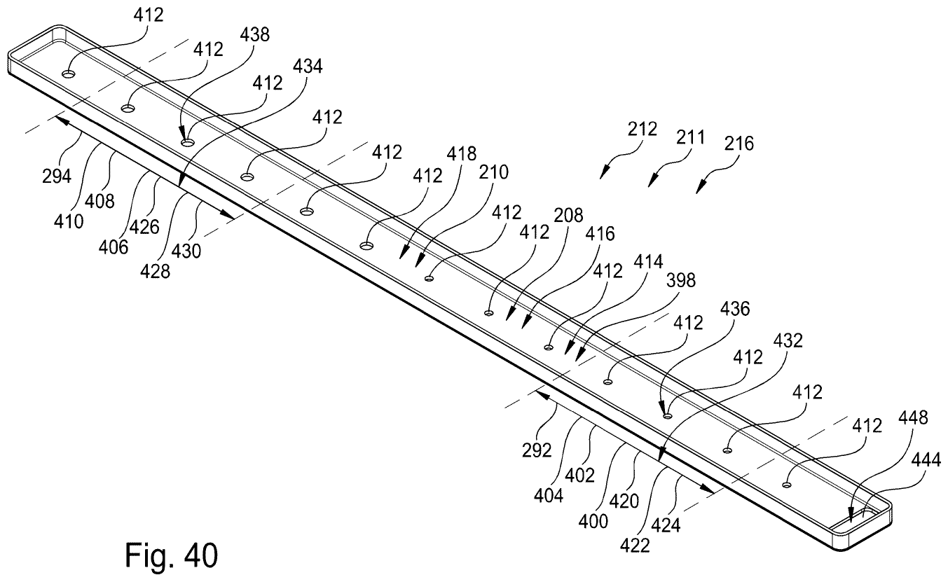

This is illustrated with reference to the temperature-control fluid guide elements 211 shown in FIGS. 40 to 45, which can be used optionally as the first temperature-control fluid guide element 212 (cf. FIG. 38) or as the second temperature-control fluid guide element 216 (cf. FIG. 39).

Depending on the use as the first temperature-control fluid guide element 212 or as the second temperature-control fluid guide element 216, the temperature-control fluid guide zone 414 can act as a temperature-control fluid distribution zone 418 or as a temperature-control fluid collection zone 416. The temperature-control fluid distribution zone 418 can extend through a temperature-control fluid distribution channel 210. The temperature-control fluid collection zone 416 can extend through a temperature-control fluid collection channel 208.

When the temperature-control fluid guide element 211 shown in FIG. 40 is used as a first temperature-control fluid guide element, the first guide zone portion 420 is a first distribution zone portion 422 and the second guide zone portion 426 is a second distribution zone portion 428.

When the temperature-control fluid guide element 211 shown in FIG. 40 is used as a second temperature-control fluid guide element 216, the first guide zone portion 420 is a first collection zone portion 424 and the second guide zone portion 426 is a second collection zone portion 430.

A first temperature-control fluid guide channel portion 400 can extend through the first guide zone portion 420. A first temperature-control fluid distribution channel portion 402 can extend through the first distribution zone portion 422. A first temperature-control fluid collection channel portion 404 can extend through the first collection zone portion 424.

The first temperature-control fluid distribution channel portion 402 can, for example, be the first portion 292 which has also been described in the context of other figures herein. The first temperature-control fluid collection channel portion 404 can, for example, be the first portion 292 which has also been described in the context of other figures herein.

The second temperature-control fluid distribution channel portion 408 can, for example, be the second portion 294 which has also been described in the context of other figures herein. The second temperature-control fluid collection channel portion 410 can, for example, be the second portion 294 which has also been described in the context of other figures herein.

In FIG. 40, a first guide zone portion extent 432 of the first guide zone portion 420 in the first direction 152 is identical in size to a second guide zone portion extent 434 of the second guide zone portion 426 in the first direction 152.

When the temperature-control fluid guide element 211 shown in FIG. 40 is used according to the invention in an energy storage unit 100, the temperature-control fluid guide zone 414 is able to be fluidically connected via a plurality of passages 412 to one of the two temperature-control zones 255, 256, 258.

From FIG. 40 it can be directly seen that the passages 412 are designed in such a way that a second flow resistance for the transfer of temperature-control fluid between the temperature-control zone 255, 256, 258 and the second guide zone portion 426 is lower than a first flow resistance for the transfer of temperature-control fluid between the temperature-control zone 255, 256, 258 and the first guide zone portion 420.

For this purpose, a first cross section 436 of a passage 412 in the first guide zone portion 420 is smaller than a second cross section 438 of another passage 412 in the second guide zone portion 426.

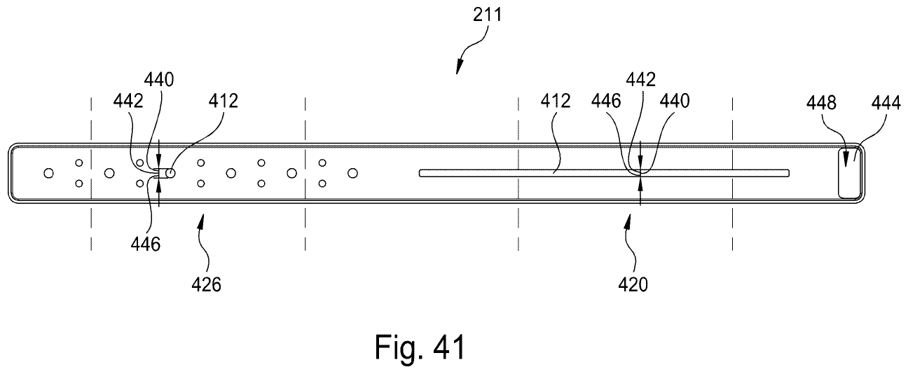

FIG. 41 shows a further temperature-control fluid guide element 211. A dimension 440 of a passage 412 in the first guide zone portion 420 is smaller than a dimension 440 of another passage in the second guide zone portion 426. In FIG. 41, the dimension 440 is in each case a diameter 446. The diameter 446 is in each case a smallest diameter 442.

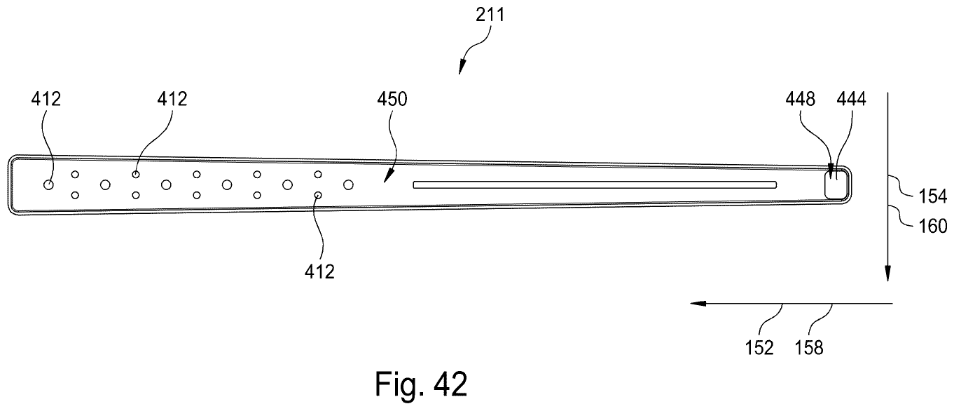

The temperature-control fluid guide element 211 shown in FIG. 42 is similar to the temperature-control fluid guide element 211 shown in FIG. 41. In the temperature-control fluid guide element 211 shown in FIG. 42, the temperature-control fluid guide zone 414 has a taper zone 450. The temperature-control fluid guide zone 414 tapers in the taper zone 450 in the temperature-control fluid flow direction 290 in which the temperature-control fluid can be guided in the temperature-control fluid guide zone 414. Alternatively, it can be provided that the temperature-control fluid guide zone in the taper zone 450 tapers counter to the temperature-control fluid flow direction 290. This depends on whether the temperature-control fluid guide element 211 is used as a second temperature-control fluid guide element 216 for collecting temperature-control fluid, or as a first temperature-control fluid guide element for distributing temperature-control fluid.

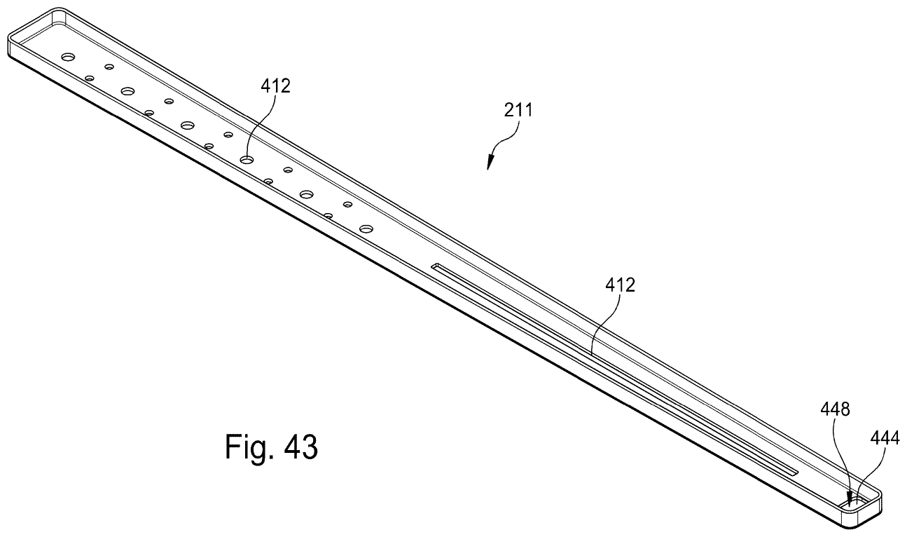

FIG. 43 shows the temperature-control fluid guide element 211 from FIG. 42 in a perspective illustration.

FIG. 43 shows that the temperature-control fluid guide zone 414 in the taper zone 450 tapers in a second direction 154 which can be, for example, the direction of width extent 160 of the energy storage unit 100.

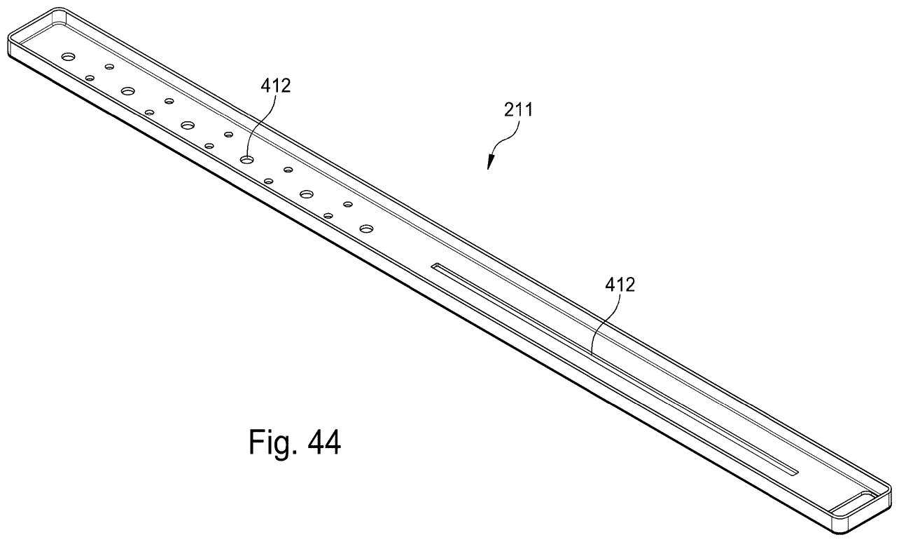

FIG. 44 shows the temperature-control fluid guide element 211 from FIG. 41 in a perspective illustration.

In the temperature-control fluid guide element 211 shown in FIGS. 41 and 44 as well as in the temperature-control fluid guide element 211 shown in FIGS. 42 and 43, a number of passages 412 in the first guide zone portion 420 is less than a number of passages 412 in the second guide zone portion 426. FIG. 41 illustrates this by way of example for the temperature-control fluid guide element 211 which is illustrated in FIGS. 41 and 44.

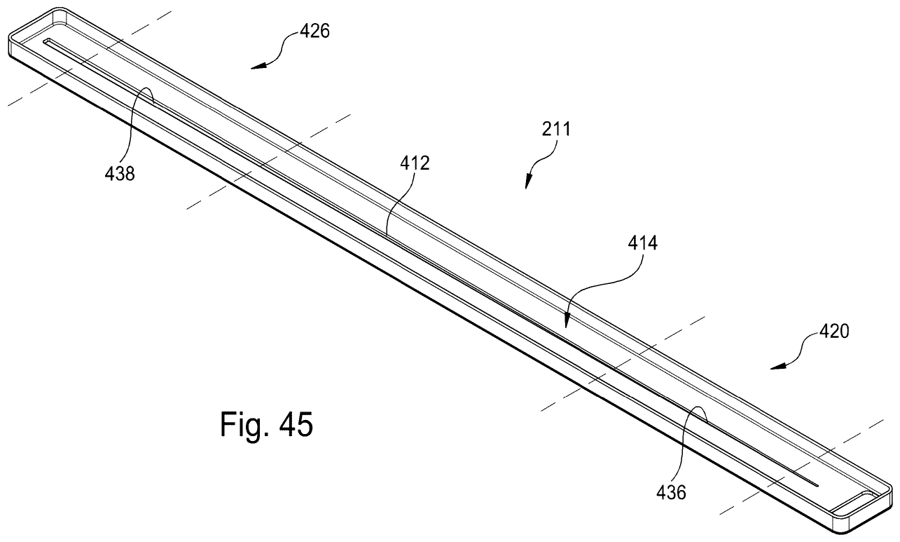

The temperature-control fluid guide element 211 shown in FIG. 45 also has a passage 412 via which the temperature-control fluid guide zone 414 is able to be fluidically connected to a temperature-control zone 255, 256, 258. The passage is designed in such a way that a second flow resistance for the transfer of temperature-control fluid between the temperature-control zone 255, 256, 258 and the second guide zone portion 426 is lower than a first flow resistance for the transfer of temperature-control fluid between the temperature-control zone 255, 256, 258 and the first guide zone portion 420.

A dimension 440 of the passage 412 in the first guide zone portion 420 is smaller than a dimension 440 of the same passage 412 in the second guide zone portion 426. The dimension can be, for example, a slot width of the slot-shaped passage 412 shown in FIG. 45.

Moreover, in the temperature-control fluid guide element 211 shown in FIG. 45, a first cross section 436 of the passage 412 in the first guide zone portion 420 is smaller than a second cross section 438 of the same passage in the second guide zone portion 426. The cross section can in particular be the cross-sectional area which comprises the portion of the passage 412 lying in the respective guide zone portion 420 or 426.

In FIGS. 38 and 39, a shortest temperature control path 452 is plotted using dotted lines. The shortest temperature control path 452 leads from a passage 412, which is shown in FIG. 38, via the first temperature-control zone 258, also shown in FIG. 38, through a temperature-control fluid passage 254 into the second temperature-control zone 256, which can be seen in FIG. 39. The shortest temperature control path 452 continues via the second temperature-control zone 256 to a passage 412 which is shown in FIG. 39.

Additionally, a largest spacing between passage ends 454 is illustrated in FIG. 39. This largest distance is also illustrated by dotted lines. A dotted line connects the two passage ends 454.

From FIGS. 38 and 39 it can be seen that the length of the shortest temperature path 452 is at most 150% of the largest spacing between passage ends 454 that is able to be measured in the first direction 152.

In all embodiments shown in the figures, the temperature-control chamber 170 has a first temperature-control zone and a second temperature-control zone. Moreover, the energy storage units 100 each have a plurality of temperature-control fluid passages 254. The temperature-control fluid passages 254 connect in each case the first temperature-control zone 258 fluidically to the second temperature-control zone 256. FIG. 9 shows, by way of example for one of the embodiments, the first temperature-control zone 258 and the second temperature-control zone 256. In the embodiment shown there, the temperature-control fluid passages 254 are integrated into the shaped element 246 which is shown in FIG. 12.

The invention does preclude the fact that one or a plurality of further temperature-control zones are present between the first temperature-control zone 258 and the second temperature-control zone 256. This means that the temperature-control fluid passages 254 do not necessarily have to lead directly from the first temperature-control zone 258 to the second temperature-control zone 256.

It is conceivable that there is an indirect connection of the first temperature-control zone 258 via one or a plurality of temperature-control fluid passages 254 and at least one further temperature-control zone to the second temperature-control zone 256. For example, further temperature-control fluid passages can be provided between one of the further temperature-control zones and the second temperature-control zone 256.

FIG. 39 illustrates for another embodiment that a plurality of temperature-control fluid passages 254 comprise a first passage portion 456 and a second passage portion 458, wherein a passage portion extent 460 of the first passage portion 456 in a first direction 152, which is the direction of longitudinal extent 158 of the energy storage unit 100, is identical in size to a second passage portion extent 462 of the second passage portion 458 in the first direction 152.

The two passage portions 456 and 458 are mutually offset in the first direction 152.

It is possible that the temperature-control fluid passages 254 are designed in such a way that a second passage flow resistance for the passage of temperature-control fluid from the first temperature-control zone 258 to the second temperature-control zone 256 in the second passage portion 458 is lower than a first passage flow resistance for the passage of temperature-control fluid from the first temperature-control zone 258 to the second temperature-control zone 256 in the first passage portion 456.

When viewing FIG. 39, it is obvious that a second temperature-control fluid guide path 465 leading from the inlet 150 to the outlet 148 centrally through the second passage portion 458 is longer than a first temperature-control fluid guide path 464 leading from the inlet 150 to the outlet centrally through the first passage portion. Plotted in FIG. 39 are arrows that indicate the course of the first temperature-control fluid guide path 464 leading through the first passage portion 456 in the second temperature-control zone 256.

It can be advantageous when a dimension 440 of a temperature-control fluid passage 254 in the first passage portion 456 is smaller than a dimension 440 of the same temperature-control fluid passage 254 or of another temperature-control fluid passage 254 in the second passage portion 458. The dimension can be in particular a diameter 446, for example a smallest diameter 442.

It is conceivable that a first cross section 436 of a temperature-control fluid passage 254 in the first passage portion 456 is smaller than a second cross section 438 of the same temperature-control fluid passage 254 or another temperature-control fluid passage 254 in the second passage portion 458.

It is also conceivable that a number of temperature-control fluid passages 254 in the first passage portion 456 is smaller than a number of temperature-control fluid passages 254 in the second passage portion 458.

In all embodiments shown in the figures, in a main flow direction 466, which is indicated by way of example in FIG. 38, proceeding from a temperature-control fluid distribution zone 418, at most 20 energy storage elements 164, for example at most 12 energy storage elements 164, are able to be temperature-controlled by means of the temperature-control fluid which is able to be guided in the main flow direction 466. As shown in FIG. 38, the main flow direction 466 runs parallel to the second direction 154 which is a direction of width extent 160 of the energy storage unit 100. The main flow direction 466 runs in this direction towards the temperature-control fluid passage 254.

FIG. 39 shows a main counterflow direction 468. The main counterflow direction 468 runs counter to the main flow direction 466 through the second temperature-control zone 256 towards a temperature-control fluid collection zone 416. In the main counterflow direction 468, proceeding from the temperature-control fluid passage 254, at most 20 energy storage elements 164, for example at most 12 energy storage elements 164, are able to be temperature-controlled by means of the temperature-control fluid which is able to be guided in the main counterflow direction 468.

As is obvious in particular from FIG. 30, in the main flow direction 466, in the first temperature-control zone 258 first ends 366 of the at most 20 energy storage elements 164, for example of the at most 12 energy storage elements 164, can be able to be temperature-controlled by means of the temperature-control fluid which is able to be guided in the main flow direction 466. Moreover, in the main counterflow direction 468, in the second temperature-control zone 256, second ends 368 of the at most 20 energy storage elements 164, for example of the at most 12 energy storage elements 164, can be able to be temperature-controlled by means of the temperature-control fluid which is able to be guided in the main counterflow direction 468.

The first ends 366 and second ends 368 are mutually opposite ends 366 and 368 of the same at most 20 energy storage elements 164, for example of the same at most 12 energy storage elements 164.

In a method according to the invention for controlling the temperature of energy storage elements 164, a temperature-control fluid is supplied to a first central region 470 of a first temperature-control zone 258 of an energy storage unit 100. The first central region 470 extends in a longitudinal direction 471 of the first temperature-control zone 258 through the first temperature-control zone 258. The first central region divides the first temperature-control zone 258 into an outflow zone 472 lying on one side of the first central region 470 and into a second outflow zone 474 lying on the other side of the first central region 470. This is illustrated by way of example in FIG. 38 for the embodiment of an energy storage unit 100 shown there.

The temperature-control fluid supplied to the first temperature-control zone 258 is divided among the first outflow zone 472 and the second outflow zone 474, and is therein guided in each case so as to be in heat exchange contact with part of the energy storage elements 164 of the energy storage unit 100.

In the method according to the invention, it can be provided that the temperature-control fluid guided and heated in an indirectly or directly preceding method step in the heat exchange contact with in each case part of the energy storage elements 164 is discharged from the energy storage unit 100.

FIG. 38 also shows that at least part of the temperature-control fluid supplied to the first temperature-control zone 258 spreads in the first outflow zone 472 and in the second outflow zone 474 in mutually opposite main flow directions 466.

The number of energy storage elements 164 in sequence along the main flow directions 466, proceeding from the first central region 470, is so small and so much temperature-control fluid is conveyed through the energy storage unit 100, that the temperature of the temperature-control fluid discharged from the energy storage unit during a charging operation of the energy storage unit 100, in which the energy storage unit 100 is transferred from a charge state of 10% to a charge state of 90% in 30 minutes, does not exceed a temperature of the temperature-control fluid flowing into the energy storage unit by more than 6 K, preferably not by more than 4 K, for example not by more than 2.5 K.

### LIST OF REFERENCE SIGNS

100 Energy storage unit
102 Energy storage module
104 Electrochemical energy storage unit
106 Electrochemical energy storage module
108 Temperature-control fluid barrier
110 Housing
112 Barrier zone
113 Frontal barrier zone
114 Wall zone
115 Barrier element
116 First barrier element
118 Cover element
120 Lid element
122 Overlapping portion
124 Channel barrier zone
126 First barrier zone
128 First wall zone
130 Second barrier element
132 Base element
134 Second barrier zone
136 Third barrier element
138 Frame wall element
140 Barrier zone
142 Frame
144 First opening
146 Second opening
148 Outlet
150 Inlet
152 First direction
154 Second direction
156 Third direction
158 Direction of length extent
160 Direction of width extent
162 Direction of height extent
164 Energy storage element
166 Electrochemical energy storage element
168 Battery cell
170 Temperature control chamber
172 Reinforcement element
174 Sleeve
176 Recess
178 Wall end
180 Sealing element
182 Weld seam
184 Second barrier zone
186 Second wall zone
188 Counter-reinforcement element
190 Support reinforcement element
192 End
194 First end
196 Second end
198 Depression
200 First depression
202 Second depression
204 Hollow-cylindrical reinforcement wall
206 Hollow-cylindrical depression
208 Temperature-control fluid collection channel
210 Temperature-control fluid distribution channel
211 Temperature-control fluid guide element
212 First temperature-control fluid guide element
214 Further overlapping portion
216 Second temperature-control fluid guide element
218 Further channel barrier zone
220 Surface
222 First plane
224 Second plane
226 Third plane
228 Fourth plane
230 Prism
232 First prism
234 Second prism
238 Edge
240 Straight line
242 Shell surface
243 Cylindrical depression
244 Second cylindrical depression
246 Shaped element
248 Positioning zone
250 Storage element receptacle zone
252 Temperature-control fluid guide element
254 Temperature-control fluid passage
255 Temperature-control zone
256 Second temperature-control zone
258 First temperature-control zone
260 Monitoring unit
262 Monitoring circuit
264 Cell monitoring circuit
266 Cell Supervisory Circuit (CSC)
268 Monitoring zone
270 Monitoring space
272 Monitoring space barrier
274 Shielding material
276 Plastics material
278 Plastics foam material
280 Inflow direction
282 Outflow direction
284, 286 Frontal plane
288 Temperature-control fluid collection channel
290 Temperature-control fluid flow direction
292 First portion
294 Second portion
296 Fluid collection passage
298 Fixing element
300 Screw
302 Shoulder zone
304 Neck zone
306 Head zone
308 Fixing zone
310 Fluid guide unit
312 Flow interference unit
314 Temperature-control zone subdivision unit
316 Storage element contact zone
318 Current conductor element
320 Current conductor element
322 Contact temperature-control zone
324 Passage zone
326 Turbulator
328 Surface facing a temperature-control zone
330 External reinforcement element
332 Fluid deflection element
334 Bend
336 Contacting system
338 Contacting element
339 Electrically conducting connection
340 Monitoring system
341 Portion
342 Terminal
344 First terminal
346 Second terminal
348 Connection zone
350 Contacting zone
352 First contacting zone
354 Second contacting zone
356 Pole
358 Positive pole
360 Negative pole
362 Insulation material
364 Layer
366 First end
368 Second end
370 Reinforcement element recess
372 Carrier element
374 Positioning element
376 Connecting zone
378 Positive pole connecting zone
380 Negative pole connecting zone
384 Connecting device
386 Peripheral connecting device
390 Connecting side
392 First connecting device
394 Second connecting device
396 Contact portion
398 Temperature-control fluid guide channel
400 First temperature-control fluid guide channel portion
402 First temperature-control fluid distribution channel portion
404 First temperature-control fluid collection channel portion
408 Second temperature-control fluid distribution channel portion
410 Second temperature-control fluid collection channel portion
412 Passage
414 Temperature-control fluid guide zone
416 Temperature-control fluid collection zone
418 Temperature-control fluid distribution zone
420 First guide zone portion
422 First distribution zone portion
424 First collection zone portion
426 Second guide zone portion
428 Second distribution zone portion
430 Second collection zone portion
432 First guide zone portion extent
434 Second guide zone portion extent
436 First cross section
438 Second cross section
440 Dimension
442 Smallest diameter
446 Diameter
450 Taper zone
452 Shortest temperature-control path
454 Passage end
456 First penetration portion
458 Second penetration portion
460 First penetration portion extent
462 Second penetration portion extent
464 First temperature-control fluid guide path
465 Second temperature-control fluid guide path
466 Main flow direction
468 Main counterflow direction
470 First central region
471 Longitudinal direction
472 First outflow zone
474 Second outflow zone

1. An energy storage unit comprising:
a plurality of energy storage elements; and
a temperature-control fluid barrier, wherein
the temperature-control fluid barrier extends about a temperature-control chamber and in the temperature-control chamber at least a plurality of the energy storage elements are capable of being temperature-controlled by means of a temperature-control fluid.

2. The energy storage unit as claimed in claim 1, wherein
the temperature-control chamber has a first temperature-control zone and a second temperature-control zone, and the energy storage unit has a temperature-control fluid passage or a plurality of temperature-control fluid passages, and
the one temperature-control fluid passage connects the first temperature-control zone fluidically to the second temperature-control zone, or a plurality of the temperature-control fluid passages connect the first temperature-control zone fluidically to the second temperature-control zone.

3. The energy storage unit as claimed in claim 2, wherein
the one temperature-control fluid passage or a plurality of the temperature-control fluid passages comprise a first penetration portion and a second penetration portion,
a first penetration portion extent of the first penetration portion in a first direction, or the direction of longitudinal extent, is identical in size to a second penetration portion extent of the second penetration portion in the first direction, and
the two penetration portions adjoin one another or are offset from one another in the first direction.

4. The energy storage unit as claimed in claim 3, wherein
the temperature-control fluid passage or the temperature-control fluid passages are designed in such a way that
a second flow resistance for the penetration of temperature-control fluid from the first temperature-control zone to the second temperature-control zone in the second penetration portion is less than
a first flow resistance for the penetration of temperature-control fluid from the first temperature-control zone to the second temperature-control zone in the first penetration portion.

5. The energy storage unit as claimed in claim 3, wherein
the energy storage unit has an inlet through which a temperature-control fluid can be directed into the energy storage unit, and an outlet through which a temperature-control fluid can flow out of the energy storage unit, and
a second temperature-control fluid guide path leading centrally through the second penetration portion from the inlet to the outlet is longer than a first temperature-control fluid guide path leading centrally through the first penetration portion from the inlet to the outlet.

6. The energy storage unit as claimed in claim 3, wherein
a dimension of a temperature-control fluid passage in the first penetration portion is smaller than a dimension, or the corresponding dimension, of the same temperature-control fluid passage or of another temperature-control fluid passage in the second penetration portion, and
the dimension, or a diameter, can be a smallest diameter.

7. The energy storage unit as claimed in claim 3, wherein
a smallest diameter of a temperature-control fluid passage in the first penetration portion is smaller than the smallest diameter of a temperature-control fluid passage in the second penetration portion.

8. The energy storage unit as claimed in claim 3, wherein
a first cross section of a temperature-control fluid passage in the first penetration portion is smaller than a second cross section of a temperature-control fluid passage in the second penetration portion.

9. The energy storage unit as claimed in claim 3, wherein
a number of temperature-control fluid passages in the first penetration portion is less than a number of temperature-control fluid passages in the second penetration portion.

10. The energy storage unit as claimed in claim 3, wherein
in a main flow direction that runs parallel to a second direction, or a direction of width extent, or, counter to the second direction, through the first temperature-control zone towards the temperature-control fluid passage, proceeding from a temperature-control fluid distribution zone, at most 20 energy storage elements or at most 12 energy storage elements are capable of being impacted by a flow and/or surrounded by a flow and/or temperature-controlled by means of the temperature-control fluid which is capable of being guided in the main flow direction.

11. The energy storage unit as claimed in claim 10, wherein
in a main counterflow direction that runs counter to the main flow direction through the second temperature-control zone towards a temperature-control fluid collection zone, proceeding from the temperature-control fluid passage, at most 20 energy storage elements or at most 12 energy storage elements are capable of being impacted by a flow and/or surrounded by a flow and/or temperature-controlled by means of the temperature-control fluid which is capable of being guided in the main counterflow direction.

12. The energy storage unit as claimed in claim 10, wherein
in the main flow direction in the first temperature-control zone first ends of the at most 20 energy storage elements or at most 12 energy storage elements, are capable of being impacted by a flow and/or surrounded by a flow and/or temperature-controlled by means of the temperature-control fluid which is capable of being guided in the main flow direction,
and/or
in the main counterflow direction in the second temperature-control zone second ends of the at most 20 energy storage elements or at most 12 energy storage elements, are capable of being impacted by a flow and/or surrounded by a flow and/or temperature-controlled by means of the temperature-control fluid which is capable of being guided in the main counterflow direction.

13. The energy storage unit as claimed in claim 12, wherein
the first ends and the second ends are mutually opposite ends of the same at most 20 or 12 energy storage elements.

14. The energy storage unit as claimed in claim 1, wherein
the energy storage unit is an energy storage module and/or capable of providing electrical energy for driving a motor vehicle;
and/or
the plurality of energy storage elements are a plurality of electrochemical energy storage elements or a plurality of battery cells.

15. A method for controlling the temperature of energy storage elements of an energy storage unit as claimed in claim 1, wherein
a temperature-control fluid is supplied to a first central region of a first temperature-control zone of the energy storage unit,
the first central region extends in a longitudinal direction of the first temperature-control zone through the first temperature-control zone and divides the first temperature-control zone into a first outflow zone lying on one side of the first central region and into a second outflow zone lying on the other side of the first central region, and
the temperature-control fluid supplied to the first temperature-control zone is divided among the first outflow zone and the second outflow zone, and therein is guided in each case so as to be in heat-exchanging contact with part of the energy storage elements of the energy storage unit.

16. The method as claimed in claim 15, wherein
the temperature-control fluid which in a directly or indirectly preceding method step has been guided so as to be in each case in heat-exchanging contact with part of the energy storage elements is discharged from the energy storage unit.

17. The method as claimed in claim 15, wherein
at least a part of the temperature-control fluid supplied to the first temperature-control zone spreads out in the first outflow zone and in the second outflow zone in mutually opposite main flow directions.

18. The method as claimed in claim 16, wherein
the number of energy storage elements in sequence along the main flow directions, proceeding from the first central region, is so small and so much temperature-control fluid is conveyed through the energy storage unit that the temperature of the temperature-control fluid discharged from the energy storage unit during a charging operation of the energy storage unit, in which the energy storage unit is transferred from a charge state of 20% to a charge state of 80% in less than 15 minutes, does exceed a temperature of the temperature-control fluid flowing into the energy storage unit by not more than 6 K, or not by more than 4 K, or not by more than 2.5 K.
